(19) United States
(12) Patent Application Publication
(10) Pub. No.: US 2026/0065898 A1
(43) Pub. Date: Mar. 5, 2026

(54) SPEECH TRANSLATION USING A WEARABLE DEVICE

(71) Applicant: Amazon Technologies, Inc., Seattle, WA (US)

(72) Inventor: Constantin Daniel Marcu, Rolling Hills, CA (US)

(21) Appl. No.: 19/381,198

(22) Filed: Nov. 6, 2025

Related U.S. Application Data
(63) Continuation of application No. 17/485,878, filed on Sep. 27, 2021.

(51) Int. Cl. G10L 15/00; G06F 40/58; G06N 20/00; G10L 13/00; G10L 15/26; G10L 21/10; G10L 25/27

(52) U.S. Cl. CPC G10L 15/005; G06F 40/58; G06N 20/00; G10L 13/00; G10L 15/26; G10L 21/10; G10L 25/27

(57) ABSTRACT

A speech translation system may provide real-time or near real-time translation of speech uttered by a person or emitted from a media device. The speech translation system may include a device that may receive audio representing speech in a source language and output audio representing speech in a target language. The speech translation system may translate the speech in portions representing semantically cohesive speech segments such that the target speech reflects the semantic meaning of words, phrases, and/or clauses as used in the context of the source speech. The speech translation system may condense the speech segments prior to or during translation to reduce verbosity. The speech translation system may selectively translate some speakers and not others, and may determine voice characteristics of source speech and apply identifying characteristics to the target speech that allow a user to differentiate respective target speech from different speakers based on the identifying characteristics.

### CROSS REFERENCE TO RELATED APPLICATION

This application is a continuation of, and claims priority to, U.S. Non-Provisional patent application Ser. No. 17/485,878, filed on Sep. 27, 2021, and entitled “SPEECH TRANSLATION USING A WEARABLE DEVICE,” which is hereby incorporated by reference in its entirety.

### BACKGROUND

Speech recognition systems have progressed to the point where humans can interact with computing devices using their voices. Such systems employ techniques to identify the words spoken by a human user based on the various qualities of a received audio input. Speech recognition combined with natural language understanding processing techniques enable speech-based user control of a computing device to perform tasks based on the user's spoken commands. Speech recognition and natural language understanding processing techniques may be referred to collectively or separately herein as speech processing. Speech processing may also involve converting a user's speech into text data which may then be provided to various text-based software applications.

Speech processing may be used by computers, hand-held devices, telephone computer systems, kiosks, and a wide variety of other devices to improve human-computer interactions.

### BRIEF DESCRIPTION OF DRAWINGS

For a more complete understanding of the present disclosure, reference is now made to the following description taken in conjunction with the accompanying drawings.

FIG. 1A is a conceptual diagram illustrating components of a speech translation system incorporating a device, according to embodiments of the present disclosure.

FIG. 1B is a flowchart illustrating operations of an example method 101 of translating conversational speech using the speech translation system 100, according to embodiments of the present disclosure;

FIG. 2 is a conceptual diagram illustrating components of devices for use in a system providing speech translation, according to embodiments of the present disclosure;

FIG. 3A illustrates a first example scenario of a multilingual conversation facilitated by devices for speech translation, according to embodiments of the present disclosure;

FIG. 3B illustrates a second example scenario of a multilingual conversation where some but not all of the participants use devices for speech translation, according to embodiments of the present disclosure;

FIG. 4A is a conceptual diagram illustrating components of the speech translation system configured to translate speech emitted from a media device using a wearable device, according to embodiments of the present disclosure;

FIG. 4B illustrates a third example scenario of a user receiving a real-time translation of speech emitted from a media device via a device for speech translation, according to embodiments of the present disclosure;

FIG. 4C illustrates a fourth example scenario of a user receiving a real-time closed-caption translation of speech emitted from a media device, according to embodiments of the present disclosure;

FIG. 5 is a conceptual diagram illustrating a natural language condenser component, according to embodiments of the present disclosure;

FIG. 6 is a conceptual diagram of an ASR component, according to embodiments of the present disclosure.

FIG. 7 is a conceptual diagram illustrating a translation component, according to embodiments of the present disclosure;

FIG. 8 is a conceptual diagram of components of a system to detect if input audio data includes system directed speech, according to embodiments of the present disclosure.

FIG. 9 is a conceptual diagram of text-to-speech components according to embodiments of the present disclosure.

FIG. 10 is a conceptual diagram of how natural language processing is performed, according to embodiments of the present disclosure.

FIG. 11 is a conceptual diagram of how natural language processing is performed, according to embodiments of the present disclosure.

FIG. 12 is a conceptual diagram of components of an image processing component, according to embodiments of the present disclosure.

FIG. 13 is a schematic diagram of an illustrative architecture in which sensor data is combined to recognize one or more users according to embodiments of the present disclosure.

FIG. 14 is a system flow diagram illustrating user recognition according to embodiments of the present disclosure.

FIG. 15 is a conceptual diagram illustrating a sentiment detection component according to embodiments of the present disclosure.

FIG. 16 is a block diagram conceptually illustrating example components of a device, according to embodiments of the present disclosure.

FIG. 17 is a block diagram conceptually illustrating example components of a system, according to embodiments of the present disclosure.

FIG. 18 illustrates an example of a computer network for use with the overall system, according to embodiments of the present disclosure.

### DETAILED DESCRIPTION

Speech processing systems can leverage different computerized voice-enabled technologies to perform actions for and/or on behalf of a user. Automatic speech recognition (ASR) is a field of computer science, artificial intelligence, and linguistics concerned with transforming audio data associated with speech into text or other type of word representative data of that speech. Similarly, natural language understanding (NLU) is a field of computer science, artificial intelligence, and linguistics concerned with enabling computers to derive meaning from text or other natural language meaning representation data. ASR and NLU are often used together as part of a speech processing system, sometimes referred to as a spoken language understanding (SLU) system. Neural machine translation (NMT) is a type of machine translation that can be used to translate sequences of words using an artificial neural network. Text-to-speech (TTS) is a field of computer science concerning transforming textual and/or other meaning representation data into audio data that is synthesized to resemble human speech. ASR, NLU, NMT, and TTS may be used together to act as a speech translation system; for example, by receiving speech in a source language and outputting synthesized speech in a target language different from the source language.

A speech translation system may perform interpretation of one or more spoken language(s) for one or more users. Providing real-time or near real-time interpretation of conversational speech and/or speech in media presents several usability opportunities. For example, latency (e.g., providing the translation several seconds or more after receiving the source speech) may be reduced to improve the natural flow of conversation, or improve the user's ability to follow a movie, podcast, radio show, or other continuous content. Furthermore, the speech translation system may be called upon to translate one voice (or more) from among many in a manner that allows the user to know the essence of who said what. As yet another example, translated or otherwise summarized speech that may be conveyed in a less distracting manner with respect to the speaker or other activities occurring.

Offered is a speech translation system, which may be incorporated in a wearable device to provide a more unobtrusive conversational and/or viewing user experience when the system is interpreting spoken language. For example, the device may be worn or otherwise positioned to receive speech and provide translated speech to the user without blocking ambient audio, which may include other speech to which the user wishes to listen. For example, the speech translation system may include one or more loudspeakers that may use beamforming, bone conducting, or other techniques to direct audio precisely to the user's ear in a manner that does not block other sounds from reaching the ear, and that also does not direct a significant volume of the audio away from the user in a manner that would disrupt conversation and/or draw attention. The speech translation system may provide low-latency interpretation (e.g., simultaneous or near-simultaneous interpretation) while translating the source speech in portions such that semantic meaning is preserved (e.g., versus a simple word-for-word translation that may not consider the context in which each word appears). To translate speech in semantically meaningful portions, the speech translation system may include an attention-based mechanism and a confidence mechanism. The speech translation system may receive a stream of speech and, using the attention-based mechanism and confidence mechanism, translate the speech in semantic translation units such as phrases, clauses, sentences, etc., in a manner that balances latency concerns with preserving semantic meaning between the source speech and target speech. In other words, the system may translate portions of speech smaller than paragraphs or sentences in a streaming fashion and without waiting for an end of speech to the extent it is able without losing the semantic meaning of the input speech. For example, the speech translation system may output a translation of a word/phrase/sentence once it has predicted a meaning with a sufficient confidence (e.g., without necessarily waiting for an end-of-speech indicator). The speech translation system may interpret the meaning of each word/phrase/sentence by taking into account, using the attention-based mechanism, the relative importance of other portions of the speech in ascertaining the meaning. Preserving semantic meaning without necessarily providing a word-for-word direct translation may improve both system latency as well as user comprehension.

A semantically cohesive segment refers to a portion of speech (or a transcription of speech) that includes enough information to interpret the semantic meaning of the portion. In some cases, the portion may be as small as a single word, or may include more than one sentence. The attention-based mechanism of the speech processing system may predict which words of a sequence are likely to inform a correct interpretation of a given word or phrase. The confidence mechanism to predict when a meaning word, phrase, clause, and/or sentence has been determined with a sufficient confidence such that the speech translation system can output a translation of the word/phrase/clause based on the meaning.

The speech translation system may perform speaker identification (e.g., user identification) to perform speaker-dependent translation, allowing the user to choose which speakers (and/or which languages) to translate. Furthermore, the speech translation system may distinguish overlapping speech from multiple speakers, and provide separate translations of each. The speech translation system may provide the separate translations with audible indications of the identity of the source speaker. For example, the TTS component may generate synthesized speech using voice characteristics similar to those of the speaker. And the speech translation system may additionally provide audible cues such as beeps to indicate when the end of a translated segment of speech has been reached. Thus, a user listening to the translation receives an indication that no more translation is forthcoming, enabling her/him to know when it may be appropriate to speak or direct attention elsewhere.

The system may be configured to incorporate user permissions and may only perform activities disclosed herein if approved by a user. As such, the systems, devices, components, and techniques described herein would be typically configured to restrict processing where appropriate and only process user information in a manner that ensures compliance with all appropriate laws, regulations, standards, and the like. The system and techniques can be implemented on a geographic basis to ensure compliance with laws in various jurisdictions and entities in which the components of the system and/or user are located.

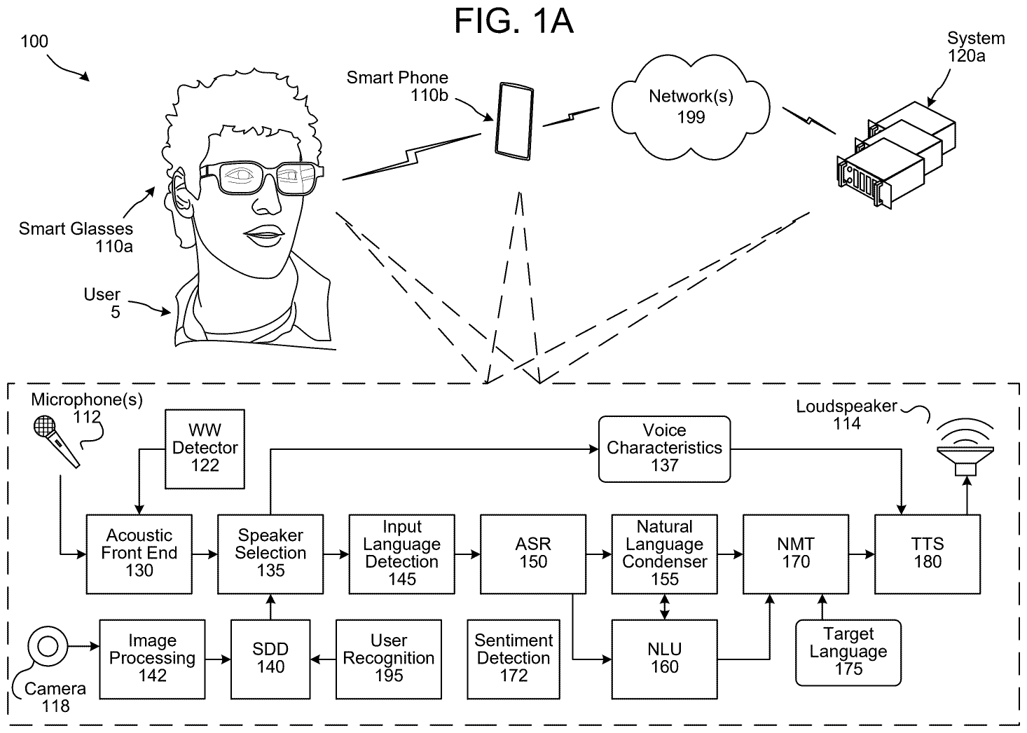

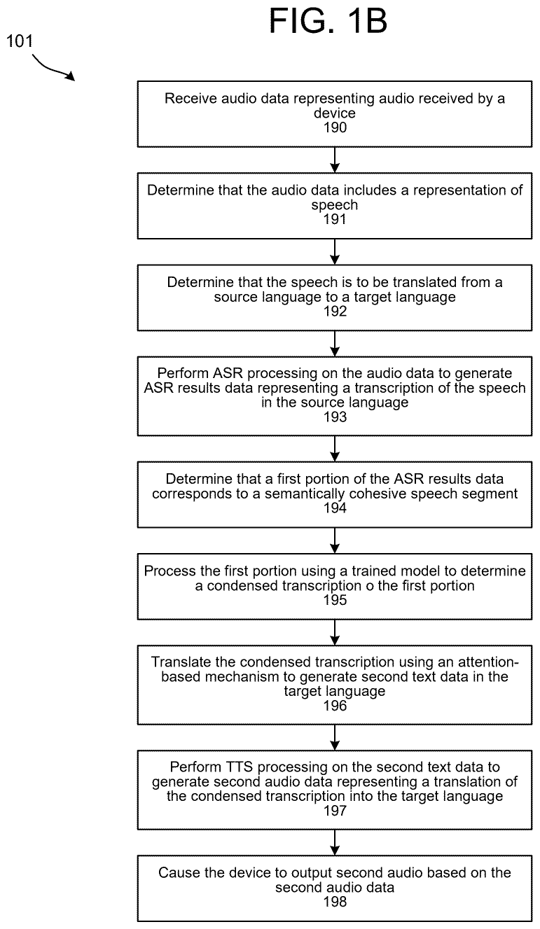

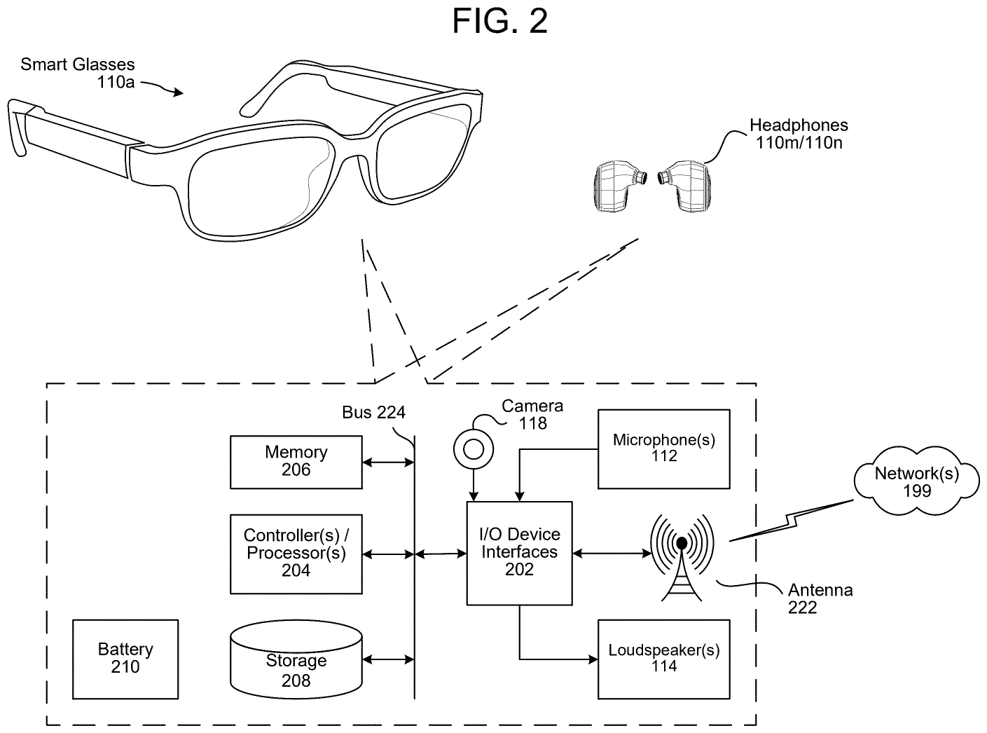

FIG. 1A is a conceptual diagram illustrating components of a speech translation system 100 incorporating a device 110, according to embodiments of the present disclosure. The device may be, for example, a wearable device such as a pair of earbuds, glasses, headphones hat, headband, necklace, pocket device with external loudspeakers and/or microphone, etc., which may be positioned or worn in proximity to a user 5 such that the user 5 can hear audio emitted by the device. A pair of smart glasses 110a are shown in FIG. 1A as an example of a device 110, but this disclosure is not limited to this specific device. Example devices 110 are described in additional detail below with reference to FIG. 2. In some implementations, the speech translation system 100 may further include a smart phone 110b and/or a system 120. In various implementations, the features and functions of the speech translation system 100 may be shared among and/or divided between a wearable device (e.g., the smart glasses 110a), a personal device and/or edge device (e.g., the smart phone 110b), and/or the system 120 (e.g., a remote system 120 that may reside “in the cloud”). While in some preferred embodiments, the wearable device may contain a microphone and/or microphone array 112 and/or a loudspeaker and/or loudspeaker array 114, the disclosure need not be so limited. Further, while various embodiments illustrate the smart glasses 110a using a smart phone 110b to connect to a network(s) 199 and then to system 120a, the smart glasses 110a may be configured to communicate directly with the network(s) 199 without going through the smart phone 110b.

The speech translation system 100 may include components for recognizing, processing, translating, and/or generating speech. For example, the speech translation system 100 may include a wakeword detection component 122, an acoustic front end (AFE) 130, a speaker selection component 135, a system directed input detector (SDD) 140, an input language detection component 145, an ASR component 150, a natural language condenser component 155, an NLU component 160, an NMT component 170, a TTS component 180, a user recognition component 195, an image processing component 142, and/or a sentiment detection component 172. In some implementations, the speech translation system 100 may include additional components configured to, for example, recognize commands represented in speech of the user 5 and/or cause actions to be performed in response to the commands.

The AFE 130 may receive an analog audio signal from the microphone(s) 112 and digitize it to generate audio data. The audio data may be digitized into frames representing time intervals for which the AFE 130 determines a number of values, called features, representing the qualities of the audio data, along with a set of those values, called a feature vector, representing the features/qualities of the audio data within the frame. In at least some embodiments, audio frames may be 10 ms each. In some embodiments, audio frames may be 30 ms in duration. Many different features may be determined, and each feature may represent some quality of the audio that may be useful for ASR processing. A number of approaches may be used by an AFE to process the audio data, such as mel-frequency cepstral coefficients (MFCCs), perceptual linear predictive (PLP) techniques, neural network feature vector techniques, linear discriminant analysis, semi-tied covariance matrices, or other approaches known to those of skill in the art. In some implementations, the AFE 130 may determine directionality data that may indicate what direction (relative to the wearable device) the incoming audio was received from. For example, the AFE 130 may receive respective audio signals from microphones 112 arranged in an array, and perform analog and/or digital beamforming on the signals to; for example, determine a direction from which speech corresponding to a particular speaker is received, or to focus the microphone array on the direction of speech origination so as to boost the signal strength of the speech relative to background noise and/or other speech. The AFE 130 may employ filters and/or signal processing to filter out speech emitted from the loudspeaker 114 of the device 110.

In some implementations, the AFE 130 may generate audio data in response to audio received from the microphone(s) 112 upon receiving an indication from the wakeword detector 122 that a wakeword has been detected in the audio. The wakeword detection component 122 may be configured to detect various wakewords. In at least some examples, each wakeword may correspond to a name of a different digital assistant. An example wakeword/digital assistant name is “Alexa.” The wakeword detector 122 of the device 110 may process the audio data, representing the audio, to determine whether speech is represented therein. The device 110 may use various techniques to determine whether the audio data includes speech. In some examples, the device 110 may apply voice-activity detection (VAD) techniques. Such techniques may determine whether speech is present in audio data based on various quantitative aspects of the audio data, such as the spectral slope between one or more frames of the audio data; the energy levels of the audio data in one or more spectral bands; the signal-to-noise ratios of the audio data in one or more spectral bands; or other quantitative aspects. In other examples, the device 110 may implement a classifier configured to distinguish speech from background noise. The classifier may be implemented by techniques such as linear classifiers, support vector machines, and decision trees. In still other examples, the device 110 may apply hidden Markov model (HMM) or Gaussian mixture model (GMM) techniques to compare the audio data to one or more acoustic models in storage, which acoustic models may include models corresponding to speech, noise (e.g., environmental noise or background noise), or silence. Still other techniques may be used to determine whether speech is present in audio data.

In some implementations, the system 100 may respond to different wakewords. Each wakeword may correspond to a different “virtual assistant”; e.g., a computerized agent for performing commands for and/or on behalf of the user 5 in response to a spoken or typed natural language command. For example, a first wakeword may activate a first virtual assistant, and a second wakeword may activate a second virtual assistant. A virtual assistant may be associated with a particular language. Thus, activating the wearable device using a first wakeword may cause the system 100 to translate non-English speech into English, while a second wakeword may correspond to Hindi. Different wakewords may correspond to different users and/or user types, with different users having different language and/or translation preferences. For example, a first wakeword may correspond to an adult user profile while a second wakeword may correspond to a child user profile, where translations associated with the child user profile are based on more basic language and/or parental or legal controls. Other translation settings may be possible, including those associated with professional speech (e.g., business, academic, etc.) casual conversational speech, movie and/or video content speech (e.g., dubbing), etc. In some implementations, a virtual assistant may have a “personality” that may include a certain, possibly recognizable, style of speech. For example, a virtual assistant may correspond to a celebrity profile, and may respond with synthesized speech generated to sound like the celebrity. Thus, the system 100 may be configured to output translated speech in the personality of the celebrity. In fact, the system 100 need not perform an actual language translation, but my reproduce the source speech as though uttered by the celebrity. For example, a user 5 may configure the system 100 to output his/her own speech and/or another speaker's speech as though spoken by a celebrity. Machine translation and virtual assistant personalities may be used in combination to, for example, receive French-language speech from a woman and output an English-language translation in the voice of Samuel L. Jackson.

The speaker selection component 135 may receive an indication of which speaker(s) to translate, and isolate speech corresponding to that/those speaker(s). The speaker selection component 135 may employ filters and/or neural networks to determine when speech in the audio data corresponds to a selected speaker. The speaker selection component 135 may employ more sophisticated models that may isolate speech corresponding to a selected speaker even in the presence of overlapping speech corresponding to unselected speakers. In some implementations, the speaker selection component 135 may receive a speaker directed input detector (SDD) result from the SDD 140. The speaker selection component 135 may use the SDD result to determine whether a speaker is directing speech towards the wearable device (and thus the user 5). The speaker selection component 135 may determine, based in part on the SDD result, that certain speech from a selected speaker is directed towards the wearable device and should thus be translated, while other speech from the selected speaker is not directed towards the wearable device and should thus be disregarded. In some implementations, the speaker selection component 135 may receive and/or determine voice characteristics corresponding to a speaker. The speaker selection component 135 may send the voice characteristics 137 to the TTS component 180. Based on the voice characteristics 137, the TTS component 180 may generate synthesized speech that is similar to the source speech. In some implementations, the speaker selection component 135 may be incorporated into the ASR component 150—in other words the ASR component 150 may perform the functions of speaker selection and/or speech isolation, as described further below. In some implementations, the speaker selection component 135 may process a signal from the SDD 140 (e.g., and SDD result 842) to determine that a speaker is speaking towards the wearable device (i.e., towards the wearer of the wearable device). The speaker selection component 135 may thus translate speech corresponding to a speaker directing speech towards the wearable device, and/or translate speech corresponding to a selected speaker when the speaker is directing their speech towards the wearable device, as determined by the SDD 140.

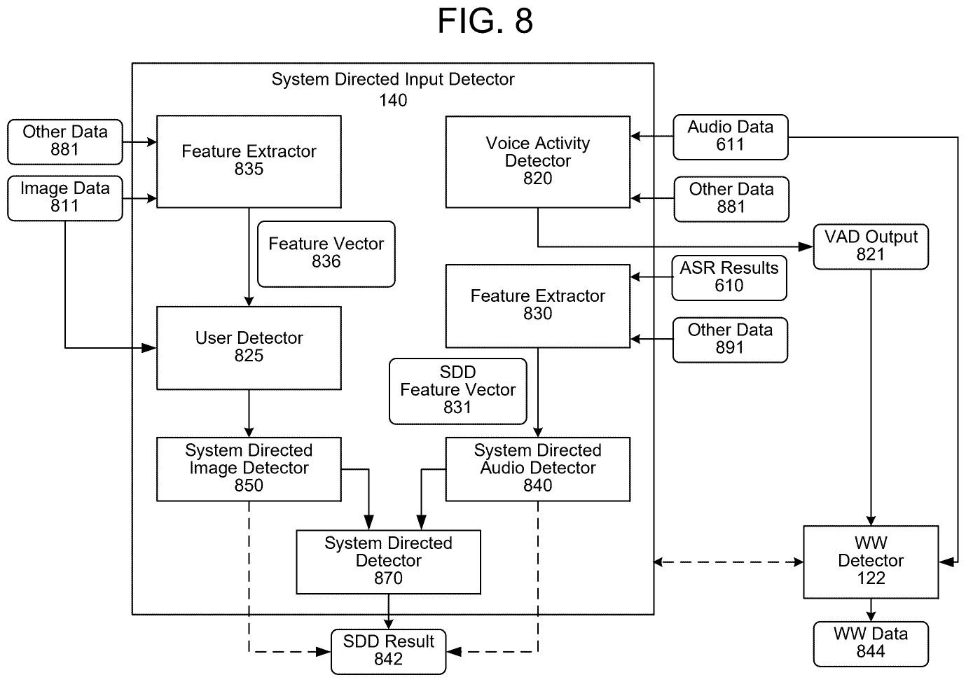

The SDD 140 may include a number of different components configured to variously detect whether the audio data includes speech or not, and make a determination as to whether the speech was or was not directed to the speech-processing system. The SDD 140 may generate an SDD result representing a determination that received speech likely is or is not directed towards the wearable device. The system 100 may use the SDD result to determine whether to translate certain received speech. The SDD is described in additional detail below with reference to FIG. 8.

The input language detection component 145 may include filters and/or models that can use acoustic features to identify a language corresponding to speech. For example, the speaker selection component 135 may isolate one or more streams of speech, which the input language detection component 145 may process to determine a language represented by the speech. The language detection component 145 may label audio data corresponding to a speaker's speech such that the ASR component 150 can apply a model corresponding to that language when attempting to transcribe the audio data. In some implementations, the input language detection component 145 may be incorporated into the ASR component 150 such that the ASR component 150 performs language identification in concert with its processing of the audio data. In some implementations, the input language detection component 145 may use additional signals to identify a language represented by speech; for example, GPS data that may indicate the user is in a region where a particular language and/or dialect may be prevalent.

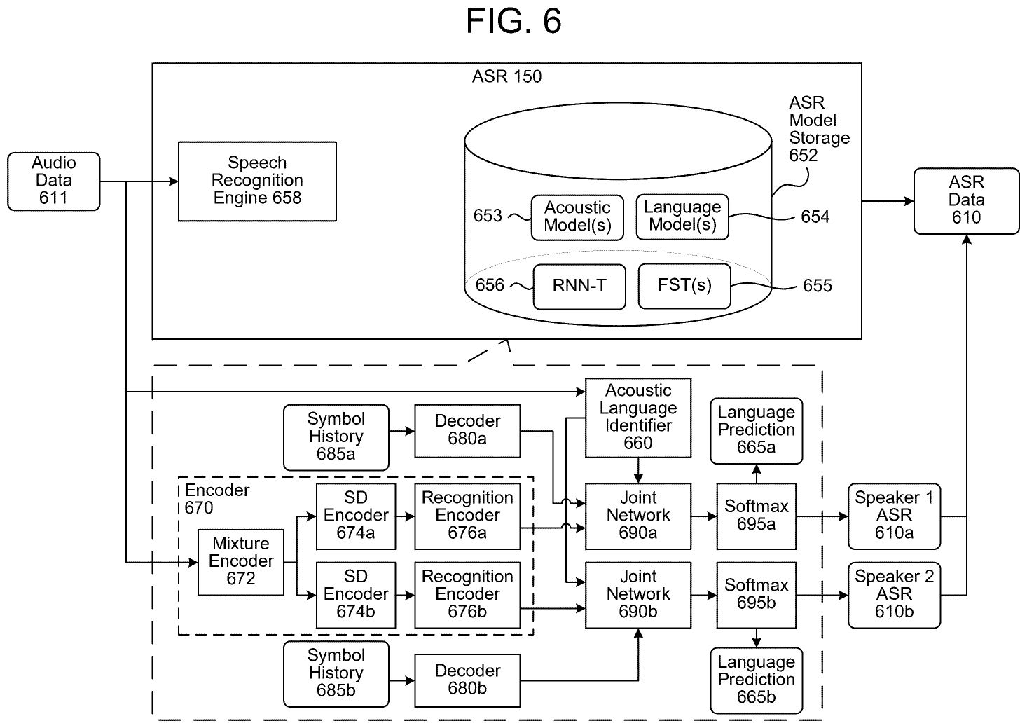

The ASR component 150 may receive audio data from the AFE 130, speaker selection component 135, and/or the input language detection component 145. The ASR component 150 may process the audio data using one or more models to generate a transcription of speech represented in the audio data. The ASR component 150 may transcribe audio data representing speech corresponding to more than one speaker. For example, the ASR component 150 may transcribe speech corresponding to a single selected speaker while ignoring speech corresponding to other speakers, and/or the ASR component 150 may separately transcribe speech corresponding to respective different speakers. In some implementations, the ASR component 150 may perform speaker selection and/or input language detection internally; for example, using one or more combined DNN models. The ASR component 150 may output one or more transcriptions of speech represented in the audio data. In some implementations, the ASR component 150 may output a highest-ranked ASR hypothesis representing a “best guess” transcription of the speech. In some implementations, the ASR component 150 may output an n-best list of transcriptions. In some implementations, the ASR component 150 may output the transcription in the form of a word and/or subword lattice representing possible word/subword sequences along with associated probabilities for the sequences. The ASR component 150 may transcribe speech in a streaming fashion; for example, by outputting a partial transcription prior to detection of an end of speech. The partial transcription may be augmented and/or revised based on later-received speech. In other words, the ASR component 150 may generate a first portion of ASR results data at a first time and a second portion of ASR results data at a second time, where the first and second portions may represent adjacent portions of a continuous speech segment. The ASR results data portions may be sent to the natural language condenser component 155 and/or the NMT component 170 as they are generated; again, in some cases without waiting for an end of speech to be detected. The ASR component 150 is described in additional detail below with reference to FIG. 6.

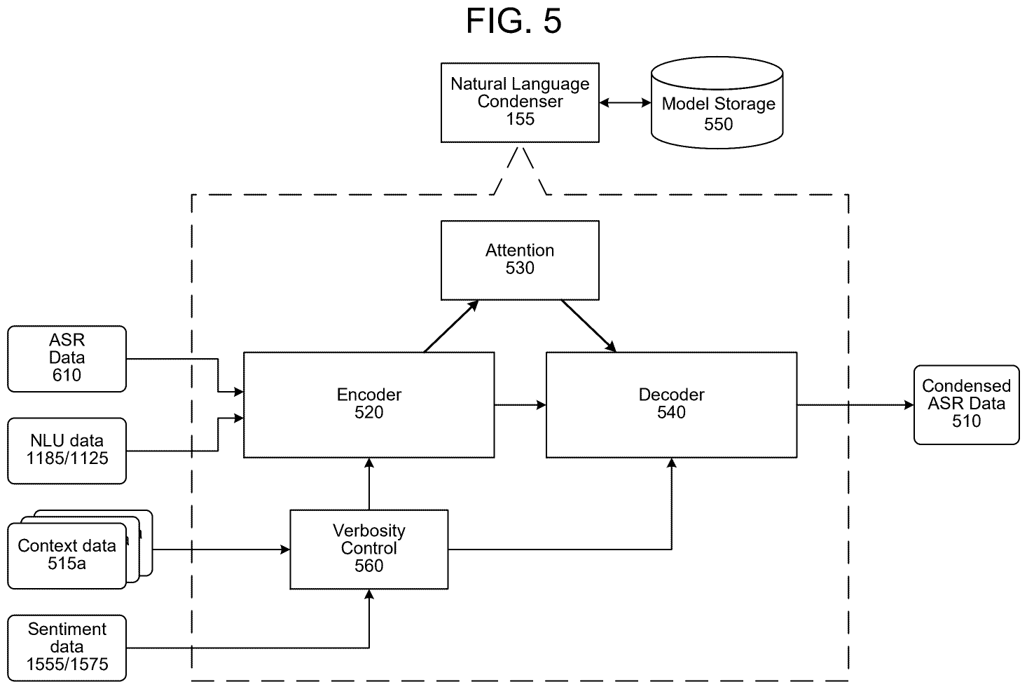

The natural language condenser component 155 may receive one or more transcriptions of speech from the ASR component 150 and condense the text. The natural language condenser component 155 may include one or more neural network models configured to rewrite received input text to generate condensed text. The natural language condenser component 155 may, for example, remove redundancies, self-corrections, non-verbal speech hesitations such as “ah” and “um,” and/or rewrite sentences to reduce verbosity while retaining semantic meaning. Condensing the transcript in this manner may shorten the translated speech while preserving meaning, which may reduce latency and allow more “open air” that is, time when the wearable device is not outputting translated speech. To condense the transcript, the natural language condenser component 155 may perform some NLU processing on the ASR data (and/or receive NLU output data from the NLU component 160) to determine semantic meaning of portions of the transcript. For example, the natural language condenser component 155 may identify two statements referencing a same object or concept, but with different parameters. For example, the transcript may include a sentence such as, “Walk to the end of the street and turn left—I mean turn right.” The natural language condenser component 155 may identify such a self-correction and condense the transcription to read, “Walk to the end of the street and turn right.” Similarly, the transcript may include, “The part should cost, um, I think, about twelve dollars or so,” to read “The part should cost about twelve dollars.” In some implementations, the natural language condenser component 155 may be incorporated into the NMT component 170 such that the NMT component 170 can output transcriptions in the target language that are length-adjusted to remove unhelpful words/syllables and/or to match a length of the source text and/or speech. In some implementations, the natural language condenser component 155 may leverage natural language processing performed, for example, by the NLU component 160. For example, the NLU component 160 may perform semantic portioning of the ASR data to determine semantically cohesive speech portions, and then pass the semantic representation of the speech to the natural language condenser component 155 and/or the NMT component 170. In speech processing, (e.g., when semantically interpreting a command to a natural language command processing system) a semantically cohesive speech portion may be in an <intent> <slot> format. For translation purposes, a semantically cohesive speech portion may be in a different form; for example, <noun> <verb> <subject> etc. Based on the semantic portioning, the natural language condenser component 155 and/or the NMT component 170 may determine that a later semantic portion repeats or corrects an earlier semantic portion, and thus may be dropped from the translation. The natural language condenser component 155 is discussed in further detail below with reference to FIG. 5.

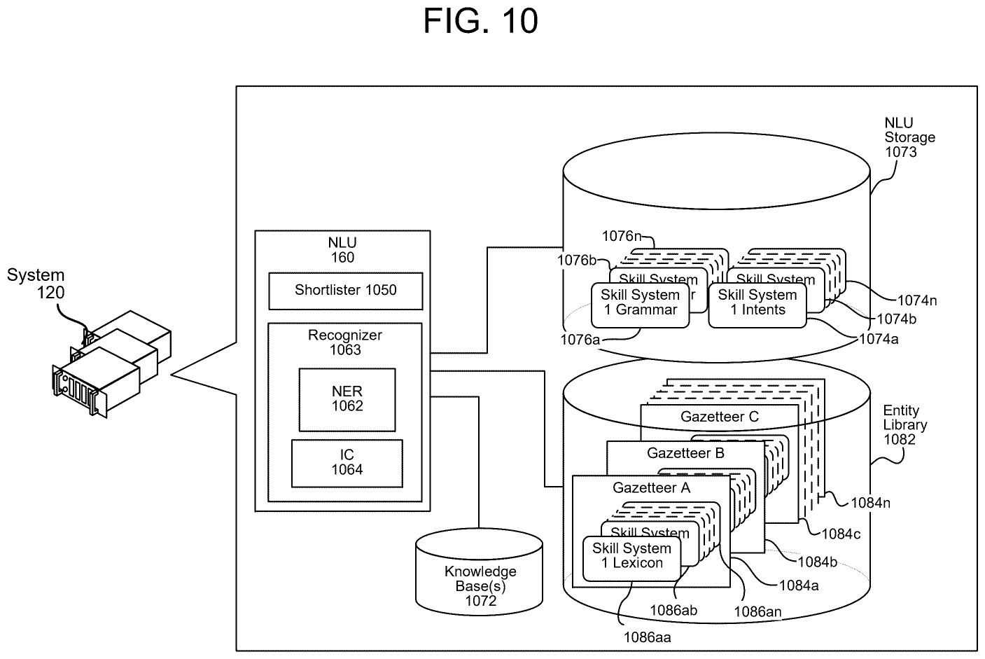

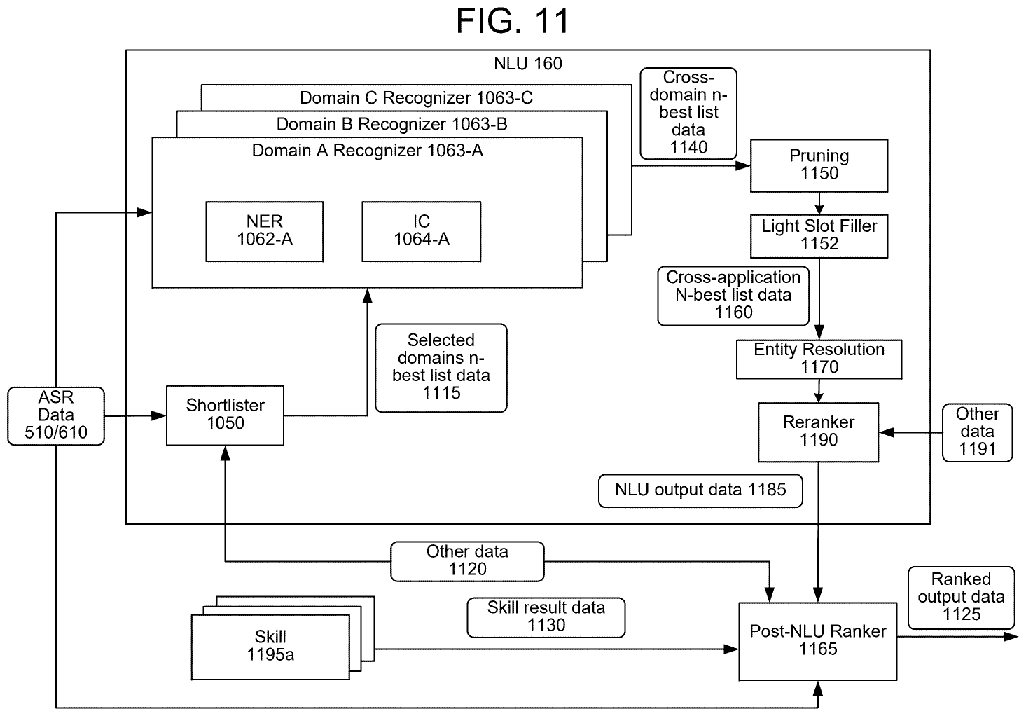

The NLU component 160 may receive the ASR data (e.g., a transcription of the source speech) from the ASR component 150. The NLU component 160 may attempts to make a semantic interpretation of the phrase(s) or statement(s) represented in the text data input therein by determining one or more meanings associated with the phrase(s) or statement(s) represented in the text data. The NLU component 160 may provide NLU results data 1125/1185 (which may include tagged text data, indicators of intent, etc.) to the natural language condenser component 155 and/or the NMT component 170. The NLU component 160 is described in additional detail below with reference to FIGS. 10 and 11.

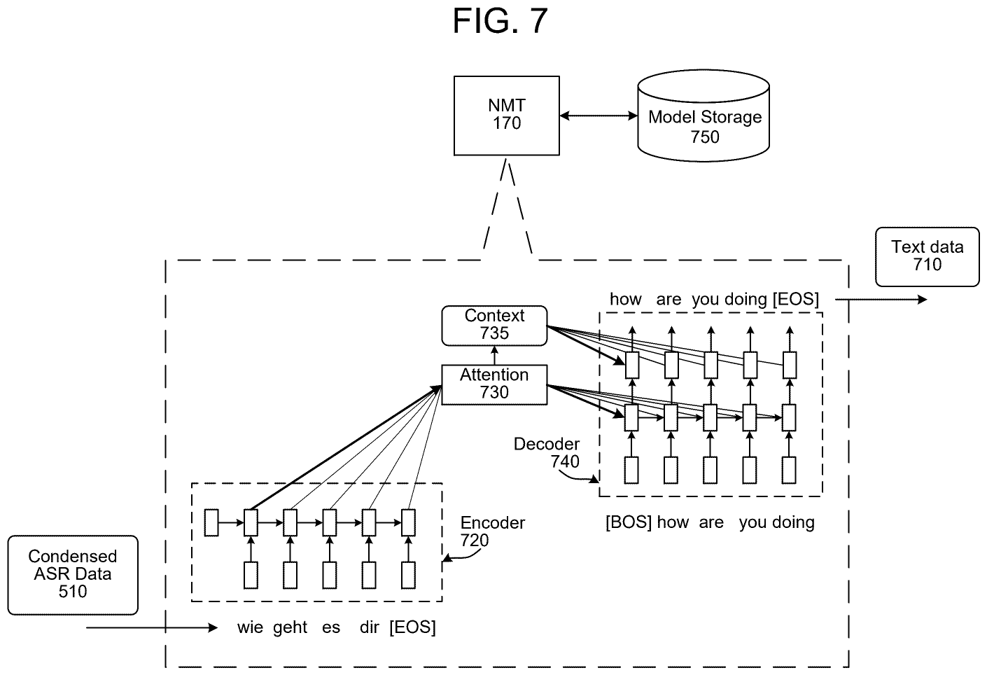

The NMT component 170 may receive ASR data from the natural language condenser component 155 (and, in some implementations, NLU results data 1125/1185 from the NLU component 160) and translate the transcription from the source language to a target language as selected/determined by an indication a target language 175. The NMT component may include one or more machine learning models for translating the transcription in a manner that preserves semantic meaning. For example, the NMT component 170 may employ a DNN having an attention mechanism that can take into account the context of a word and/or phrase such that the resulting translation represents the meaning and/or use of the word in context of a semantically cohesive speech segment in which it appears, rather than simply providing the closest literal translation of the word/phrase. Depending on the particular word, phrase, clause, etc., the semantically cohesive segment may include a portion of a sentence, a whole sentence, or more speech than a single sentence. The NMT component 170 is described in additional detail below with reference to FIG. 7.

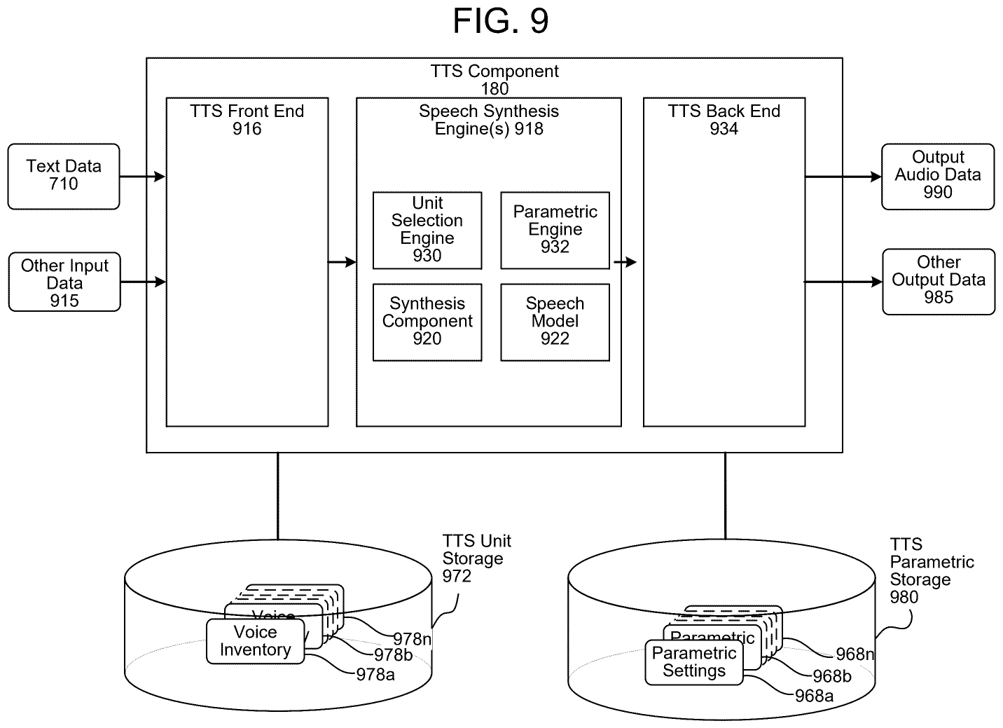

The TTS component 180 may receive the target language transcription from the NMT component 170 and generate synthesized speech representing a translation of the source speech. In some implementations, the TTS component 180 may receive voice characteristics 137—e.g., from the speaker selection component 135—and use the voice characteristics 137 to set parameters for synthesized speech generation. In some implementations, the TTS component 180 may generate synthesized speech that is differentiated based on the speaker identity such that the user 5 may differentiate between, for example, a first speaker and a second speaker. For example, for source speech having voice characteristics indicating a female speaker, the TTS component 180 may generate synthesized speech approximating a female speaker for the output speech, and likewise for source speech having voice characteristics indicating a male speaker. In some implementations, the TTS component 180 may generate synthesized speech that imitates certain qualities of the source speech; for example, pitch, timbre, cadence, etc. The TTS component 180 is described in additional detail below with reference to FIG. 9.

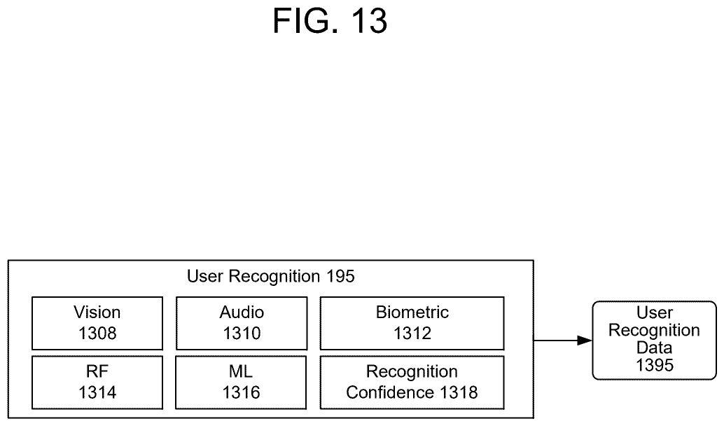

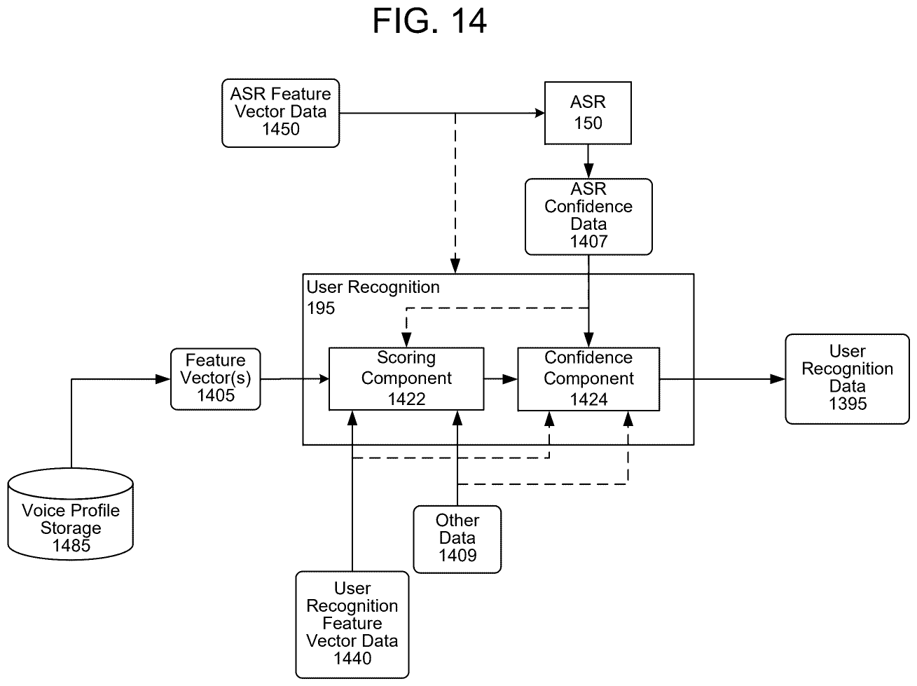

The user recognition component 195 may recognize one or more speakers and/or users using a variety of data, as described in greater detail below with regard to FIGS. 13-14. The user-recognition component 195 may take as input the audio data and/or text data output by the ASR component 150. The user-recognition component 195 may perform speaker/user recognition by comparing audio characteristics in the audio data to stored audio characteristics of speakers/users. The user-recognition component 195 may further perform speaker recognition by comparing image data (e.g., including a representation of at least a feature of the speaker), received by the system 100 in correlation with the present input, with stored image data including representations of features of different speakers/users. The user-recognition component 195 may determine a score indicating whether input originated from a particular speaker. For example, a first score may indicate a likelihood that the input originated from a first speaker, a second score may indicate a likelihood that the input originated from a second speaker, etc. The user-recognition component 195 may also determine an overall confidence regarding the accuracy of user recognition operations. Output of the user-recognition component 195 may include a single speaker identifier corresponding to the most likely speaker that originated the input. Alternatively, output of the user-recognition component 195 may include an N-best list of speaker identifiers with respective scores indicating likelihoods of respective speakers originating the input. The output of the user-recognition component 195 may be used by other components of the system 100 to, for example, select speech corresponding to a particular speaker for translation (e.g., by the speaker selection component 135) and/or load ASR, NLU, and/or entity models/libraries associated with the language used by the speaker or personalized to the speaker.

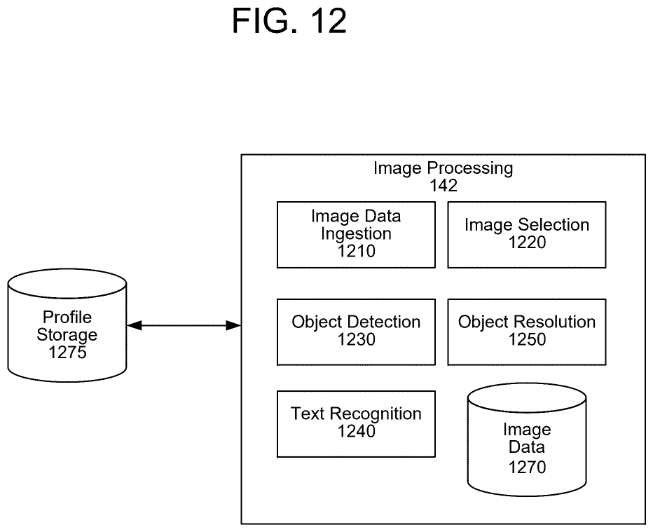

The image processing component 142 may perform computer vision functions such as object recognition, modeling, reconstruction, etc. For example, the image processing component 142 may detect a person, face, etc. (which may then be identified using user recognition component 195). The image processing component 142 is described in greater detail below with reference to FIG. 12. In some implementations, the image processing component 142 can detect the presence of text in an image. In such implementations, the image processing component 142 can recognize the presence of text, convert the image data to text data, and send the resulting text data for processing by the NLU component 160 and/or translation by the NMT component 170.

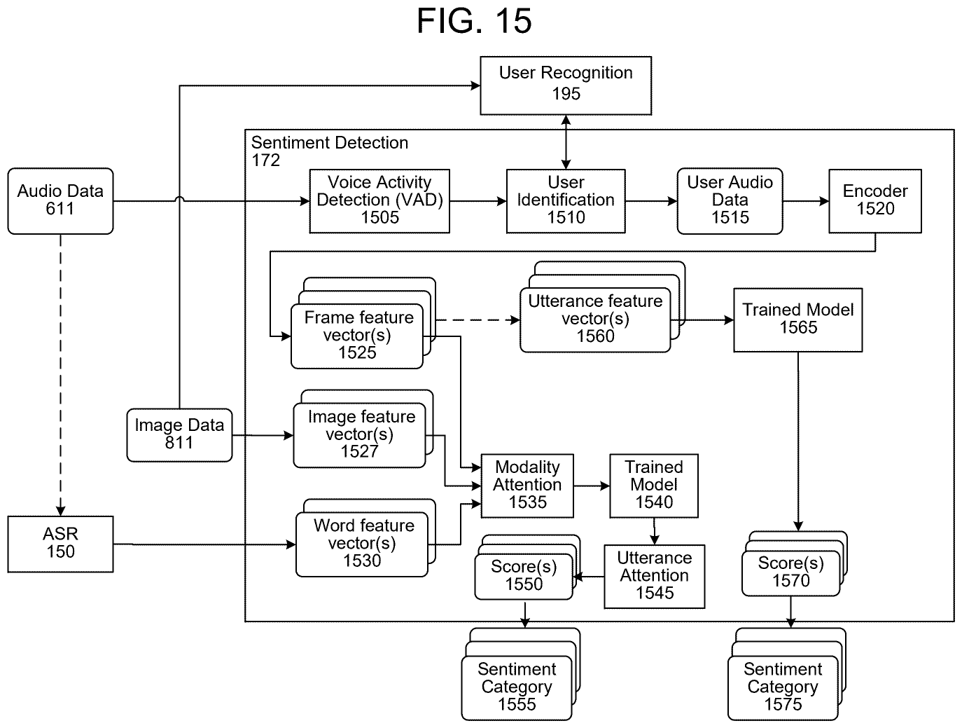

The sentiment detection component 172 may be configured to detect a sentiment of a user from audio data representing speech/utterances from the user, image data representing an image of the user, and/or the like. The system 100 may use the sentiment detection component 172 to, for example, translate portions of a speaker's speech and/or customize a response for a user based on an indication that the user is happy or frustrated. The sentiment detection component 172 is described in greater detail below with reference to FIG. 15.

FIG. 1B is a flowchart illustrating operations of an example method 101 of translating conversational speech using the speech translation system 100, according to embodiments of the present disclosure. The system 100 may, at a step 190, receive audio data representing audio received by a device; for example, the smart glasses 110a shown in FIG. 1A. The system 100 may, at a step 191, determine that the audio data includes a representation of speech. In some implementations, the system 100 may determine that the audio data includes speech corresponding to multiple speakers; for example, first speech corresponding to a first person, second speech corresponding to a second person, etc.

The system 100 may, at a step 192, determine that the speech is to be translated from a source language to a target language. The system 100 may first determine that the speech is in a first language. The system 100 may determine that speech in the first language is to be translated; for example, based on a user profile setting indicating that the first language does not correspond to a preferred language of the user wearing the device. Thus, the system 100 may determine that the speech is to be translated based on the determination that the source language does not correspond to a preferred language of the user. In the case of speech received from multiple speakers, the system 100 may determine that the first speech is to be translated but the second speech is not to be translated. For example, the system 100 may determine that the second speech is in a second language that does correspond to a preferred language of a user. In some implementations, the system 100 may determine whether to translate speech based on additional indicators, such as the identity of the speaker, whether the speaker is directing the speech towards the device (and thus the user), and/or whether the speech originated from a media device such as a television, radio, personal computer, etc.

The system 100 may, at a step 193, perform ASR processing on the audio data to generate ASR results data representing a transcription of the speech in the source language. The ASR processing may be based on, for example, one or more trained models, which may be associated with the source language and/or dialect.

The system 100 may, at a step 194, determine that a first portion of the ASR results data corresponds to a semantically cohesive speech segment. The system 100 may process the ASR results data using one or more trained models to determine that a first portion of the ASR results data corresponds to the semantically cohesive speech segment. In some implementations, the system 100 may determine that a second portion of the ASR results data does not correspond to the semantically cohesive speech segment (although the second portion may correspond to a second semantically cohesive speech segment, which may be independent of the first segment). In some implementations, the system 100 may process the ASR results data (e.g., using NLU processing or similar) to determine that a speech segment is redundant over an earlier speech segment, or represents a correction of the earlier speech segment. The system 100 may thus modify the ASR results to remove or condense the second portion before providing the ASR results data to a translation component. In this manner, the translation may be shortened relative to the source speech, which may decrease latency perceived by the listener and/or reduce the amount of time the user must direct attention towards the audio emitted by the device, rather than the speakers and/or media device.

The system 100 may, at a step 195, process the first portion of the ASR results data using a trained model to determine a condensed transcription. The system 100 may condense the ASR results data using, for example, the natural language condenser component 155 described below with reference to FIG. 5. In some implementations, the system 100 may adjust the verbosity of the condensed transcription relative to the verbosity of the first portion according to one or more contextual inputs. For example, a sentiment detector of the system 100 may determine a sentiment category of the first speech, and the trained model may be configured to increase/decrease a verbosity of the condensed transcription depending on a degree of emotion determined (e.g., increasing verbosity for strongly positive and/or strongly negative sentiment categories). In some implementations, a verbosity of the output may be selected manually by the user.

The system 100 may, at a step 196, translate the condensed transcription to generate text data in the target language. The system 100 may translate the condensed transcription using an attention-based mechanism of a neural machine translation component, such as the NMT component 170. In some implementations, the system 100 may determine not to translate the second portion contemporaneously with the first portion; however, the system 100 may subsequently translate the second portion upon determining that it represents a second semantically cohesive speech segment.

The system 100 may, at a step 197, perform TTS processing on the second text data to generate second audio data representing a translation of the condensed transcription into the target language. In some implementations, the system 100 may generate synthetic speech having identifiable or distinguishable characteristics; for example, to enable a user to differentiate between translations of a first speaker's speech and a second speaker's speech. In some implementations, the TTS component may, based on a speaker's voice characteristics, generate synthetic speech that approximates those characteristics with respect to, for example, timbre, cadence, pauses, inflection, etc.

The system 100 may, at a step 198, cause the device to output second audio based on the second audio data. In some cases, the device may receive a speaker's speech and output it to a first user (e.g., the user of the device). In some cases, the device may receive the first user's speech, and the system 100 may cause a second device associated with a second user to output audio representing a translation of the first user's speech. In some cases, the first and second users (e.g., the first device and the second device) may be geographically remote from each other.

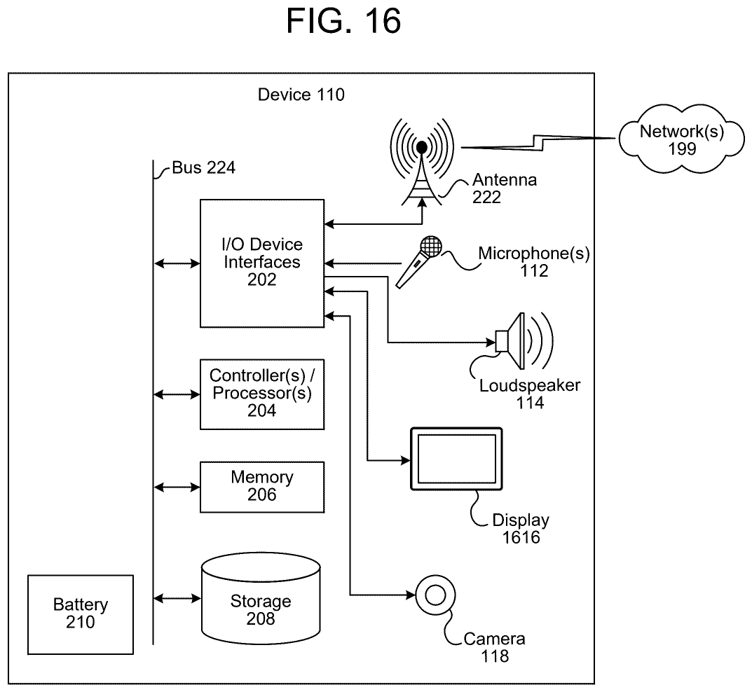

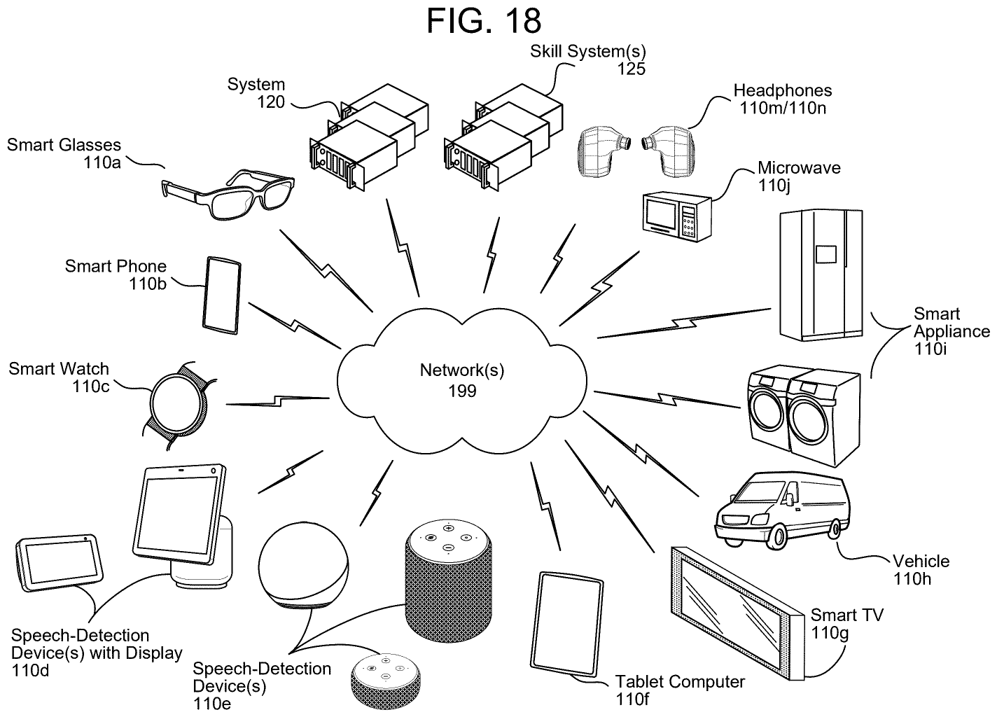

FIG. 2 is a conceptual diagram illustrating components of devices for use in a system providing speech translation, according to embodiments of the present disclosure. FIG. 2 illustrates the smart glasses 110a and earbud-style headphones 110m/110n as examples of devices 110, but other devices having different form factors may include the same and/or similar components and perform the functions described herein. For example, the device could be another type of wearable device a hat, necklace, headphones, etc., and/or a pocket device (e.g., with internal/external earphones and/or microphone), etc. The device 110 may include component the same as or similar to components of the devices 110 described with reference to FIGS. 16 and 18. For example, the device may include the microphone and/or microphone array 112 and the loudspeaker and/or loudspeaker array 114 as previously described. The microphone(s) 112 and loudspeaker(s) may connect to one or more processors 204 via input/output (I/O) device interfaces 202 and a bus 224. Via the bus 224, the processor(s) 204 may connect to a computer memory 206 (e.g., RAM), data storage 208, and/or an antenna 222. In some implementations, the device may include a camera 118 for taking still images and/or video. In some implementations, the device may include a display (e.g., such as the display 1616) that may be in the form of an LCD and/or heads-up display incorporating or adjacent to one or more lenses of the device. In some implementations, the device may include global positioning system (GPS) receivers/other location sensor(s), that may be used to determine a location of the device to, for example, provide additional data for language identification. The device may also include other components such as a proximity sensor, gyroscope, accelerometer, etc. The device may communicate with other devices 110 and/or systems 120 over the network 199 via the antenna 222. For example, the device may connect to one or more personal, shared, and/or public devices 110, one or more edge devices, and/or one or more remote systems 120. The other devices/systems may augment the functions of the device with, for example, more powerful processors, larger memory, storage, bandwidth, etc. Components of the device may be powered by one or more batteries 210. Other features of a device 110 (including wearable devices) are described in additional detail below with reference to FIG. 18.

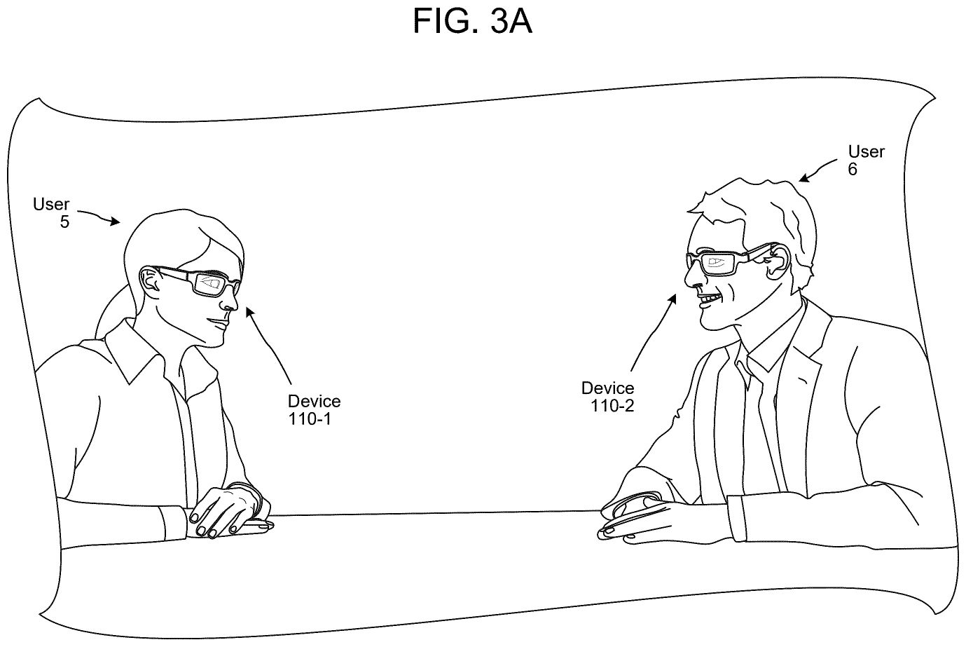

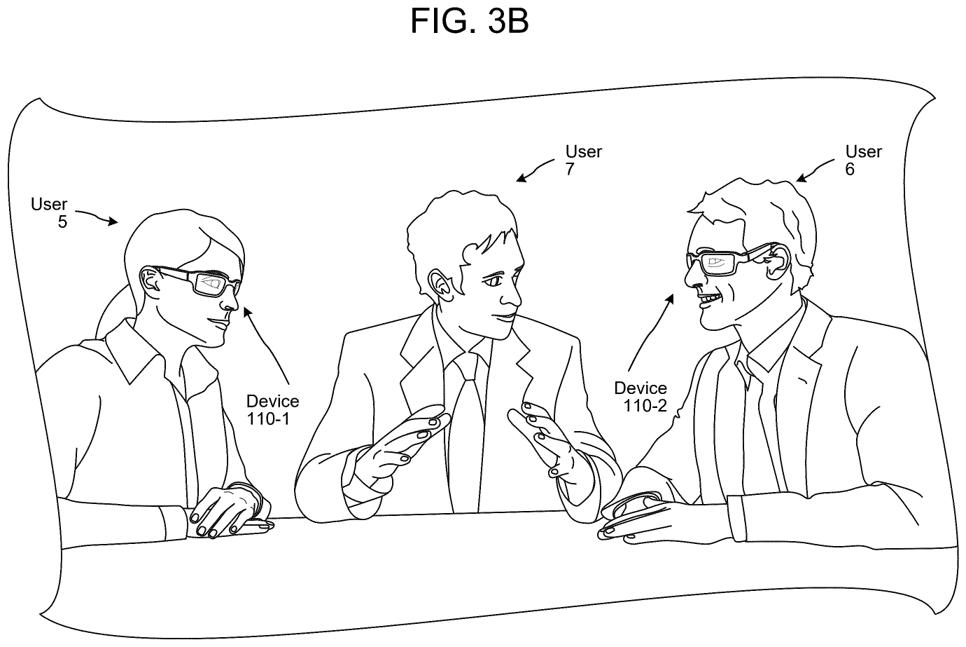

FIGS. 3A and 3B illustrate example multilingual conversations facilitated in part by one or more devices 110. In the example conversations, translation may be performed by a device 110 in conjunction with the system 100 (or multiple respective systems 100) previously described. FIG. 3A illustrates a first example scenario of a multilingual conversation facilitated by devices 110, according to embodiments of the present disclosure. A first user 5 and a second user 6 may have a multilingual conversation in which one of them speaks a first language and the other speaks a second language. The devices 110-1 and 110-2 may facilitate the multilingual conversation in various ways. For example, the first device 110-1 may receive speech of the second user 6 and translate it (e.g., as part of the system 100) for the first user 5. Similarly, the second device 110-2 may receive speech of the first user 5 and translate if for the second user 6. In another example, the first device 110-1 may receive the speech of the first user 5 (that is, the user wearing a wearable device), translate it, and cause the second device 110-2 to output the translated speech to the second user 6, and vice-versa. In this manner, the system 100 including the devices 110 may facilitate conversation in a noisy environment where isolating a single user's speech from background noise and other conversations may be challenging. In some implementations, the users 5 and 6 may be physically separated from either other; for example, in different rooms, different buildings, different cities, etc.

In some cases, the system 100 may still facilitate conversations in which not every user has/uses a device 110 of his/her own. FIG. 3B illustrates a second example scenario of a multilingual conversation where some but not all of the participants use devices 110 for speech translation, according to embodiments of the present disclosure. In this case, the user 7 does not have a dedicated device 110; however, the first device 110-1 may translate speech of the third user 7 for the first user 5, and the second device 110-2 may translate the speech of the third user 7 for the second user.

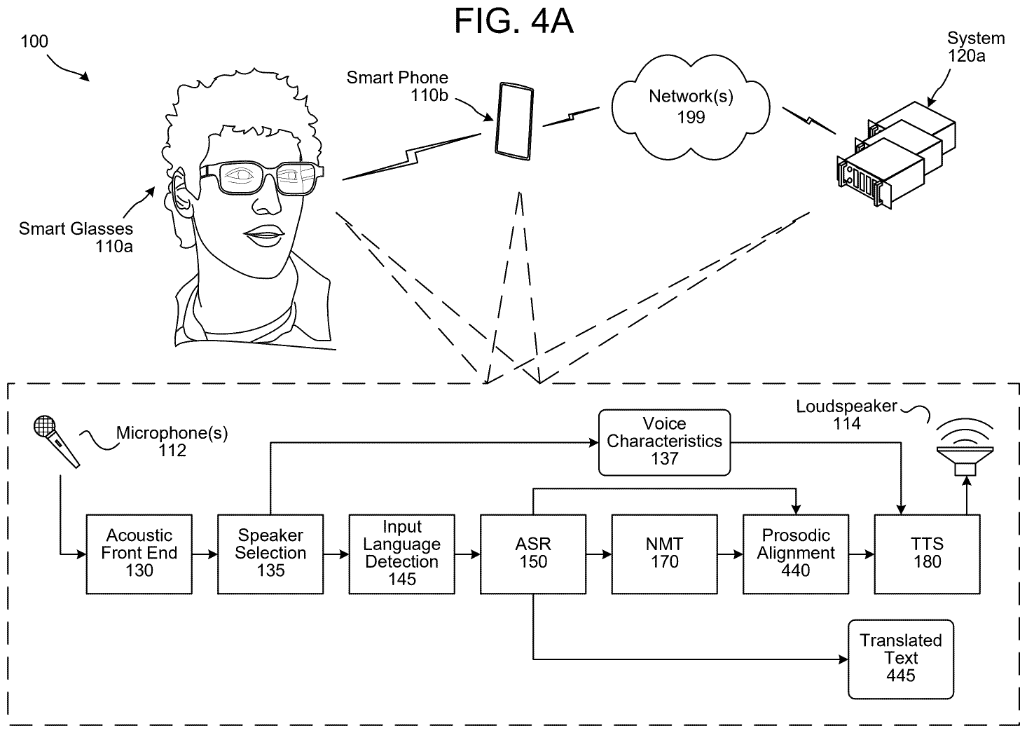

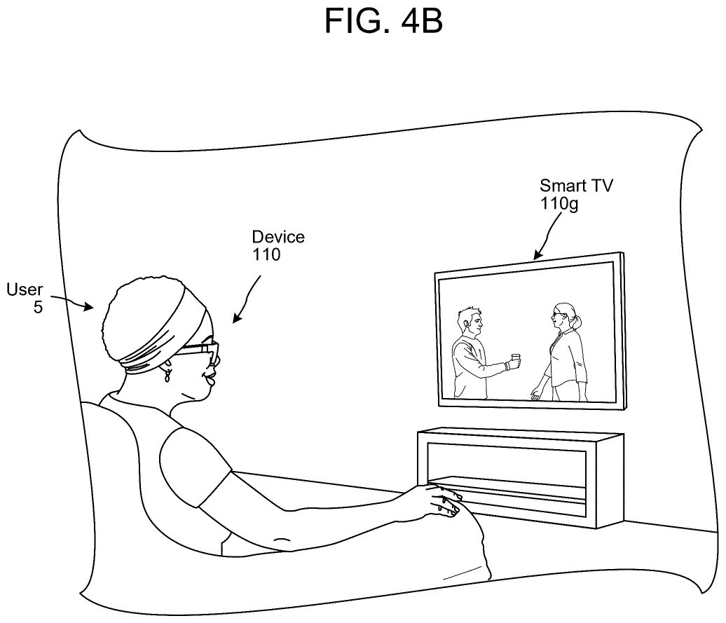

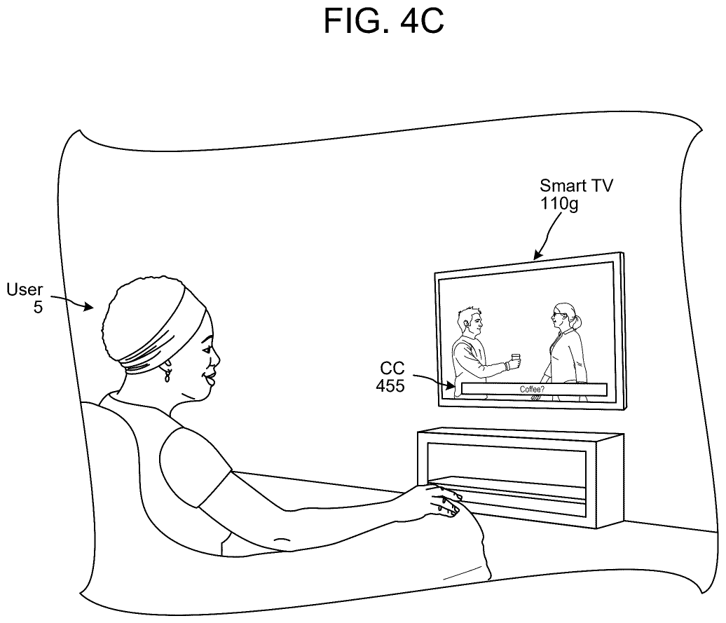

FIG. 4A is a conceptual diagram illustrating components of the speech translation system 100 configured to translate speech emitted from a media device using a device 110, according to embodiments of the present disclosure. A media device may be, for example, a device that may output audio and/or video to a user 5; for example, a television, radio, personal computer, mobile device, and/or speech-enabled device, etc. The system 100 may include many of the same components described previously with reference to FIG. 1A, and/or components similar thereto. For example, the system 100 may include the AFE 130, the speaker selection component 135, the input language detection component 145, the ASR component 150, the NMT component 170, a prosodic alignment component 440, and/or the TTS component 180. In addition to output translated speech, the system 100 shown in FIG. 4A may additional output translated text 445. Thus, the system 100 shown in FIG. 4A may provide both dubbing and closed captions to a user 5 watching a media device such as a television, projector, laptop computer, etc.

The prosodic alignment component 440 may add pauses before and/or after prosodic phrases to the synthesized speech. A prosodic phrase may be a segment of speech followed by a silent pause. A predetermined threshold may be used to determine when to insert a delay in the synthesized speech that corresponds to such a pause in the source speech; for example, 100 or 200 milliseconds. The prosodic alignment component 440 may leverage the attention mechanism of the NMT component 170 to determine which phrases of the target text correspond to phrases in the source text, and by extension the source speech exhibiting the pauses. Based on the timing information determined for the source speech (e.g., by the ASR component 150) and the phrase structure information determined for the source transcription (e.g., by the NMT component 170), the prosodic alignment component 440 may add timing information to the target transcription. The timing information may be used by the TTS component 180 to add corresponding pauses to the target speech. In some implementations, the pauses of the target speech may be shortened or elongated relative to the source speech in order to, for example, provide better alignment between the target speech and speech-related movements of the speaker of the source speech. In some implementations, the prosodic alignment component 440 may be incorporated into the NMT component 170 such that the NMT component 170 can output transcriptions in the target language that includes timing information that can allow the TTS component 180 to generate target speech having similar timing characteristics of the source speech.

Other techniques may be used to align the target speech with the source speech (that is, movements of the speaker of the source speech). For example, if a source language phrase has a certain duration and the target language phrase has a longer or shorter duration, the TTS component 180 may shorten or elongate the target speech to a certain degree to bring the durations into alignment, without creating an audible distortion or unnatural cadence in the target speech. For more extreme adjustments of the source speech to match timing or other characteristics of the source speech, the NMT component 170 may perform other time compensation functions as described below with reference to FIG. 7.

FIG. 4B illustrates a third example scenario of a user receiving a real-time translation of speech emitted from a media device via a device for speech translation, according to embodiments of the present disclosure. The user 5, wearing the device 110a, may be watching a movie, show, event, etc. on the media device, in this case a smart TV 110g. Although the smart TV 110g is used in the example scenarios shown in FIGS. 4B and 4C, the system 100 may translate speech emitted from any device capable of streaming video and/or audio. The system 100 may receive, via the device, source speech emitted from the media device. The system 100 may translate the source speech to generate target speech in a different language from the source speech. The system 100 may deliver the target speech to the user 5 via the device 110a. The system 100 may adjust the timing of the target speech (e.g., by modifying cadence and/or pauses in the speech) to align the target speech with the source speech and/or movements associated with the source speech (e.g., movements of the speakers face).

FIG. 4C illustrates a fourth example scenario of a user receiving a real-time closed-caption translation of speech emitted from a media device, according to embodiments of the present disclosure. In some implementations, the system 100 may provide translation in the form of closed captioning. For example, the system 100 may receive the source speech from the device 110a, translate to generate target text for the closed captioning 455, and send the target text to the smart TV 110g or similar component. In another example, the system 100 may receive the source speech from, and deliver the target text to, the smart TV 110g. In such cases, the user 5 may benefit from the translation provided by the system 100, even without wearing the device. In some implementations, the system 100 may provide the translation (e.g., as dubbed speech and/or closed captioning) in real time or near real time. That is, the system 100 need not process the audio of the movie/show/event in advance. Thus, the system 100 may provide translations for live events.

FIG. 5 is a conceptual diagram illustrating a natural language condenser component 155, according to embodiments of the present disclosure. The natural language condenser component 155 may receive ASR data 610 from the ASR component 150 and condense the text. In some implementations, the natural language condenser component 155 may receive additional data, such as NLU data 1185/1125 from the NLU component 160, sentiment data 1555/1575 from the sentiment detection component 172, and/or other context data 515a, 515b, 515c, etc. (collectively “context data 515”). The natural language condenser component 155 may use the received data to determine an alternative representation of the ASR data 610, and generate condensed ASR data 510.

The natural language condenser component 155 may include one or more neural network models configured to rewrite received input text to generate condensed text. The natural language condenser component 155 may store the models in a model storage component 550. For example, natural language condenser component 155 may include an encoder-decoder architecture with an attention-based mechanism, such as a sequence-to-sequence (seq2seq) model, that may rewrite the ASR data 610. FIG. 5 illustrates such an architecture. The natural language condenser component 155 may have an encoder 520, an attention mechanism 530, and a decoder 540.

The natural language condenser component 155 may retrieve parameters for the various networks/models from the model storage component 550. One or more models used by the natural language condenser component 155 may be trained to generate condensed ASR data 510 having different lengths; that is, different levels of verbosity. For example, a model of the natural language condenser component 155 may be trained with a verbosity token. Training data may be processed to compute a target-source length ratio for entries of the training data. Based on the length ratio, entries may be categorized as short, normal, and long. For example, entries having a length ratio near 1 (e.g., from 0.97 to 1.05) may be categorized as normal. Longer ratios may correspond to long, and shorter ratios may correspond to short. At training time, a verbosity token may be assigned to an embedding vector (e.g., similar to other tokens of the source vocabulary). Thus, the encoder 520 may be fed a sequence of embeddings that includes the verbosity tokens as well as other tokens representing the source sentence. At inference time, a verbosity control component 560 may prepend a verbosity value to the source text; for example, based on the context data 515 and/or the sentiment data 1555/1575. The natural language condenser component 155 may thus favor translations that match the verbosity value (e.g., rank them higher than possible translations that may be shorter/longer but have a similar score with regard to semantic meaning). In some implementations, the verbosity value may be provided to the encoder 520, the decoder 540, or both the encoder 520 and decoder 540. In some implementations, the verbosity embedding may be used as an extra bias vector; for example, in a final linear projection layer of the decoder 540.

The encoder 520 may read the source text (e.g., the ASR results data 610) in a streaming fashion. The encoder 520 may produce a hidden representation of the sentence. The hidden representation may be, for example, vectors representing words of the source text in, for example, a seq2seq model. The encoder 520 may be a recurrent neural network (RNN), such as a long short-term memory (LSTM) network.

In some implementations, the encoder 520 may receive NLU data 1185/1125 as an additional input. The NLU data may, for example, identify intents and/or entities represented in the ASR data 610. The NLU data may thus provide context to the encoder 520 when generating a hidden representation of a word and/or phrase in the ASR data 610.

The decoder 540 may also be a neural network such as a recurrent neural network (RNN). The decoder 540 may have access to the source text through the attention mechanism 530. The attention mechanism 530 may generate a context vector, which the decoder 540 may use at each time step to determine a next word. Using the attention mechanism 530, the decoder 540 may decide which word(s) of the ASR data 610 are most relevant for generating a condensed representation of the input text that preserves semantic meaning. Thus, the attention mechanism 530 can provide the decoder 540 with access to the source text other than just a single word. The attention mechanism 530 can further indicate a different importance to different words of the source text (or hidden representation) for purposes of condensing a given sentence or phrase. The decoder 540 may generate the condensed ASR data 510.

In some implementations, the natural language condenser component 155 may take into account context data when generating the condensed ASR data 510. For example, the verbosity control component 560 may use sentiment data 1555/1575, context data 515, etc., to determine a desired verbosity of the condensed ASR data 510. For example, based on the sentiment data, the natural language condenser component 155 may determine condensed ASR data 510 having a longer or shorter verbosity. Sentiment categories may be broad such as positive, neutral, and negative or may be more precise such as angry, happy, distressed, surprised, disgust, or the like. If the speech to be translated includes a strong emotional signal (e.g., strongly positive, strongly negative, elated, angry, disgusted, etc.), the natural language condenser component 155 may increase the verbosity of the condensed ASR data 510 such that a meaning and/or sentiment of the received speech is better represented in the eventual translation. Other context data 515 may be used to adjust verbosity including deference. The natural language condenser component 155 may determine that articles or inflections of the speech indicate speaking to a superior (high deference) or to a subordinate such as a child (low deference). The natural language condenser component 155 may translate with higher verbosity in the case of high deference, and lower verbosity in the case of low deference. Other context data 515 may include a fluency of a speaker and/or listener. The natural language condenser component 155 may receive a signal indicating a fluency of the speaker and/or listener, and adjust verbosity to, for example, use a higher verbosity output for more fluent speakers/listeners and a lower verbosity for less fluent speakers/listeners. In some implementations, the context data 515 may include user settings in which the user may manually adjust verbosity for their speech and/or received speech. The verbosity may be adjusted generally, or for particular situations such as social, professional, deference dependent, etc. The verbosity control component 560 may include one or more trainable models to generate verbosity tokens based on the various inputs.

FIG. 6 is a conceptual diagram of an ASR component 150, according to embodiments of the present disclosure. The ASR component 150 may include one or more models, such as a recurrent neural network transducer (RNN-T) 656, acoustic models 653, language models 654, finite state transducers (FSTs) 655, etc. The ASR component 150 may be configured to receive audio data 611 and output ASR data 610. The ASR component 150 may perform ASR processing as a stream; that is, receiving the audio data 611 as a continuous stream and output the ASR data 610 as a continuous stream without delaying processing until an end-of-speech or end-of-sentence indication is determined. In some implementations, the ASR component 150 may be configured to perform streaming ASR processing of audio data 611 representing speech uttered by more than one person; for example, first speech uttered by a first person and second speech uttered by a second person. In some cases, the first speech or second speech may represent audio output by a media device such as television, laptop computer, radio, etc.

The RNN-T 656 may include features that facilitate transcription of overlapping speech from different people. A single speaker RNN-T may include an encoder 670 (e.g., a transcription network), a decoder 680 (e.g., a prediction network), and a joint network 690. The encoder 670 may sequentially process acoustic features represented in the audio data 611 and generate high-level representations of the audio (e.g., similar to the output of the acoustic model 653 described below). The decoder 680 may predict a next label in a sequence given previous labels in the sequence (e.g., from the symbol history 685a or 685b). During training, ground truth may be used as a previous label context for the prediction network input; while during inference, previous non-blank prediction output may be used. The joint network 690 may be a feed-forward network that may process outputs from both the encoder 670 and the decoder 680. The joint network 690 may output a probability distribution over output labels using, for example, a softmax function 695a/695b to normalize the distribution.

In some implementations, the RNN-T 656 may perform speech separation within the encoder 670. Functions of the encoder 670 may thus be split between a mixture encoder 672, one or more speaker-dependent (SD) encoders 674a, 674b, etc., (collectively “SD encoders 674”) connected to respective recognition encoders 676a, 676b, etc. (collectively “recognition encoders 676”). The mixture encoder 672 may process input features and extract acoustic representations of the mixed speech. The acoustic representations of the mixed speech may be fed into the speaker-dependent encoders 674, which may have different parameters for each speaker (e.g., person), and thus may thus key into that speaker and generate separated intermediate encoder representations (e.g., speaker dependent representations). The speaker-dependent representations may be processed by the recognition encoders 676. In some implementations, the recognition encoders 676 may process the speaker-dependent representations in parallel. In some implementations, the recognition encoders 676 may process the speaker-dependent representations based on a shared set of parameters common to all speakers. The decoders 680a, 680b, etc. (collectively “decoders 680”) and join networks 690a, 690b, etc. (collectively “joint networks 690”) may process the respective outputs of the recognition encoder 676 (i.e., outputs corresponding to each speaker) similarly to processing the output of an encoder 670 handling speech from a single person.

In some implementations, the RNN-T 656 may include or be combined with language prediction features. For example, the RNN-T 656 may include an acoustic language identifier 660 (e.g., an acoustic language identification classifier). The acoustic language identifier 660 may be a neural network or other model that can infer a spoken language based on acoustic features. For example, the acoustic language identifier 660 may include a RNN with one or more LSTM layers followed by a projection layer. The output of the acoustic language identifier 660 may be feed in to the joint network(s) 690. Thus, the RNN-T 656 may receive the acoustic features at the acoustic language identifier 660 and the encoder 670. The joint network(s) 690 may receive the transcription from the encoder 670, prediction from the decoder(s) 680, and output from the acoustic language identifier 660. The joint network(s) 690 may process these data and output the ASR data 610 (e.g., in the case of a single speaker) or ASR data 610a, 610b, etc. (e.g., in the case of multiple speakers). In some implementations, the RNN-T 656 may include the language prediction(s) 665a, 665b, etc., (collectively, “language predictions 665”) as part of the ASR data 610 or output the language prediction(s) 665 separately from the ASR data 610.

Other ASR technologies may be employed in addition to or instead of the RNN-T 656. For example, the ASR component 150 may interpret a spoken natural language input based on the similarity between the spoken natural language input and pre-established language models 654 stored in an ASR model storage 652. For example, the ASR component 150 may compare the audio data with models for sounds (e.g., subword units or phonemes) and sequences of sounds to identify words that match the sequence of sounds spoken in the natural language input. Alternatively, the ASR component 150 may use a finite state transducer (FST) 655 to implement the language model functions.

When the ASR component 150 generates more than one ASR hypothesis for a single spoken natural language input, each ASR hypothesis may be assigned a score (e.g., probability score, confidence score, etc.) representing a likelihood that the corresponding ASR hypothesis matches the spoken natural language input (e.g., representing a likelihood that a particular set of words matches those spoken in the natural language input). The score may be based on a number of factors including, for example, the similarity of the sound in the spoken natural language input to models for language sounds (e.g., an acoustic model 653 stored in the ASR model storage 652), and the likelihood that a particular word, which matches the sounds, would be included in the sentence at the specific location (e.g., using a language or grammar model 654). Based on the considered factors and the assigned confidence score, the ASR component 150 may output an ASR hypothesis that most likely matches the spoken natural language input, or may output multiple ASR hypotheses in the form of a lattice or an N-best list, with each ASR hypothesis corresponding to a respective score.

The ASR component 150 may include a speech recognition engine 658. The ASR component 150 receives audio data 611 (for example, received from a local device 110 having processed audio detected by a microphone by an acoustic front end (AFE) or other component). The speech recognition engine 658 compares the audio data 611 with acoustic models 653, language models 654, FST(s) 655, and/or other data models and information for recognizing the speech conveyed in the audio data. The audio data 611 may be audio data that has been digitized (for example by an AFE) into frames representing time intervals for which the AFE determines a number of values, called features, representing the qualities of the audio data, along with a set of those values, called a feature vector, representing the features/qualities of the audio data within the frame. In at least some embodiments, audio frames may be 10 ms each. Many different features may be determined, as known in the art, and each feature may represent some quality of the audio that may be useful for ASR processing. A number of approaches may be used by an AFE to process the audio data, such as mel-frequency cepstral coefficients (MFCCs), perceptual linear predictive (PLP) techniques, neural network feature vector techniques, linear discriminant analysis, semi-tied covariance matrices, or other approaches known to those of skill in the art.

The speech recognition engine 658 may process the audio data 611 with reference to information stored in the ASR model storage 652. Feature vectors of the audio data 611 may arrive at the system 120 encoded, in which case they may be decoded prior to processing by the speech recognition engine 658. The ASR component 150 may be configured to perform ASR in multiple languages. The ASR component 150 may attempt to detect the language of incoming audio on its own or may receive an indication of the detected language from the input language detection component 145. The ASR component 150 may store models corresponding to different source and/or target language in the ASR model storage 652. In some implementations, certain ASR models may be shared among multiple languages and/or dialects, while others correspond to a single language and/or dialect. The ASR component 150 may then process the incoming audio based on the detected language.

The speech recognition engine 658 attempts to match received feature vectors to language acoustic units (e.g., phonemes) and words as known in the stored acoustic models 653, language models 654, and FST(s) 655. For example, audio data 611 may be processed by one or more acoustic model(s) 653 to determine acoustic unit data. The acoustic unit data may include indicators of acoustic units detected in the audio data 611 by the ASR component 150. For example, acoustic units can consist of one or more of phonemes, diaphonemes, tonemes, phones, diphones, triphones, or the like. The acoustic unit data can be represented using one or a series of symbols from a phonetic alphabet such as the X-SAMPA, the International Phonetic Alphabet, or Initial Teaching Alphabet (ITA) phonetic alphabets. In some implementations a phoneme representation of the audio data can be analyzed using an n-gram based tokenizer. An entity, or a slot representing one or more entities, can be represented by a series of n-grams.

The acoustic unit data may be processed using the language model 654 (and/or using FST 655) to determine ASR data 610. The ASR data 610 can include one or more hypotheses. One or more of the hypotheses represented in the ASR data 610 may then be sent to further components (such as the NLU component 160) for further processing as discussed herein. The ASR data 610 may include representations of text of an utterance, such as words, subword units, or the like.

The speech recognition engine 658 computes scores for the feature vectors based on acoustic information and language information. The acoustic information (such as identifiers for acoustic units and/or corresponding scores) is used to calculate an acoustic score representing a likelihood that the intended sound represented by a group of feature vectors matches a language phoneme. The language information is used to adjust the acoustic score by considering what sounds and/or words are used in context with each other, thereby improving the likelihood that the ASR component 150 will output ASR hypotheses that make sense grammatically. The specific models used may be general models or may be models corresponding to a particular domain, such as music, banking, etc.

The speech recognition engine 658 may use a number of techniques to match feature vectors to phonemes, for example using Hidden Markov Models (HMMs) to determine probabilities that feature vectors may match phonemes. Sounds received may be represented as paths between states of the HMM and multiple paths may represent multiple possible text matches for the same sound. Further techniques, such as using FSTs, may also be used.

The speech recognition engine 658 may use the acoustic model(s) 653 to attempt to match received audio feature vectors to words or subword acoustic units. An acoustic unit may be a senone, phoneme, phoneme in context, syllable, part of a syllable, syllable in context, or any other such portion of a word. The speech recognition engine 658 computes recognition scores for the feature vectors based on acoustic information and language information. The acoustic information is used to calculate an acoustic score representing a likelihood that the intended sound represented by a group of feature vectors match a subword unit. The language information is used to adjust the acoustic score by considering what sounds and/or words are used in context with each other, thereby improving the likelihood that the ASR component 150 outputs ASR hypotheses that make sense grammatically.

The speech recognition engine 658 may use a number of techniques to match feature vectors to phonemes or other acoustic units, such as diphones, triphones, etc. One common technique is using Hidden Markov Models (HMMs). HMMs are used to determine probabilities that feature vectors may match phonemes. Using HMMs, a number of states are presented, in which the states together represent a potential phoneme (or other acoustic unit, such as a triphone) and each state is associated with a model, such as a Gaussian mixture model or a deep belief network. Transitions between states may also have an associated probability, representing a likelihood that a current state may be reached from a previous state. Sounds received may be represented as paths between states of the HMM and multiple paths may represent multiple possible text matches for the same sound. Each phoneme may be represented by multiple potential states corresponding to different known pronunciations of the phonemes and their parts (such as the beginning, middle, and end of a spoken language sound). An initial determination of a probability of a potential phoneme may be associated with one state. As new feature vectors are processed by the speech recognition engine 658, the state may change or stay the same, based on the processing of the new feature vectors. A Viterbi algorithm may be used to find the most likely sequence of states based on the processed feature vectors.

The probable phonemes and related states/state transitions, for example HMM states, may be formed into paths traversing a lattice of potential phonemes. Each path represents a progression of phonemes that potentially match the audio data represented by the feature vectors. One path may overlap with one or more other paths depending on the recognition scores calculated for each phoneme. Certain probabilities are associated with each transition from state to state. A cumulative path score may also be calculated for each path. This process of determining scores based on the feature vectors may be called acoustic modeling. When combining scores as part of the ASR processing, scores may be multiplied together (or combined in other ways) to reach a desired combined score or probabilities may be converted to the log domain and added to assist processing.

The speech recognition engine 658 may also compute scores of branches of the paths based on language models or grammars. Language modeling involves determining scores for what words are likely to be used together to form coherent words and sentences. Application of a language model may improve the likelihood that the ASR component 150 correctly interprets the speech contained in the audio data. For example, for an input audio sounding like “hello,” acoustic model processing that returns the potential phoneme paths of “H E L O”, “H A L O”, and “Y E L O” may be adjusted by a language model to adjust the recognition scores of “H E L O” (interpreted as the word “hello”), “H A L O” (interpreted as the word “halo”), and “Y E L O” (interpreted as the word “yellow”) based on the language context of each word within the spoken utterance.

FIG. 7 is a conceptual diagram illustrating a translation component (NMT) 170, according to embodiments of the present disclosure. The NMT COMPONENT 170 may receive source text in a first language (e.g., the condensed ASR data 510) and generate target text in a second language (e.g., the text data 710). The NMT COMPONENT 170 may translate the source text in a manner that preserves semantic meaning; for example, by translating all or portions of the condensed ASR data 510 in semantic translation units, rather than performing a rote word-for-word transcription, which may ignore context and/or different meanings of words when used in different combinations. The NMT COMPONENT 170 may perform the translation using an attention-based mechanism; for example, such as that found in a transformer DNN architecture.

The NMT COMPONENT 170 may include an encoder 720, an attention mechanism 730, and a decoder 740. The NMT COMPONENT 170 may retrieve parameters for the various networks/models from a model storage 750. The encoder 720 may read the source text until an end-of-sentence (EOS) indicator or symbol is received (although the NMT component 170 may translate the condensed ASR data 510 in a streaming fashion without waiting for an EOS to begin translating). The encoder 720 may produce a hidden representation of the sentence. The hidden representation may be, for example, vectors representing words of the source text in, for example, a sequence-to-sequence model. The encoder 720 may be a recurrent neural network (RNN), such as a long short-term memory (LSTM) network.

The decoder 740 may also be a neural network such as a recurrent neural network (RNN). The decoder 740 may produce the target text 710 starting with a beginning-of-sentence (BOS) indicator or symbol. The decoder 740 may have access to the source text through the attention mechanism 730. The attention mechanism 730 may generate a context vector 735. The context vector 735 may be filtered for each output time step (e.g., each word). The decoder 740 may use the context vector 735 at each time step to predict the next word. Using the attention mechanism 730, the decoder 740 may decide which word(s) are most relevant for generating a target word. Thus, the attention mechanism 730 provides the decoder 740 with access to the source text other than just a single word being translated. The attention mechanism 730 can further indicate a different importance to different words of the source text (or hidden representation) for purposes of translating a given word. In other words, the attention mechanism 730 may enable the decoder 740 to focus on the most relevant parts of a source sentence. This may aid the decoder's 740 capability to correctly translate an ambiguous word or phrase. The decoder 740 may predict subsequent words in the sequence based on the generated word and its hidden representation. The decoder 740 may continue to generate words until it predicts an EOS.

One of both of the encoder 720 or the decoder 740 may include a confidence mechanism. The confidence mechanism may determine a confidence score associated an interpretation of word or phrase (in the case of the encoder 720), or the hidden representation of the word or phrase (in the case of the decoder 740). The confidence score may represent a likelihood that a word/phrase or hidden representation can be unambiguously associated with a particular meaning/translation based on the current information. If the score does not satisfy a certain condition (e.g., is below a threshold), the encoder 720/decoder 740 may continue to process words/hidden representations until the condition is satisfied (e.g., meets or exceeds a threshold). In an example operation, the encoder 720 may receive a word having multiple meanings in the source language (e.g., “run” as used in the earlier example). The encoder 720 may wait to receive additional words until it is has enough information to ascribe “run” to a particular meaning with sufficient confidence. One it has done so, it may output the hidden representation. Likewise, the decoder 740 may receive the hidden representations, which may correspond to one or more possible words in the target language. For example, a hidden representation having a meaning of a manner of locomotion faster than a walk and in which the feet never touch the ground at the same time. Such a meaning may correspond to multiple words in the target language; for example, literal translations of “run,” “jog,” “sprint,” “dash,” etc. Thus, the decoder 740 may continue to receive hidden representations of other words until it can select a translation for the chosen hidden representation of “run” with sufficient confidence, taking into account the attention data from the attention mechanism 730.

In some implementations, the NMT component 170 may leverage natural language processing capabilities of the NLU component 160. For example, the NMT component 170 may receive NLU output data that represents a semantic representation of the speech. For example, the NLU results data may represent semantically cohesive speech portions, for example, in the form of <noun> <verb> <subject> etc. Based on the semantic portioning provided by the NLU processing, the NMT component 170 may determine that a portion of the condensed ASR data 510 represents a semantically cohesive segment of speech. The NLU output data may further include intent classification and/or entity resolution data, which may provide information to the NMT component 170 regarding a meaning of a particular word or phrase in the context of the recognized speech. The encoder 720 may thus use the NLU output data to select an appropriate hidden representation of a source text word or phrase from among multiple possibilities.

In some implementations, the NMT component 170 may include features that can control the length of the target text; for example, to allow for better alignment with the source text/speech and/or to reduce the length of time needed to deliver the translation. That is, providing shorter, terser, and/or condensed translated speech may allow the user to direct more attention towards members of the conversation rather than the device and its output. In some implementations, one or more models used by the NMT component 170 may be trained with a verbosity token. For example, training data may be processed to compute a target-source length ratio for entries of the training data. Based on the length ratio, entries may be categorized as short, normal, and long. For example, entries having a length ratio near 1 (e.g., from 0.97 to 1.05) may be categorized as normal. Longer ratios may correspond to long, and shorter ratios may correspond to short. At training time, a verbosity token may be assigned to an embedding vector (e.g., similar to other tokens of the source vocabulary). Thus, the encoder 720 may be fed a sequence of embeddings that includes the verbosity tokens as well as other tokens representing the source sentence. At inference time, a verbosity value may be prepended to the source text. The NMT component 170 may thus favor translations that match the verbosity value (e.g., rank them higher than possible translations that may be shorter/longer but have a similar score with regard to semantic meaning). In some implementations, the verbosity value may be provided to the encoder 720, the decoder 740, or both the encoder 720 and decoder 740. In some implementations, the verbosity embedding may be used as an extra bias vector; for example, in a final linear projection layer of the decoder 740.

FIG. 8 is a conceptual diagram of components of a system to detect if input audio data includes system directed speech, according to embodiments of the present disclosure. The system directed input detector (SDD) 140 may receive various inputs and indications is described below and output an SDD result 842. The system 100 may use the SDD result 842 to, for example, determine whether a selected speaker is directing speech towards the wearable device (and therefore the user 5) and thus determine that the speech should be translated. The system directed input detector 140 may include a number of different components. First, the system directed input detector 140 may include a voice activity detector (VAD) 820. The VAD 820 may operate to detect whether the incoming audio data 611 includes speech or not. The VAD output 821 may be a binary indicator. Thus, if the incoming audio data 611 includes speech, the VAD 820 may output an indicator 821 that the audio data 611 does includes speech (e.g., a 1) and if the incoming audio data 611 does not includes speech, the VAD 820 may output an indicator 821 that the audio data 611 does not includes speech (e.g., a 0). The VAD output 821 may also be a score (e.g., a number between 0 and 1) corresponding to a likelihood that the audio data 611 includes speech. The VAD 820 may also perform start-point detection as well as end-point detection where the VAD 820 determines when speech starts in the audio data 611 and when it ends in the audio data 611. Thus the VAD output 821 may also include indicators of a speech start point and/or a speech endpoint for use by other components of the system. (For example, the start-point and end-points may demarcate the audio data 611 that is sent to the speech processing component 240.) The VAD output 821 may be associated with a same unique ID as the audio data 611 for purposes of tracking system processing across various components.

The VAD 820 may operate using a variety of VAD techniques, including those described above with regard to VAD operations performed by device 110. The VAD may be configured to be robust to background noise so as to accurately detect when audio data actually includes speech or not. The VAD 820 may operate on raw audio data 611 such as that sent by device 110 or may operate on feature vectors or other data representing the audio data 611. For example, the VAD 820 may take the form of a deep neural network (DNN) and may operate on a single feature vector representing the entirety of audio data 611 received from the device or may operate on multiple feature vectors, for example feature vectors representing frames of audio data where each frame covers a certain amount of time of audio data (e.g., 25 ms). The VAD 820 may also operate on other data 881 that may be useful in detecting voice activity in the audio data 611. For example, the other data 881 may include results of anchored speech detection where the system takes a representation (such as a voice fingerprint, reference feature vector, etc.) of a reference section of speech (such as speech of a voice that uttered a previous command to the system that included a wakeword) and compares a voice detected in the audio data 611 to determine if that voice matches a voice in the reference section of speech. If the voices match, that may be an indicator to the VAD 820 that speech was detected. If not, that may be an indicator to the VAD 820 that speech was not detected. (For example, a representation may be taken of voice data in the first input audio data which may then be compared to the second input audio data to see if the voices match. If they do (or do not) that information may be considered by the VAD 820.) The VAD 820 may also consider other data when determining if speech was detected. The VAD 820 may also consider speaker ID information (such as may be output by user recognition component 195), directionality data that may indicate what direction (relative to the capture device 110) the incoming audio was received from. Such directionality data may be received from the device 110 and may have been determined by a beamformer or other component of device 110. The VAD 820 may also consider data regarding a previous utterance which may indicate whether the further audio data received by the system is likely to include speech. Other VAD techniques may also be used.

If the VAD output 821 indicates that no speech was detected the system (through, for example, an orchestrator component or some other component) may discontinue processing with regard to the audio data 611, thus saving computing resources that might otherwise have been spent on other processes (e.g., ASR for the audio data 611, etc.). If the VAD output 821 indicates that speech was detected, the system may make a determination as to whether the speech was or was not directed to the speech-processing system. Such a determination may be made by the system directed audio detector 840. The system directed audio detector 840 may include a trained model, such as a DNN, that operates on a feature vector which represent certain data that may be useful in determining whether or not speech is directed to the system. To create the feature vector operable by the system directed audio detector 840, a feature extractor 830 may be used. The feature extractor 830 may input ASR results 610 which include results from the processing of the audio data 611 by the ASR component 150. For privacy protection purposes, in certain configurations the ASR results 610 may be obtained from an ASR component 150 located on device 110 or on a home remote component as opposed to an ASR component 150 located on a cloud or other remote system 120 so that audio data 611 is not sent remote from the user's home unless the system directed input detector component 140 has determined that the input is system directed. Though this may be adjusted depending on user preferences/system configuration.

The ASR results 610 may include an N-best list of top scoring ASR hypotheses and their corresponding scores, portions (or all of) an ASR lattice/trellis with scores, portions (or all of) an ASR search graph with scores, portions (or all of) an ASR confusion network with scores, or other such ASR output. As an example, the ASR results 610 may include a trellis, which may include a raw search graph as scored during ASR decoding. The ASR results 610 may also include a lattice, which may be a trellis as scored that has been pruned to remove certain hypotheses that do not exceed a score threshold or number of hypotheses threshold. The ASR results 610 may also include a confusion network where paths from the lattice have been merged (e.g., merging hypotheses that may share all or a portion of a same word). The confusion network may be a data structure corresponding to a linear graph that may be used as an alternate representation of the most likely hypotheses of the decoder lattice. The ASR results 610 may also include corresponding respective scores (such as for a trellis, lattice, confusion network, individual hypothesis, N-best list, etc.)

The ASR results 610 (or other data 891) may include other ASR result related data such as other features from the ASR system or data determined by another component. For example, the system may determine an entropy of the ASR results (for example a trellis entropy or the like) that indicates a how spread apart the probability mass of the trellis is among the alternate hypotheses. A large entropy (e.g., large spread of probability mass over many hypotheses) may indicate the ASR component 150 being less confident about its best hypothesis, which in turn may correlate to detected speech not being device directed. The entropy may be a feature included in other data 891 to be considered by the system directed audio detector 840.

The system may also determine and consider ASR decoding costs, which may include features from Viterbi decoding costs of the ASR. Such features may indicate how well the input acoustics and vocabulary match with the acoustic models 653 and language models 654. Higher Viterbi costs may indicate greater mismatch between the model and the given data, which may correlate to detected speech not being device directed. Confusion network feature may also be used. For example, an average number of arcs (where each arc represents a word) from a particular node (representing a potential join between two words) may measure how many competing hypotheses there are in the confusion network. A large number of competing hypotheses may indicate that the ASR component 150 is less confident about the top hypothesis, which may correlate to detected speech not being device directed. Other such features or data from the ASR results 610 may also be used as other data 891.

The ASR results 610 may be represented in a system directed detector (SDD) feature vector 831 that can be used to determine whether speech was system-directed. The feature vector 831 may represent the ASR results 610 but may also represent audio data 611 (which may be input to feature extractor 830) or other information. Such ASR results may be helpful in determining if speech was system-directed. For example, if ASR results include a high scoring single hypothesis, that may indicate that the speech represented in the audio data 611 is directed at, and intended for, the device 110. If, however, ASR results do not include a single high scoring hypothesis, but rather many lower scoring hypotheses, that may indicate some confusion on the part of the ASR component 150 and may also indicate that the speech represented in the audio data 611 was not directed at, nor intended for, the device 110.

The ASR results 610 may include complete ASR results, for example ASR results corresponding to all speech between a startpoint and endpoint (such as a complete lattice, etc.). In this configuration the system may wait until all ASR processing for a certain input audio has been completed before operating the feature extractor 830 and system directed audio detector 840. Thus the system directed audio detector 840 may receive a feature vector 831 that includes all the representations of the audio data 611 created by the feature extractor 830. The system directed audio detector 840 may then operate a trained model (such as a DNN) on the feature vector 831 to determine a score corresponding to a likelihood that the audio data 611 includes a representation of system-directed speech. If the score is above a threshold, the system directed audio detector 840 may determine that the audio data 611 does include a representation of system-directed speech. The SDD result 842 may include an indicator of whether the audio data includes system-directed speech, a score, and/or some other data.

The ASR results 610 may also include incomplete ASR results, for example ASR results corresponding to only some speech between a between a startpoint and endpoint (such as an incomplete lattice, etc.). In this configuration the feature extractor 830/system directed audio detector 840 may be configured to operate on incomplete ASR results 610 and thus the system directed audio detector 840 may be configured to output an SSD result 842 that provides an indication as to whether the portion of audio data processed (that corresponds to the incomplete ASR results) corresponds to system directed speech. The system may thus be configured to perform ASR at least partially in parallel with the system directed audio detector 840 to process ASR result data as it is ready and thus continually update an SDD result 842. Once the system directed input detector 140 has processed enough ASR results and/or the SDD result 842 exceeds a threshold, the system may determine that the audio data 611 includes system-directed speech. Similarly, once the system directed input detector 140 has processed enough ASR results and/or the SDD result 842 drops below another threshold, the system may determine that the audio data 611 does not include system-directed speech.

The SDD result 842 may be associated with a same unique ID as the audio data 611 and VAD output 821 for purposes of tracking system processing across various components.

The feature extractor 830 may also incorporate in a feature vector 831 representations of other data 891. Other data 891 may include, for example, word embeddings from words output by the ASR component 150 may be considered. Word embeddings are vector representations of words or sequences of words that show how specific words may be used relative to other words, such as in a large text corpus. A word embedding may be of a different length depending on how many words are in a text segment represented by the word embedding. For purposes of the feature extractor 830 processing and representing a word embedding in a feature vector 831 (which may be of a fixed length), a word embedding of unknown length may be processed by a neural network with memory, such as an LSTM (long short term memory) network. Each vector of a word embedding may be processed by the LSTM which may then output a fixed representation of the input word embedding vectors.

Other data 891 may also include, for example, NLU output from the NLU component 160 may be considered. Thus, if natural language output data 1185/1125 indicates a high correlation between the audio data 611 and an out-of-domain indication (e.g., no intent classifier scores from ICs 1064 or overall domain scores from recognizers 1063 reach a certain confidence threshold), this may indicate that the audio data 611 does not include system-directed speech. Other data 891 may also include, for example, an indicator of a user/speaker as output user recognition component 195. Thus, for example, if the user recognition component 195 does not indicate the presence of a known user, or indicates the presence of a user associated with audio data 611 that was not associated with a previous utterance, this may indicate that the audio data 611 does not include system-directed speech. The other data 891 may also include an indication that a voice represented in audio data 611 is the same (or different) as the voice detected in previous input audio data corresponding to a previous utterance. The other data 891 may also include directionality data, for example using beamforming or other audio processing techniques to determine a direction/location of a source of detected speech and whether that source direction/location matches a speaking user. The other data 891 may also include data indicating that a direction of a user's speech is toward a device 110 or away from a device 110, which may indicate whether the speech was system directed or not.

Other data 891 may also include image data 811 (e.g., from the camera 118). For example, if image data is detected from one or more devices that are nearby to the device 110 (which may include the device 110 itself) that captured the audio data being processed using the system directed input detector (140), the image data may be processed to determine whether a user is facing an audio capture device for purposes of determining whether speech is system-directed as further explained below.

Other data 891 may also dialog history data. For example, the other data 891 may include information about whether a speaker has changed from a previous utterance to the current audio data 611, whether a topic of conversation has changed from a previous utterance to the current audio data, how NLU results from a previous utterance compare to NLU results obtained using the current audio data 611, other system context information. The other data 891 may also include an indicator as to whether the audio data 611 was received as a result of a wake command or whether the audio data 611 was sent without the device 110 detecting a wake command (e.g., the device 110 being instructed by remote system 120 and/or determining to send the audio data without first detecting a wake command).

Other data 891 may also include information from a user profile.

Other data 891 may also include direction data, for example data regarding a direction of arrival of speech detected by the device, for example a beam index number, angle data, or the like. If second audio data is received from a different direction than first audio data, then the system may be less likely to declare the second audio data to include system-directed speech since it is originating from a different location.

Other data 891 may also include acoustic feature data such as pitch, prosody, intonation, volume, or other data descriptive of the speech in the audio data 611. As a user may use a different vocal tone to speak with a machine than with another human, acoustic feature information may be useful in determining if speech is device-directed.

Other data 891 may also include an indicator that indicates whether the audio data 611 includes a wakeword. For example, if a device 110 detects a wakeword prior to sending the audio data 611 to the remote system 120, the device 110 may send along an indicator that the device 110 detected a wakeword in the audio data 611. In another example, the remote system 120 may include another component that processes incoming audio data 611 to determine if it includes a wakeword. If it does, the component may create an indicator indicating that the audio data 611 includes a wakeword. The indicator may then be included in other data 891 to be incorporated in the feature vector 831 and/or otherwise considered by the system directed audio detector 840.

Other data 891 may also include device history data such as information about previous operations related to the device 110 that sent the audio data 611. For example, the other data 891 may include information about a previous utterance that was just executed, where the utterance originated with the same device 110 as a current utterance and the previous utterance was within a certain time window of the current utterance. Device history data may be stored in a manner associated with the device identifier (which may also be included in other data 891), which may also be used to track other information about the device, such as device hardware, capability, location, etc.

The other data 881 used by the VAD 820 may include similar data and/or different data from the other data 891 used by the feature extractor 830. The other data 881/891 may thus include a variety of data corresponding to input audio from a previous utterance. That data may include acoustic data from a previous utterance, speaker ID/voice identification data from a previous utterance, information about the time between a previous utterance and a current utterance, or a variety of other data described herein taken from a previous utterance. A score threshold (for the system directed audio detector 840 and/or the VAD 820) may be based on the data from the previous utterance. For example, a score threshold (for the system directed audio detector 840 and/or the VAD 820) may be based on acoustic data from a previous utterance.

The feature extractor 830 may output a single feature vector 831 for one utterance/instance of input audio data 611. The feature vector 831 may consistently be a fixed length, or may be a variable length vector depending on the relevant data available for particular audio data 611. Thus, the system directed audio detector 840 may output a single SDD result 842 per utterance/instance of input audio data 611. The SDD result 842 may be a binary indicator. Thus, if the incoming audio data 611 includes system-directed speech, the system directed audio detector 840 may output an indicator 842 that the audio data 611 does includes system-directed speech (e.g., a 1) and if the incoming audio data 611 does not includes system-directed speech, the system directed audio detector 840 may output an indicator 842 that the audio data 611 does not system-directed includes speech (e.g., a 0). The SDD result 842 may also be a score (e.g., a number between 0 and 1) corresponding to a likelihood that the audio data 611 includes system-directed speech. Although not illustrated in FIG. 8, the flow of data to and from the system directed input detector 140 may be managed by the orchestrator component or by one or more other components.

The trained model(s) of the system directed audio detector 840 may be trained on many different examples of SDD feature vectors that include both positive and negative training samples (e.g., samples that both represent system-directed speech and non-system directed speech) so that the DNN and/or other trained model of the system directed audio detector 840 may be capable of robustly detecting when speech is system-directed versus when speech is not system-directed.

A further input to the system directed input detector 140 may include output data from TTS component 180 to avoid synthesized speech output by the system being confused as system-directed speech spoken by a user. The output from the TTS component 180 may allow the system to ignore synthesized speech in its considerations of whether speech was system directed. The output from the TTS component 180 may also allow the system to determine whether a user captured utterance is responsive to the TTS output, thus improving system operation.

The system directed input detector 140 may also use echo return loss enhancement (ERLE) and/or acoustic echo cancellation (AEC) data to avoid processing of audio data generated by the system.

As shown in FIG. 8, the system directed input detector 140 may simply user audio data to determine whether an input is system directed (for example, system directed audio detector 840 may output an SDD result 842). This may be true particularly when no image data is available (for example for a device without a camera). If image data 811 is available, however, the system may also be configured to use image data 811 to determine if an input is system directed. The image data 811 may include image data captured by device 110 and/or image data captured by other device(s) in the environment of device 110. The audio data 611, image data 811 and other data 881 may be timestamped or otherwise correlated so that the system directed input detector 140 may determine that the data being analyzed all relates to a same time window so as to ensure alignment of data considered with regard to whether a particular input is system directed. For example, the system directed input detector 140 may determine system directedness scores for every frame of audio data/every image of a video stream and may align and/or window them to determine a single overall score for a particular input that corresponds to a group of audio frames/images.

Image data 811 along with other data 881 may be received by feature extractor 835. The feature extractor may create one or more feature vectors 836 which may represent the image data 811/other data 881. In certain examples, other data 881 may include data from image processing component 142 which may include information about faces, gesture, etc. detected in the image data 811. For privacy protection purposes, in certain configurations any image processing/results thereof may be obtained from an image processing component 142 located on device 110 or on a home remote component as opposed to a image processing component 142 located on a cloud or other remote system 120 so that image data 811 is not sent remote from the user's home unless the system directed input detector component 140 has determined that the input is system directed. Though this may be adjusted depending on user preferences/system configuration.

The feature vector 836 may be passed to the user detector 825. The user detector 825 (which may use various components/operations of image processing component 142, user recognition component 195, etc.) may be configured to process image data 811 and/or feature vector 836 to determine information about the user's behavior which in turn may be used to determine if an input is system directed. For example, the user detector 825 may be configured to determine the user's position/behavior with respect to device 110/system 100. The user detector 825 may also be configured to determine whether a user's mouth is opening/closing in a manner that suggests the user is speaking. The user detector 825 may also be configured to determine whether a user is nodding or shaking his/her head. The user detector 825 may also be configured to determine whether a user's gaze is directed to the device 110, to another user, or to another object. The user detector 825 may also be configured to determine gestures of the user such as a shoulder shrug, pointing toward an object, a wave, a hand up to indicate an instruction to stop, or a fingers moving to indicate an instruction to continue, holding up a certain number of fingers, putting a thumb up, etc. The user detector 825 may also be configured to determine a user's position/orientation such as facing another user, facing the device 110, whether their back is turned, etc. The user detector 825 may also be configured to determine relative positions of multiple users that appear in image data (and/or are speaking in audio data 611 which may also be considered by the user detector 825 along with feature vector 831), for example which users are closer to a device 110 and which are farther away. The user detector 825 (and/or other component) may also be configured to identify other objects represented in image data and determine whether objects are relevant to a dialog or system interaction (for example determining if a user is referring to an object through a movement or speech).

The user detector 825 may operate one or more models (e.g., one or more classifiers) to determine if certain situations are represented in the image data 811. For example the user detector 825 may employ a visual directedness classifier that may determine, for each face detected in the image data 811 whether that face is looking at the device 110 or not. For example, a light-weight convolutional neural network (CNN) may be used which takes a face image cropped from the result of the face detector as input and output a [0,1] score of how likely the face is directed to the camera or not. Another technique may include to determine a three-dimensional (3D) landmark of each face, estimate the 3D angle of the face and predict a directness score based on the 3D angle.

The user detector 825 (or other component(s) such as those in image processing 142) may be configured to track a face in image data to determine which faces represented may belong to a same person. The system may user IOU based tracker, a mean-shift based tracker, a particle filter based tracker, or other technique.

The user detector 825 (or other component(s) such as those in user recognition component 195) may be configured to determine whether a face represented in image data belongs to a person who is speaking or not, thus performing active speaker detection. The system may take the output from the face tracker and aggregate a sequence of face from the same person as input and predict whether this person is speaking or not. Lip motion, user ID, detected voice data, and other data may be used to determine whether a user is speaking or not.

The system directed image detector 850 may then determine, based on information from the user detector 825 as based on the image data whether an input relating to the image data is system directed. The system directed image detector 850 may also operate on other input data, for example image data including raw image data 811, image data including feature data 836 based on raw image data, other data 881, or other data. The determination by the system directed image detector 850 may result in a score indicating whether the input is system directed based on the image data. If no audio data is available, the indication may be output as SDD result 842. If audio data is available, the indication may be sent to system directed detector 870 which may consider information from both system directed audio detector 840 and system directed image detector 850. The system directed detector 870 may then process the data from both system directed audio detector 840 and system directed image detector 850 to come up with an overall determination as to whether an input was system directed, which may be output as SDD result 842. The system directed detector 870 may consider not only data output from system directed audio detector 840 and system directed image detector 850 but also other data/metadata corresponding to the input (for example, image data/feature data 836, audio data/feature data 831, image data 811, audio data 611, or the like discussed with regard to FIG. 8. The system directed detector 870 may include one or more models which may analyze the various input data to make a determination regarding SDD result 842.

In one example the determination of the system directed detector 870 may be based on “AND” logic, for example determining an input is system directed only if affirmative data is received from both system directed audio detector 840 and system directed image detector 850. In another example the determination of the system directed detector 870 may be based on “OR” logic, for example determining an input is system directed if affirmative data is received from either system directed audio detector 840 or system directed image detector 850. In another example the data received from system directed audio detector 840 and system directed image detector 850 are weighted individually based on other information available to system directed detector 870 to determine to what extend audio and/or image data should impact the decision of whether an input is system directed.

The system directed input detector 140 may also receive information from a wakeword detection component 122. For example, an indication that a wakeword was detected (e.g., WW data 844) may be considered by the system directed input detector 140 (e.g., by system directed audio detector 840, system directed detector 870, etc.) as part of the overall consideration of whether a system input was device directed. Detection of a wakeword may be considered a strong signal that a particular input was device directed.

If an input is determined to be system directed, the data related to the input may be sent to downstream components for further processing (e.g., to the ASR component 150). If an input is determined not to be system directed, the system may take no further action regarding the data related to the input and may allow it to be deleted. In certain configurations, to maintain privacy, the operations to determine whether an input is system directed are performed by device 110 (or home server(s) 120) and only if the input is determined to be system directed is further data (such as audio data 611 or image data 811) sent to a remote system 120 that is outside a user's home or other direct control.

FIG. 9 is a conceptual diagram of text-to-speech (TTS) components 180 according to embodiments of the present disclosure. The TTS component 180 may receive text data 710 (e.g., output from the NMT component 170) and generate output audio data 990; for example, synthetized speech in the target language. In some implementations, the TTS component 180 may receive voice characteristics of the source speech (e.g., the voice characteristics 137 from the speaker selection component 135) and use the voice characteristics to generate synthesized speech similar to and/or indicative of the source speech. For example, if the audio includes two different speakers, one with a higher pitched voice and one with a lower pitched voice, the TTS component 180 may generate respective streams of synthesized speech with similar distinguishing characteristics. In some implementations, the TTS component 180 may receive sentiment data (e.g., the sentiment data 1555 and/or 1575) and generate synthesized speech using voice characteristic data that can reproduce, imitate, or otherwise represent the emotional quality of the source speech; for example, angry, amused, sarcastic, etc. The TTS component 180 may receive voice characteristic data for use in synthesizing speech from the TTS unit storage 972 and/or the TTS parametric storage 980.

Components of a system that may be used to perform unit selection, parametric TTS processing, and/or model-based audio synthesis are shown in FIG. 9. The TTS component 180 may include a TTS front end 916, a speech synthesis engine 918, TTS unit storage 972, TTS parametric storage 980, and a TTS back end 934. The TTS unit storage 972 may include, among other things, voice inventories 978a-978n that may include pre-recorded audio segments (called units) to be used by the unit selection engine 930 when performing unit selection synthesis as described below. The TTS parametric storage 980 may include, among other things, parametric settings 968a-968n that may be used by the parametric synthesis engine 932 when performing parametric synthesis as described below. A particular set of parametric settings 968 may correspond to a particular voice profile (e.g., whispered speech, excited speech, etc.).

In various embodiments of the present disclosure, model-based synthesis of audio data may be performed using by a speech model 922 and a TTS front end 916. The TTS front end 916 may be the same as front ends used in traditional unit selection or parametric systems. In other embodiments, some or all of the components of the TTS front end 916 are based on other trained models. The present disclosure is not, however, limited to any particular type of TTS front end 916. The speech model 922 may be used to synthesize speech without requiring the TTS unit storage 972 or the TTS parametric storage 980, as described in greater detail below.

TTS component receives text data 710. Although the text data 710 in FIG. 9 is input into the TTS component 180, it may be output by other component(s) (such as a skill component, NLU component 160, or other component) and may be intended for output by the system. Thus in certain instances text data 710 may be referred to as “output text data.” Further, the data 710 may not necessarily be text, but may include other data (such as symbols, code, other data, etc.) that may reference text (such as an indicator of a word) that is to be synthesized. Thus data 710 may come in a variety of forms. The TTS front end 916 transforms the data 710 (from, for example, an application, user, device, or other data source) into a symbolic linguistic representation, which may include linguistic context features such as phoneme data, punctuation data, syllable-level features, word-level features, and/or emotion, speaker, accent, or other features for processing by the speech synthesis engine 918. The syllable-level features may include syllable emphasis, syllable speech rate, syllable inflection, or other such syllable-level features; the word-level features may include word emphasis, word speech rate, word inflection, or other such word-level features. The emotion features may include data corresponding to an emotion associated with the text data 710, such as surprise, anger, or fear. The speaker features may include data corresponding to a type of speaker, such as sex, age, or profession. The accent features may include data corresponding to an accent associated with the speaker, such as Southern, Boston, English, French, or other such accent.

The TTS front end 916 may also process other input data 915, such as text tags or text metadata, that may indicate, for example, how specific words should be pronounced, for example by indicating the desired output speech quality in tags formatted according to the speech synthesis markup language (SSML) or in some other form (e.g., and as based on sentiment data 1555/1575). For example, a first text tag may be included with text marking the beginning of when text should be whispered (e.g., <begin whisper>) and a second tag may be included with text marking the end of when text should be whispered (e.g., <end whisper>). The tags may be included in the text data 710 and/or the text for a TTS request may be accompanied by separate metadata indicating what text should be whispered (or have some other indicated audio characteristic). The speech synthesis engine 918 may compare the annotated phonetic units models and information stored in the TTS unit storage 972 and/or TTS parametric storage 980 for converting the input text into speech. The TTS front end 916 and speech synthesis engine 918 may include their own controller(s)/processor(s) and memory or they may use the controller/processor and memory of the server 120, device 110, or other device, for example. Similarly, the instructions for operating the TTS front end 916 and speech synthesis engine 918 may be located within the TTS component 180, within the memory and/or storage of the server 120, device 110, or within an external device.

Text data 710 input into the TTS component 180 may be sent to the TTS front end 916 for processing. The front end 916 may include components for performing text normalization, linguistic analysis, linguistic prosody generation, or other such components. During text normalization, the TTS front end 916 may first process the text input and generate standard text, converting such things as numbers, abbreviations (such as Apt., St., etc.), symbols ($, %, etc.) into the equivalent of written out words.

During linguistic analysis, the TTS front end 916 may analyze the language in the normalized text to generate a sequence of phonetic units corresponding to the input text. This process may be referred to as grapheme-to-phoneme conversion. Phonetic units include symbolic representations of sound units to be eventually combined and output by the system as speech. Various sound units may be used for dividing text for purposes of speech synthesis. The TTS component 180 may process speech based on phonemes (individual sounds), half-phonemes, di-phones (the last half of one phoneme coupled with the first half of the adjacent phoneme), bi-phones (two consecutive phonemes), syllables, words, phrases, sentences, or other units. Each word may be mapped to one or more phonetic units. Such mapping may be performed using a language dictionary stored by the system, for example in the TTS unit storage 972. The linguistic analysis performed by the TTS front end 916 may also identify different grammatical components such as prefixes, suffixes, phrases, punctuation, syntactic boundaries, or the like. Such grammatical components may be used by the TTS component 180 to craft a natural-sounding audio waveform output. The language dictionary may also include letter-to-sound rules and other tools that may be used to pronounce previously unidentified words or letter combinations that may be encountered by the TTS component 180. Generally, the more information included in the language dictionary, the higher quality the speech output.

Based on the linguistic analysis the TTS front end 916 may then perform linguistic prosody generation where the phonetic units are annotated with desired prosodic characteristics, also called acoustic features, which indicate how the desired phonetic units are to be pronounced in the eventual output speech. During this stage the TTS front end 916 may consider and incorporate any prosodic annotations that accompanied the text input to the TTS component 180. Such acoustic features may include syllable-level features, word-level features, emotion, speaker, accent, language, pitch, energy, duration, and the like. Application of acoustic features may be based on prosodic models available to the TTS component 180. Such prosodic models indicate how specific phonetic units are to be pronounced in certain circumstances. A prosodic model may consider, for example, a phoneme's position in a syllable, a syllable's position in a word, a word's position in a sentence or phrase, neighboring phonetic units, etc. As with the language dictionary, a prosodic model with more information may result in higher quality speech output than prosodic models with less information. Further, a prosodic model and/or phonetic units may be used to indicate particular speech qualities of the speech to be synthesized, where those speech qualities may match the speech qualities of input speech (for example, the phonetic units may indicate prosodic characteristics to make the ultimately synthesized speech sound like a whisper based on the input speech being whispered).

The output of the TTS front end 916, which may be referred to as a symbolic linguistic representation, may include a sequence of phonetic units annotated with prosodic characteristics. This symbolic linguistic representation may be sent to the speech synthesis engine 918, which may also be known as a synthesizer, for conversion into an audio waveform of speech for output to an audio output device and eventually to a user. The speech synthesis engine 918 may be configured to convert the input text into high-quality natural-sounding speech in an efficient manner. Such high-quality speech may be configured to sound as much like a human speaker as possible, or may be configured to be understandable to a listener without attempts to mimic a precise human voice.

The speech synthesis engine 918 may perform speech synthesis using one or more different methods. In one method of synthesis called unit selection, described further below, a unit selection engine 930 matches the symbolic linguistic representation created by the TTS front end 916 against a database of recorded speech, such as a database (e.g., TTS unit storage 972) storing information regarding one or more voice corpuses (e.g., voice inventories 978a-n). Each voice inventory may correspond to various segments of audio that was recorded by a speaking human, such as a voice actor, where the segments are stored in an individual inventory 978 as acoustic units (e.g., phonemes, diphones, etc.). Each stored unit of audio may also be associated with an index listing various acoustic properties or other descriptive information about the unit. Each unit includes an audio waveform corresponding with a phonetic unit, such as a short .wav file of the specific sound, along with a description of various features associated with the audio waveform. For example, an index entry for a particular unit may include information such as a particular unit's pitch, energy, duration, harmonics, center frequency, where the phonetic unit appears in a word, sentence, or phrase, the neighboring phonetic units, or the like. The unit selection engine 930 may then use the information about each unit to select units to be joined together to form the speech output.

The unit selection engine 930 matches the symbolic linguistic representation against information about the spoken audio units in the database. The unit database may include multiple examples of phonetic units to provide the system with many different options for concatenating units into speech. Matching units which are determined to have the desired acoustic qualities to create the desired output audio are selected and concatenated together (for example by a synthesis component 920) to form output audio data 990 representing synthesized speech. Using all the information in the unit database, a unit selection engine 930 may match units to the input text to select units that can form a natural sounding waveform. One benefit of unit selection is that, depending on the size of the database, a natural sounding speech output may be generated. As described above, the larger the unit database of the voice corpus, the more likely the system will be able to construct natural sounding speech.

In another method of synthesis—called parametric synthesis—parameters such as frequency, volume, noise, are varied by a parametric synthesis engine 932, digital signal processor or other audio generation device to create an artificial speech waveform output. Parametric synthesis uses a computerized voice generator, sometimes called a vocoder. Parametric synthesis may use an acoustic model and various statistical techniques to match a symbolic linguistic representation with desired output speech parameters. Using parametric synthesis, a computing system (for example, a synthesis component 920) can generate audio waveforms having the desired acoustic properties. Parametric synthesis may include the ability to be accurate at high processing speeds, as well as the ability to process speech without large databases associated with unit selection, but also may produce an output speech quality that may not match that of unit selection. Unit selection and parametric techniques may be performed individually or combined together and/or combined with other synthesis techniques to produce speech audio output.

The TTS component 180 may be configured to perform TTS processing in multiple languages. For each language, the TTS component 180 may include specially configured data, instructions and/or components to synthesize speech in the desired language(s). To improve performance, the TTS component 180 may revise/update the contents of the TTS unit storage 972 based on feedback of the results of TTS processing, thus enabling the TTS component 180 to improve speech synthesis.

The TTS unit storage 972 may be customized for an individual user based on his/her individualized desired speech output. In particular, the speech unit stored in a unit database may be taken from input audio data of the user speaking. For example, to create the customized speech output of the system, the system may be configured with multiple voice inventories 978a-978n, where each unit database is configured with a different “voice” to match desired speech qualities. Such voice inventories may also be linked to user accounts. The voice selected by the TTS component 180 may be used to synthesize the speech. For example, one voice corpus may be stored to be used to synthesize whispered speech (or speech approximating whispered speech), another may be stored to be used to synthesize excited speech (or speech approximating excited speech), and so on. To create the different voice corpuses a multitude of TTS training utterances may be spoken by an individual (such as a voice actor) and recorded by the system. The audio associated with the TTS training utterances may then be split into small audio segments and stored as part of a voice corpus. The individual speaking the TTS training utterances may speak in different voice qualities to create the customized voice corpuses, for example the individual may whisper the training utterances, say them in an excited voice, and so on. Thus the audio of each customized voice corpus may match the respective desired speech quality. The customized voice inventory 978 may then be used during runtime to perform unit selection to synthesize speech having a speech quality corresponding to the input speech quality.

Additionally, parametric synthesis may be used to synthesize speech with the desired speech quality. For parametric synthesis, parametric features may be configured that match the desired speech quality. If simulated excited speech was desired, parametric features may indicate an increased speech rate and/or pitch for the resulting speech. Many other examples are possible. The desired parametric features for particular speech qualities may be stored in a “voice” profile (e.g., parametric settings 968) and used for speech synthesis when the specific speech quality is desired. Customized voices may be created based on multiple desired speech qualities combined (for either unit selection or parametric synthesis). For example, one voice may be “shouted” while another voice may be “shouted and emphasized.” Many such combinations are possible.

Unit selection speech synthesis may be performed as follows. Unit selection includes a two-step process. First a unit selection engine 930 determines what speech units to use and then it combines them so that the particular combined units match the desired phonemes and acoustic features and create the desired speech output. Units may be selected based on a cost function which represents how well particular units fit the speech segments to be synthesized. The cost function may represent a combination of different costs representing different aspects of how well a particular speech unit may work for a particular speech segment. For example, a target cost indicates how well an individual given speech unit matches the features of a desired speech output (e.g., pitch, prosody, etc.). A join cost represents how well a particular speech unit matches an adjacent speech unit (e.g., a speech unit appearing directly before or directly after the particular speech unit) for purposes of concatenating the speech units together in the eventual synthesized speech. The overall cost function is a combination of target cost, join cost, and other costs that may be determined by the unit selection engine 930. As part of unit selection, the unit selection engine 930 chooses the speech unit with the lowest overall combined cost. For example, a speech unit with a very low target cost may not necessarily be selected if its join cost is high.

The system may be configured with one or more voice corpuses for unit selection. Each voice corpus may include a speech unit database. The speech unit database may be stored in TTS unit storage 972 or in another storage component. For example, different unit selection databases may be stored in TTS unit storage 972. Each speech unit database (e.g., voice inventory) includes recorded speech utterances with the utterances' corresponding text aligned to the utterances. A speech unit database may include many hours of recorded speech (in the form of audio waveforms, feature vectors, or other formats), which may occupy a significant amount of storage. The unit samples in the speech unit database may be classified in a variety of ways including by phonetic unit (phoneme, diphone, word, etc.), linguistic prosodic label, acoustic feature sequence, speaker identity, etc. The sample utterances may be used to create mathematical models corresponding to desired audio output for particular speech units. When matching a symbolic linguistic representation the speech synthesis engine 918 may attempt to select a unit in the speech unit database that most closely matches the input text (including both phonetic units and prosodic annotations). Generally the larger the voice corpus/speech unit database the better the speech synthesis may be achieved by virtue of the greater number of unit samples that may be selected to form the precise desired speech output.

Vocoder-based parametric speech synthesis may be performed as follows. A TTS component 180 may include an acoustic model, or other models, which may convert a symbolic linguistic representation into a synthetic acoustic waveform of the text input based on audio signal manipulation. The acoustic model includes rules which may be used by the parametric synthesis engine 932 to assign specific audio waveform parameters to input phonetic units and/or prosodic annotations. The rules may be used to calculate a score representing a likelihood that a particular audio output parameter(s) (such as frequency, volume, etc.) corresponds to the portion of the input symbolic linguistic representation from the TTS front end 916.

The parametric synthesis engine 932 may use a number of techniques to match speech to be synthesized with input phonetic units and/or prosodic annotations. One common technique is using Hidden Markov Models (HMMs). HMMs may be used to determine probabilities that audio output should match textual input. HMMs may be used to translate from parameters from the linguistic and acoustic space to the parameters to be used by a vocoder (the digital voice encoder) to artificially synthesize the desired speech. Using HMMs, a number of states are presented, in which the states together represent one or more potential acoustic parameters to be output to the vocoder and each state is associated with a model, such as a Gaussian mixture model. Transitions between states may also have an associated probability, representing a likelihood that a current state may be reached from a previous state. Sounds to be output may be represented as paths between states of the HMM and multiple paths may represent multiple possible audio matches for the same input text. Each portion of text may be represented by multiple potential states corresponding to different known pronunciations of phonemes and their parts (such as the phoneme identity, stress, accent, position, etc.). An initial determination of a probability of a potential phoneme may be associated with one state. As new text is processed by the speech synthesis engine 918, the state may change or stay the same, based on the processing of the new text. For example, the pronunciation of a previously processed word might change based on later processed words. A Viterbi algorithm may be used to find the most likely sequence of states based on the processed text. The HMMs may generate speech in parameterized form including parameters such as fundamental frequency (f0), noise envelope, spectral envelope, etc. that are translated by a vocoder into audio segments. The output parameters may be configured for particular vocoders such as a STRAIGHT vocoder, TANDEM-STRAIGHT vocoder, WORLD vocoder, HNM (harmonic plus noise) based vocoders, CELP (code-excited linear prediction) vocoders, GlottHPMM vocoders, HSM (harmonic/stochastic model) vocoders, or others.

In addition to calculating potential states for one audio waveform as a potential match to a phonetic unit, the parametric synthesis engine 932 may also calculate potential states for other potential audio outputs (such as various ways of pronouncing a particular phoneme or diphone) as potential acoustic matches for the acoustic unit. In this manner multiple states and state transition probabilities may be calculated.

The probable states and probable state transitions calculated by the parametric synthesis engine 932 may lead to a number of potential audio output sequences. Based on the acoustic model and other potential models, the potential audio output sequences may be scored according to a confidence level of the parametric synthesis engine 932. The highest scoring audio output sequence, including a stream of parameters to be synthesized, may be chosen and digital signal processing may be performed by a vocoder or similar component to create an audio output including synthesized speech waveforms corresponding to the parameters of the highest scoring audio output sequence and, if the proper sequence was selected, also corresponding to the input text. The different parametric settings 968, which may represent acoustic settings matching a particular parametric “voice”, may be used by the synthesis component 920 to ultimately create the output audio data 990.

When performing unit selection, after a unit is selected by the unit selection engine 930, the audio data corresponding to the unit may be passed to the synthesis component 920. The synthesis component 920 may then process the audio data of the unit to create modified audio data where the modified audio data reflects a desired audio quality. The synthesis component 920 may store a variety of operations that can convert unit audio data into modified audio data where different operations may be performed based on the desired audio effect (e.g., whispering, shouting, etc.).

As an example, input text may be received along with metadata, such as SSML tags, indicating that a selected portion of the input text should be whispered when output by the TTS module 180. For each unit that corresponds to the selected portion, the synthesis component 920 may process the audio data for that unit to create a modified unit audio data. The modified unit audio data may then be concatenated to form the output audio data 990. The modified unit audio data may also be concatenated with non-modified audio data depending on when the desired whispered speech starts and/or ends. While the modified audio data may be sufficient to imbue the output audio data with the desired audio qualities, other factors may also impact the ultimate output of audio such as playback speed, background effects, or the like, that may be outside the control of the TTS module 180. In that case, other output data 985 may be output along with the output audio data 990 so that an ultimate playback device (e.g., device 110) receives instructions for playback that can assist in creating the desired output audio. Thus, the other output data 985 may include instructions or other data indicating playback device settings (such as volume, playback rate, etc.) or other data indicating how output audio data including synthesized speech should be output. For example, for whispered speech, the output audio data 990 may include other output data 985 that may include a prosody tag or other indicator that instructs the device 110 to slow down the playback of the output audio data 990, thus making the ultimate audio sound more like whispered speech, which is typically slower than normal speech. In another example, the other output data 985 may include a volume tag that instructs the device 110 to output the speech at a volume level less than a current volume setting of the device 110, thus improving the quiet whisper effect.

FIGS. 10 and 11 illustrates how the NLU component 160 may perform NLU processing, according to embodiments of the present disclosure. The NLU component 160 may process ASR results data 610 and/or other data to interpret a semantic meaning of the recognized speech. In some implementations, the NLU component 160 may facilitate semantic portioning of the ASR data to determine semantically cohesive speech portions. The NLU component 160 may send the semantic representation of the speech to the natural language condenser component 155 and/or the NMT component 170 in the form of, for example, NLU output data (e.g., NLU output data 1185 and/or ranked output data 1125). In speech processing, (e.g., when semantically interpreting a command to a natural language command processing system as described below) a semantically cohesive speech portion may be in an <intent> <slot> format. For translation purposes, a semantically cohesive speech portion may be in a different form; for example, <noun> <verb> <subject> etc. Based on the semantic portioning provided by the NLU processing, the natural language condenser component 155 and/or the NMT component 170 may determine, for example, that a portion of the ASR results data 610 represents a semantically cohesive segment of speech, and/or that a later semantic portion repeats or corrects an earlier semantic portion, and thus may be dropped from the translation. The NLU processing may further include intent classification and/or entity resolution, which may yield information that the natural language condenser component 155 and/or the NMT component 170 may use to interpret/translate a particular word or phrase based on its semantic meaning in the context of the recognized speech. For example, the NMT component 170 may thus use the NLU output data to, for example, select an appropriate hidden representation of a source text word or phrase from among multiple possibilities.

FIG. 10 is a conceptual diagram of how natural language processing is performed, according to embodiments of the present disclosure. And FIG. 11 is a conceptual diagram of how natural language processing is performed, according to embodiments of the present disclosure.

FIG. 10 illustrates how NLU processing is performed on text data. The NLU component 160 may process text data including several ASR hypotheses of a single user input. For example, if the ASR component 150 outputs text data including an n-best list of ASR hypotheses, the NLU component 160 may process the text data with respect to all (or a portion of) the ASR hypotheses represented therein.

The NLU component 160 may annotate text data by parsing and/or tagging the text data. For example, for the text data “tell me the weather for Seattle,” the NLU component 160 may tag “tell me the weather for Seattle” as an <OutputWeather> intent as well as separately tag “Seattle” as a location for the weather information.

The NLU component 160 may include a shortlister component 1050. The shortlister component 1050 selects skills that may execute with respect to ASR data 610 (and/or condensed ASR data 510) input to the NLU component 160. A skill may refer to an application that may execute with respect to the user input. A skill may be embodied in one or more skill components 1195a, 1195b, 1195c, etc. (collectively, “skill components 1195”). A skill component may be software running on the system(s) 120 that is akin to a software application. That is, a skill component 1195 may enable the system(s) 120 to execute specific functionality in order to provide data or produce some other requested output. As used herein, a “skill component” may refer to software that may be placed on a machine or a virtual machine (e.g., software that may be launched in a virtual instance when called). A skill component may be software customized to perform one or more actions as indicated by a business entity, device manufacturer, user, etc. What is described herein as a skill component may be referred to using many different terms, such as an action, bot, app, or the like. The system(s) 120 may be configured with more than one skill component 1195. For example, a weather service skill component may enable the system(s) 120 to provide weather information, a car service skill component may enable the system(s) 120 to book a trip with respect to a taxi or ride sharing service, a restaurant skill component may enable the system(s) 120 to order a pizza with respect to the restaurant's online ordering system, etc. A skill component 1195 may operate in conjunction between the system(s) 120 and other devices, such as the device 110, in order to complete certain functions. Inputs to a skill component 1195 may come from speech processing interactions or through other interactions or input sources. A skill component 1195 may include hardware, software, firmware, or the like that may be dedicated to a particular skill component 1195 or shared among different skill components 1195.

The ASR data 610 (and/or condensed ASR data 510) may include representations of text of an utterance, such as words, subword units, or the like. The shortlister component 1050 thus limits downstream, more resource intensive NLU processes to being performed with respect to skills that may execute with respect to the user input.

Without a shortlister component 1050, the NLU component 160 may process ASR data 610 input thereto with respect to every skill of the system, either in parallel, in series, or using some combination thereof. By implementing a shortlister component 1050, the NLU component 160 may process ASR data 610 with respect to only the skills that may execute with respect to the user input. This reduces total compute power and latency attributed to NLU processing.

The shortlister component 1050 may include one or more trained models. The model(s) may be trained to recognize various forms of user inputs that may be received by the system(s) 120. For example, during a training period skill system(s) 125 associated with a skill may provide the system(s) 120 with training text data representing sample user inputs that may be provided by a user to invoke the skill. For example, for a ride sharing skill, a skill system(s) 125 associated with the ride sharing skill may provide the system(s) 120 with training text data including text corresponding to “get me a cab to [location],” “get me a ride to [location],” “book me a cab to [location],” “book me a ride to [location],” etc. The one or more trained models that will be used by the shortlister component 1050 may be trained, using the training text data representing sample user inputs, to determine other potentially related user input structures that users may try to use to invoke the particular skill. During training, the system(s) 120 may solicit the skill system(s) 125 associated with the skill regarding whether the determined other user input structures are permissible, from the perspective of the skill system(s) 125, to be used to invoke the skill. The alternate user input structures may be derived by one or more trained models during model training and/or may be based on user input structures provided by different skills. The skill system(s) 125 associated with a particular skill may also provide the system(s) 120 with training text data indicating grammar and annotations. The system(s) 120 may use the training text data representing the sample user inputs, the determined related user input(s), the grammar, and the annotations to train a model(s) that indicates when a user input is likely to be directed to/handled by a skill, based at least in part on the structure of the user input. Each trained model of the shortlister component 1050 may be trained with respect to a different skill. Alternatively, the shortlister component 1050 may use one trained model per domain, such as one trained model for skills associated with a weather domain, one trained model for skills associated with a ride sharing domain, etc.

The system(s) 120 may use the sample user inputs provided by a skill system(s) 125, and related sample user inputs potentially determined during training, as binary examples to train a model associated with a skill associated with the skill system(s) 125. The model associated with the particular skill may then be operated at runtime by the shortlister component 1050. For example, some sample user inputs may be positive examples (e.g., user inputs that may be used to invoke the skill). Other sample user inputs may be negative examples (e.g., user inputs that may not be used to invoke the skill).

As described above, the shortlister component 1050 may include a different trained model for each skill of the system, a different trained model for each domain, or some other combination of trained model(s). For example, the shortlister component 1050 may alternatively include a single model. The single model may include a portion trained with respect to characteristics (e.g., semantic characteristics) shared by all skills of the system. The single model may also include skill-specific portions, with each skill-specific portion being trained with respect to a specific skill of the system. Implementing a single model with skill-specific portions may result in less latency than implementing a different trained model for each skill because the single model with skill-specific portions limits the number of characteristics processed on a per skill level.

The portion trained with respect to characteristics shared by more than one skill may be clustered based on domain. For example, a first portion of the portion trained with respect to multiple skills may be trained with respect to weather domain skills, a second portion of the portion trained with respect to multiple skills may be trained with respect to music domain skills, a third portion of the portion trained with respect to multiple skills may be trained with respect to travel domain skills, etc.

Clustering may not be beneficial in every instance because it may cause the shortlister component 1050 to output indications of only a portion of the skills that the ASR data 610 may relate to. For example, a user input may correspond to “tell me about Tom Collins.” If the model is clustered based on domain, the shortlister component 1050 may determine the user input corresponds to a recipe skill (e.g., a drink recipe) even though the user input may also correspond to an information skill (e.g., including information about a person named Tom Collins).

The NLU component 160 may include one or more recognizers 1063. In at least some embodiments, a recognizer 1063 may be associated with a skill system 125 (e.g., the recognizer may be configured to interpret text data to correspond to the skill system 125). In at least some other examples, a recognizer 1063 may be associated with a domain such as smart home, video, music, weather, custom, etc. (e.g., the recognizer may be configured to interpret text data to correspond to the domain).

If the shortlister component 1050 determines ASR data 610 is potentially associated with multiple domains, the recognizers 1063 associated with the domains may process the ASR data 610, while recognizers 1063 not indicated in the shortlister component 1050's output may not process the ASR data 610. The “shortlisted” recognizers 1063 may process the ASR data 610 in parallel, in series, partially in parallel, etc. For example, if ASR data 610 potentially relates to both a communications domain and a music domain, a recognizer associated with the communications domain may process the ASR data 610 in parallel, or partially in parallel, with a recognizer associated with the music domain processing the ASR data 610.

Each recognizer 1063 may include a named entity recognition (NER) component 1062. The NER component 1062 attempts to identify grammars and lexical information that may be used to construe meaning with respect to text data input therein. The NER component 1062 identifies portions of text data that correspond to a named entity associated with a domain, associated with the recognizer 1063 implementing the NER component 1062. The NER component 1062 (or other component of the NLU component 160) may also determine whether a word refers to an entity whose identity is not explicitly mentioned in the text data, for example “him,” “her,” “it” or other anaphora, exophora, or the like.

Each recognizer 1063, and more specifically each NER component 1062, may be associated with a particular grammar database 1076, a particular set of intents/actions 1074, and a particular personalized lexicon 1086. The grammar databases 1076, and intents/actions 1074 may be stored in an NLU storage 1073. Each gazetteer 1084 may include domain/skill-indexed lexical information associated with a particular user and/or device 110. For example, a Gazetteer A (1084a) includes skill-indexed lexical information 1086aa to 1086an. A user's music domain lexical information might include album titles, artist names, and song names, for example, whereas a user's communications domain lexical information might include the names of contacts. Since every user's music collection and contact list is presumably different. This personalized information improves later performed entity resolution.

An NER component 1062 applies grammar information 1076 and lexical information 1086 associated with a domain (associated with the recognizer 1063 implementing the NER component 1062) to determine a mention of one or more entities in text data. In this manner, the NER component 1062 identifies “slots” (each corresponding to one or more particular words in text data) that may be useful for later processing. The NER component 1062 may also label each slot with a type (e.g., noun, place, city, artist name, song name, etc.).

Each grammar database 1076 includes the names of entities (i.e., nouns) commonly found in speech about the particular domain to which the grammar database 1076 relates, whereas the lexical information 1086 is personalized to the user and/or the device 110 from which the user input originated. For example, a grammar database 1076 associated with a shopping domain may include a database of words commonly used when people discuss shopping.

A downstream process called entity resolution (discussed in detail elsewhere herein) links a slot of text data to a specific entity known to the system. To perform entity resolution, the NLU component 160 may utilize gazetteer information (1084a-1084n) stored in an entity library storage 1082. The gazetteer information 1084 may be used to match text data (representing a portion of the user input) with text data representing known entities, such as song titles, contact names, etc. Gazetteers 1084 may be linked to users (e.g., a particular gazetteer may be associated with a specific user's music collection), may be linked to certain domains (e.g., a shopping domain, a music domain, a video domain, etc.), or may be organized in a variety of other ways.

Each recognizer 1063 may also include an intent classification (IC) component 1064. An IC component 1064 parses text data to determine an intent(s) (associated with the domain associated with the recognizer 1063 implementing the IC component 1064) that potentially represents the user input. An intent represents to an action a user desires be performed. An IC component 1064 may communicate with a database 1074 of words linked to intents. For example, a music intent database may link words and phrases such as “quiet,” “volume off,” and “mute” to a <Mute> intent. An IC component 1064 identifies potential intents by comparing words and phrases in text data (representing at least a portion of the user input) to the words and phrases in an intents database 1074 (associated with the domain that is associated with the recognizer 1063 implementing the IC component 1064).

The intents identifiable by a specific IC component 1064 are linked to domain-specific (i.e., the domain associated with the recognizer 1063 implementing the IC component 1064) grammar frameworks 1076 with “slots” to be filled. Each slot of a grammar framework 1076 corresponds to a portion of text data that the system believes corresponds to an entity. For example, a grammar framework 1076 corresponding to a <PlayMusic> intent may correspond to text data sentence structures such as “Play {Artist Name},” “Play {Album Name},” “Play {Song name},” “Play {Song name} by {Artist Name},” etc. However, to make entity resolution more flexible, grammar frameworks 1076 may not be structured as sentences, but rather based on associating slots with grammatical tags.

For example, an NER component 1062 may parse text data to identify words as subject, object, verb, preposition, etc. based on grammar rules and/or models prior to recognizing named entities in the text data. An IC component 1064 (implemented by the same recognizer 1063 as the NER component 1062) may use the identified verb to identify an intent. The NER component 1062 may then determine a grammar model 1076 associated with the identified intent. For example, a grammar model 1076 for an intent corresponding to <PlayMusic> may specify a list of slots applicable to play the identified “object” and any object modifier (e.g., a prepositional phrase), such as {Artist Name}, {Album Name}, {Song name}, etc. The NER component 1062 may then search corresponding fields in a lexicon 1086 (associated with the domain associated with the recognizer 1063 implementing the NER component 1062), attempting to match words and phrases in text data the NER component 1062 previously tagged as a grammatical object or object modifier with those identified in the lexicon 1086.

An NER component 1062 may perform semantic tagging, which is the labeling of a word or combination of words according to their type/semantic meaning. An NER component 1062 may parse text data using heuristic grammar rules, or a model may be constructed using techniques such as Hidden Markov Models, maximum entropy models, log linear models, conditional random fields (CRF), and the like. For example, an NER component 1062 implemented by a music domain recognizer may parse and tag text data corresponding to “play mother's little helper by the rolling stones” as {Verb}: “Play,” {Object}: “mother's little helper,” {Object Preposition}: “by,” and {Object Modifier}: “the rolling stones.” The NER component 1062 identifies “Play” as a verb based on a word database associated with the music domain, which an IC component 1064 (also implemented by the music domain recognizer) may determine corresponds to a <PlayMusic> intent. At this stage, no determination has been made as to the meaning of “mother's little helper” or “the rolling stones,” but based on grammar rules and models, the NER component 1062 has determined the text of these phrases relates to the grammatical object (i.e., entity) of the user input represented in the text data.

An NER component 1062 may tag text data to attribute meaning thereto. For example, an NER component 1062 may tag “play mother's little helper by the rolling stones” as: {domain} Music, {intent}<PlayMusic>, {artist name}rolling stones, {media type} SONG, and {song title} mother's little helper. For further example, the NER component 1062 may tag “play songs by the rolling stones” as: {domain} Music, {intent}<PlayMusic>, {artist name} rolling stones, and {media type} SONG.

The shortlister component 1050 may receive ASR data 610 output from the ASR component 150 or output from the device 110b (as illustrated in FIG. 11). The ASR component 150 may embed the ASR data 610 into a form processable by a trained model(s) using sentence embedding techniques as known in the art. Sentence embedding results in the ASR data 610 including text in a structure that enables the trained models of the shortlister component 1050 to operate on the ASR data 610. For example, an embedding of the ASR data 610 may be a vector representation of the ASR data 610.

The shortlister component 1050 may make binary determinations (e.g., yes or no) regarding which domains relate to the ASR data 610. The shortlister component 1050 may make such determinations using the one or more trained models described herein above. If the shortlister component 1050 implements a single trained model for each domain, the shortlister component 1050 may simply run the models that are associated with enabled domains as indicated in a user profile associated with the device 110 and/or user that originated the user input.

The shortlister component 1050 may generate n-best list data 1115 representing domains that may execute with respect to the user input represented in the ASR data 610. The size of the n-best list represented in the n-best list data 1115 is configurable. In an example, the n-best list data 1115 may indicate every domain of the system as well as contain an indication, for each domain, regarding whether the domain is likely capable to execute the user input represented in the ASR data 610. In another example, instead of indicating every domain of the system, the n-best list data 1115 may only indicate the domains that are likely to be able to execute the user input represented in the ASR data 610. In yet another example, the shortlister component 1050 may implement thresholding such that the n-best list data 1115 may indicate no more than a maximum number of domains that may execute the user input represented in the ASR data 610. In an example, the threshold number of domains that may be represented in the n-best list data 1115 is ten. In another example, the domains included in the n-best list data 1115 may be limited by a threshold a score, where only domains indicating a likelihood to handle the user input is above a certain score (as determined by processing the ASR data 610 by the shortlister component 1050 relative to such domains) are included in the n-best list data 1115.

The ASR data 610 may correspond to more than one ASR hypothesis. When this occurs, the shortlister component 1050 may output a different n-best list (represented in the n-best list data 1115) for each ASR hypothesis. Alternatively, the shortlister component 1050 may output a single n-best list representing the domains that are related to the multiple ASR hypotheses represented in the ASR data 610.

As indicated above, the shortlister component 1050 may implement thresholding such that an n-best list output therefrom may include no more than a threshold number of entries. If the ASR data 610 includes more than one ASR hypothesis, the n-best list output by the shortlister component 1050 may include no more than a threshold number of entries irrespective of the number of ASR hypotheses output by the ASR component 150. Alternatively or in addition, the n-best list output by the shortlister component 1050 may include no more than a threshold number of entries for each ASR hypothesis (e.g., no more than five entries for a first ASR hypothesis, no more than five entries for a second ASR hypothesis, etc.).

In addition to making a binary determination regarding whether a domain potentially relates to the ASR data 610, the shortlister component 1050 may generate confidence scores representing likelihoods that domains relate to the ASR data 610. If the shortlister component 1050 implements a different trained model for each domain, the shortlister component 1050 may generate a different confidence score for each individual domain trained model that is run. If the shortlister component 1050 runs the models of every domain when ASR data 610 is received, the shortlister component 1050 may generate a different confidence score for each domain of the system. If the shortlister component 1050 runs the models of only the domains that are associated with skills indicated as enabled in a user profile associated with the device 110 and/or user that originated the user input, the shortlister component 1050 may only generate a different confidence score for each domain associated with at least one enabled skill. If the shortlister component 1050 implements a single trained model with domain specifically trained portions, the shortlister component 1050 may generate a different confidence score for each domain who's specifically trained portion is run. The shortlister component 1050 may perform matrix vector modification to obtain confidence scores for all domains of the system in a single instance of processing of the ASR data 610.

N-best list data 1115 including confidence scores that may be output by the shortlister component 1050 may be represented as, for example:
Search domain, 0.67
Recipe domain, 0.62
Information domain, 0.57
Shopping domain, 0.42
   As indicated, the confidence scores output by the shortlister component 1050 may be numeric values. The confidence scores output by the shortlister component 1050 may alternatively be binned values (e.g., high, medium, low).

The n-best list may only include entries for domains having a confidence score satisfying (e.g., equaling or exceeding) a minimum threshold confidence score. Alternatively, the shortlister component 1050 may include entries for all domains associated with user enabled skills, even if one or more of the domains are associated with confidence scores that do not satisfy the minimum threshold confidence score.

The shortlister component 1050 may consider other data 1120 when determining which domains may relate to the user input represented in the ASR data 610 as well as respective confidence scores. The other data 1120 may include usage history data associated with the device 110 and/or user that originated the user input. For example, a confidence score of a domain may be increased if user inputs originated by the device 110 and/or user routinely invoke the domain. Conversely, a confidence score of a domain may be decreased if user inputs originated by the device 110 and/or user rarely invoke the domain. Thus, the other data 1120 may include an indicator of the user associated with the ASR data 610, for example as determined by the user recognition component 195.

The other data 1120 may be character embedded prior to being input to the shortlister component 1050. The other data 1120 may alternatively be embedded using other techniques known in the art prior to being input to the shortlister component 1050.

The other data 1120 may also include data indicating the domains associated with skills that are enabled with respect to the device 110 and/or user that originated the user input. The shortlister component 1050 may use such data to determine which domain-specific trained models to run. That is, the shortlister component 1050 may determine to only run the trained models associated with domains that are associated with user-enabled skills. The shortlister component 1050 may alternatively use such data to alter confidence scores of domains.

As an example, considering two domains, a first domain associated with at least one enabled skill and a second domain not associated with any user-enabled skills of the user that originated the user input, the shortlister component 1050 may run a first model specific to the first domain as well as a second model specific to the second domain. Alternatively, the shortlister component 1050 may run a model configured to determine a score for each of the first and second domains. The shortlister component 1050 may determine a same confidence score for each of the first and second domains in the first instance. The shortlister component 1050 may then alter those confidence scores based on which domains is associated with at least one skill enabled by the present user. For example, the shortlister component 1050 may increase the confidence score associated with the domain associated with at least one enabled skill while leaving the confidence score associated with the other domain the same. Alternatively, the shortlister component 1050 may leave the confidence score associated with the domain associated with at least one enabled skill the same while decreasing the confidence score associated with the other domain. Moreover, the shortlister component 1050 may increase the confidence score associated with the domain associated with at least one enabled skill as well as decrease the confidence score associated with the other domain.

As indicated, a user profile may indicate which skills a corresponding user has enabled (e.g., authorized to execute using data associated with the user). Such indications may be stored in a profile storage. When the shortlister component 1050 receives the ASR data 610, the shortlister component 1050 may determine whether profile data associated with the user and/or device 110 that originated the command includes an indication of enabled skills.

The other data 1120 may also include data indicating the type of the device 110. The type of a device may indicate the output capabilities of the device. For example, a type of device may correspond to a device with a visual display, a headless (e.g., displayless) device, whether a device is mobile or stationary, whether a device includes audio playback capabilities, whether a device includes a camera, other device hardware configurations, etc. The shortlister component 1050 may use such data to determine which domain-specific trained models to run. For example, if the device 110 corresponds to a displayless type device, the shortlister component 1050 may determine not to run trained models specific to domains that output video data. The shortlister component 1050 may alternatively use such data to alter confidence scores of domains.

As an example, considering two domains, one that outputs audio data and another that outputs video data, the shortlister component 1050 may run a first model specific to the domain that generates audio data as well as a second model specific to the domain that generates video data. Alternatively the shortlister component 1050 may run a model configured to determine a score for each domain. The shortlister component 1050 may determine a same confidence score for each of the domains in the first instance. The shortlister component 1050 may then alter the original confidence scores based on the type of the device 110 that originated the user input corresponding to the ASR data 610. For example, if the device 110 is a displayless device, the shortlister component 1050 may increase the confidence score associated with the domain that generates audio data while leaving the confidence score associated with the domain that generates video data the same. Alternatively, if the device 110 is a displayless device, the shortlister component 1050 may leave the confidence score associated with the domain that generates audio data the same while decreasing the confidence score associated with the domain that generates video data. Moreover, if the device 110 is a displayless device, the shortlister component 1050 may increase the confidence score associated with the domain that generates audio data as well as decrease the confidence score associated with the domain that generates video data.

The type of device information represented in the other data 1120 may represent output capabilities of the device to be used to output content to the user, which may not necessarily be the user input originating device. For example, a user may input a spoken user input corresponding to “play Game of Thrones” to a device not including a display. The system may determine a smart TV or other display device (associated with the same user profile) for outputting Game of Thrones. Thus, the other data 1120 may represent the smart TV of other display device, and not the displayless device that captured the spoken user input.

The other data 1120 may also include data indicating the user input originating device's speed, location, or other mobility information. For example, the device may correspond to a vehicle including a display. If the vehicle is moving, the shortlister component 1050 may decrease the confidence score associated with a domain that generates video data as it may be undesirable to output video content to a user while the user is driving. The device may output data to the system(s) 120 indicating when the device is moving.

The other data 1120 may also include data indicating a currently invoked domain. For example, a user may speak a first (e.g., a previous) user input causing the system to invoke a music domain skill to output music to the user. As the system is outputting music to the user, the system may receive a second (e.g., the current) user input. The shortlister component 1050 may use such data to alter confidence scores of domains. For example, the shortlister component 1050 may run a first model specific to a first domain as well as a second model specific to a second domain. Alternatively, the shortlister component 1050 may run a model configured to determine a score for each domain. The shortlister component 1050 may also determine a same confidence score for each of the domains in the first instance. The shortlister component 1050 may then alter the original confidence scores based on the first domain being invoked to cause the system to output content while the current user input was received. Based on the first domain being invoked, the shortlister component 1050 may (i) increase the confidence score associated with the first domain while leaving the confidence score associated with the second domain the same, (ii) leave the confidence score associated with the first domain the same while decreasing the confidence score associated with the second domain, or (iii) increase the confidence score associated with the first domain as well as decrease the confidence score associated with the second domain.

The thresholding implemented with respect to the n-best list data 1115 generated by the shortlister component 1050 as well as the different types of other data 1120 considered by the shortlister component 1050 are configurable. For example, the shortlister component 1050 may update confidence scores as more other data 1120 is considered. For further example, the n-best list data 1115 may exclude relevant domains if thresholding is implemented. Thus, for example, the shortlister component 1050 may include an indication of a domain in the n-best list 1115 unless the shortlister component 1050 is one hundred percent confident that the domain may not execute the user input represented in the ASR data 610 (e.g., the shortlister component 1050 determines a confidence score of zero for the domain).

The shortlister component 1050 may send the ASR data 610 to recognizers 1063 associated with domains represented in the n-best list data 1115. Alternatively, the shortlister component 1050 may send the n-best list data 1115 or some other indicator of the selected subset of domains to another component (such as the orchestrator component) which may in turn send the ASR data 610 to the recognizers 1063 corresponding to the domains included in the n-best list data 1115 or otherwise indicated in the indicator. If the shortlister component 1050 generates an n-best list representing domains without any associated confidence scores, the shortlister component 1050/orchestrator component may send the ASR data 610 to recognizers 1063 associated with domains that the shortlister component 1050 determines may execute the user input. If the shortlister component 1050 generates an n-best list representing domains with associated confidence scores, the shortlister component 1050/orchestrator component may send the ASR data 610 to recognizers 1063 associated with domains associated with confidence scores satisfying (e.g., meeting or exceeding) a threshold minimum confidence score.

A recognizer 1063 may output tagged text data generated by an NER component 1062 and an IC component 1064, as described herein above. The NLU component 160 may compile the output tagged text data of the recognizers 1063 into a single cross-domain n-best list 1140 and may send the cross-domain n-best list 1140 to a pruning component 1150. Each entry of tagged text (e.g., each NLU hypothesis) represented in the cross-domain n-best list data 1140 may be associated with a respective score indicating a likelihood that the NLU hypothesis corresponds to the domain associated with the recognizer 1063 from which the NLU hypothesis was output. For example, the cross-domain n-best list data 1140 may be represented as (with each line corresponding to a different NLU hypothesis):
[0.95] Intent: <PlayMusic> ArtistName: Beethoven SongName: Waldstein Sonata
[0.70] Intent: <PlayVideo> ArtistName: Beethoven VideoName: Waldstein Sonata
[0.01] Intent: <PlayMusic> ArtistName: Beethoven AlbumName: Waldstein Sonata
[0.01] Intent: <PlayMusic> SongName: Waldstein Sonata

The pruning component 1150 may sort the NLU hypotheses represented in the cross-domain n-best list data 1140 according to their respective scores. The pruning component 1150 may perform score thresholding with respect to the cross-domain NLU hypotheses. For example, the pruning component 1150 may select NLU hypotheses associated with scores satisfying (e.g., meeting and/or exceeding) a threshold score. The pruning component 1150 may also or alternatively perform number of NLU hypothesis thresholding. For example, the pruning component 1150 may select the top scoring NLU hypothesis(es). The pruning component 1150 may output a portion of the NLU hypotheses input thereto. The purpose of the pruning component 1150 is to create a reduced list of NLU hypotheses so that downstream, more resource intensive, processes may only operate on the NLU hypotheses that most likely represent the user's intent.

The NLU component 160 may include a light slot filler component 1152. The light slot filler component 1152 can take text from slots represented in the NLU hypotheses output by the pruning component 1150 and alter them to make the text more easily processed by downstream components. The light slot filler component 1152 may perform low latency operations that do not involve heavy operations such as reference to a knowledge base (e.g., 1072. The purpose of the light slot filler component 1152 is to replace words with other words or values that may be more easily understood by downstream components. For example, if a NLU hypothesis includes the word “tomorrow,” the light slot filler component 1152 may replace the word “tomorrow” with an actual date for purposes of downstream processing. Similarly, the light slot filler component 1152 may replace the word “CD” with “album” or the words “compact disc.” The replaced words are then included in the cross-domain n-best list data 1160.

The cross-domain n-best list data 1160 may be input to an entity resolution component 1170. The entity resolution component 1170 can apply rules or other instructions to standardize labels or tokens from previous stages into an intent/slot representation. The precise transformation may depend on the domain. For example, for a travel domain, the entity resolution component 1170 may transform text corresponding to “Boston airport” to the standard BOS three-letter code referring to the airport. The entity resolution component 1170 can refer to a knowledge base (e.g., 1072) that is used to specifically identify the precise entity referred to in each slot of each NLU hypothesis represented in the cross-domain n-best list data 1160. Specific intent/slot combinations may also be tied to a particular source, which may then be used to resolve the text. In the example “play songs by the stones,” the entity resolution component 1170 may reference a personal music catalog, Amazon Music account, a user profile, or the like. The entity resolution component 1170 may output an altered n-best list that is based on the cross-domain n-best list 1160 but that includes more detailed information (e.g., entity IDs) about the specific entities mentioned in the slots and/or more detailed slot data that can eventually be used by a skill. The NLU component 160 may include multiple entity resolution components 1170 and each entity resolution component 1170 may be specific to one or more domains.

The NLU component 160 may include a reranker 1190. The reranker 1190 may assign a particular confidence score to each NLU hypothesis input therein. The confidence score of a particular NLU hypothesis may be affected by whether the NLU hypothesis has unfilled slots. For example, if a NLU hypothesis includes slots that are all filled/resolved, that NLU hypothesis may be assigned a higher confidence score than another NLU hypothesis including at least some slots that are unfilled/unresolved by the entity resolution component 1170.

The reranker 1190 may apply re-scoring, biasing, or other techniques. The reranker 1190 may consider not only the data output by the entity resolution component 1170, but may also consider other data 1191. The other data 1191 may include a variety of information. For example, the other data 1191 may include skill rating or popularity data. For example, if one skill has a high rating, the reranker 1190 may increase the score of a NLU hypothesis that may be processed by the skill. The other data 1191 may also include information about skills that have been enabled by the user that originated the user input. For example, the reranker 1190 may assign higher scores to NLU hypothesis that may be processed by enabled skills than NLU hypothesis that may be processed by non-enabled skills. The other data 1191 may also include data indicating user usage history, such as if the user that originated the user input regularly uses a particular skill or does so at particular times of day. The other data 1191 may additionally include data indicating date, time, location, weather, type of device 110, user identifier, context, as well as other information. For example, the reranker 1190 may consider when any particular skill is currently active (e.g., music being played, a game being played, etc.).

As illustrated and described, the entity resolution component 1170 is implemented prior to the reranker 1190. The entity resolution component 1170 may alternatively be implemented after the reranker 1190. Implementing the entity resolution component 1170 after the reranker 1190 limits the NLU hypotheses processed by the entity resolution component 1170 to only those hypotheses that successfully pass through the reranker 1190.

The reranker 1190 may be a global reranker (e.g., one that is not specific to any particular domain). Alternatively, the NLU component 160 may implement one or more domain-specific rerankers. Each domain-specific reranker may rerank NLU hypotheses associated with the domain. Each domain-specific reranker may output an n-best list of reranked hypotheses (e.g., 5-10 hypotheses).

The NLU component 160 may perform NLU processing described above with respect to domains associated with skills wholly implemented as part of the system(s) 120. The NLU component 160 may separately perform NLU processing described above with respect to domains associated with skills that are at least partially implemented as part of the skill system(s) 125. In an example, the shortlister component 1050 may only process with respect to these latter domains. Results of these two NLU processing paths may be merged into NLU output data 1185, which may be sent to a post-NLU ranker 1165, which may be implemented by the system(s) 120.

The post-NLU ranker 1165 may include a statistical component that produces a ranked list of intent/skill pairs with associated confidence scores. Each confidence score may indicate an adequacy of the skill's execution of the intent with respect to NLU results data associated with the skill. The post-NLU ranker 1165 may operate one or more trained models configured to process the NLU results data 1185, skill result data 1130, and the other data 1120 in order to output ranked output data 1125. The ranked output data 1125 may include an n-best list where the NLU hypotheses in the NLU results data 1185 are reordered such that the n-best list in the ranked output data 1125 represents a prioritized list of skills to respond to a user input as determined by the post-NLU ranker 1165. The ranked output data 1125 may also include (either as part of an n-best list or otherwise) individual respective scores corresponding to skills where each score indicates a probability that the skill (and/or its respective result data) corresponds to the user input.

The system may be configured with thousands, tens of thousands, etc. skills. The post-NLU ranker 1165 enables the system to better determine the best skill to execute the user input. For example, first and second NLU hypotheses in the NLU results data 1185 may substantially correspond to each other (e.g., their scores may be significantly similar), even though the first NLU hypothesis may be processed by a first skill and the second NLU hypothesis may be processed by a second skill. The first NLU hypothesis may be associated with a first confidence score indicating the system's confidence with respect to NLU processing performed to generate the first NLU hypothesis. Moreover, the second NLU hypothesis may be associated with a second confidence score indicating the system's confidence with respect to NLU processing performed to generate the second NLU hypothesis. The first confidence score may be similar or identical to the second confidence score. The first confidence score and/or the second confidence score may be a numeric value (e.g., from 0.0 to 1.0). Alternatively, the first confidence score and/or the second confidence score may be a binned value (e.g., low, medium, high).

The post-NLU ranker 1165 (or other scheduling component such as orchestrator component) may solicit the first skill and the second skill to provide potential result data 1130 based on the first NLU hypothesis and the second NLU hypothesis, respectively. For example, the post-NLU ranker 1165 may send the first NLU hypothesis to the first skill 1195a along with a request for the first skill 1195a to at least partially execute with respect to the first NLU hypothesis. The post-NLU ranker 1165 may also send the second NLU hypothesis to the second skill 1195b along with a request for the second skill 1195b to at least partially execute with respect to the second NLU hypothesis. The post-NLU ranker 1165 receives, from the first skill 1195a, first result data 1130a generated from the first skill 1195a 's execution with respect to the first NLU hypothesis. The post-NLU ranker 1165 also receives, from the second skill 1195b, second results data 1130b generated from the second skill 1195b's execution with respect to the second NLU hypothesis.

The result data 1130 may include various portions. For example, the result data 1130 may include content (e.g., audio data, text data, and/or video data) to be output to a user. The result data 1130 may also include a unique identifier used by the system(s) 120 and/or the skill system(s) 125 to locate the data to be output to a user. The result data 1130 may also include an instruction. For example, if the user input corresponds to “turn on the light,” the result data 1130 may include an instruction causing the system to turn on a light associated with a profile of the device (110a/110b) and/or user.

The post-NLU ranker 1165 may consider the first result data 1130a and the second result data 1130b to alter the first confidence score and the second confidence score of the first NLU hypothesis and the second NLU hypothesis, respectively. That is, the post-NLU ranker 1165 may generate a third confidence score based on the first result data 1130a and the first confidence score. The third confidence score may correspond to how likely the post-NLU ranker 1165 determines the first skill will correctly respond to the user input. The post-NLU ranker 1165 may also generate a fourth confidence score based on the second result data 1130b and the second confidence score. One skilled in the art will appreciate that a first difference between the third confidence score and the fourth confidence score may be greater than a second difference between the first confidence score and the second confidence score. The post-NLU ranker 1165 may also consider the other data 1120 to generate the third confidence score and the fourth confidence score. While it has been described that the post-NLU ranker 1165 may alter the confidence scores associated with first and second NLU hypotheses, one skilled in the art will appreciate that the post-NLU ranker 1165 may alter the confidence scores of more than two NLU hypotheses. The post-NLU ranker 1165 may select the result data 1130 associated with the skill 1195 with the highest altered confidence score to be the data output in response to the current user input. The post-NLU ranker 1165 may also consider the ASR data 610 to alter the NLU hypotheses confidence scores.

The orchestrator component may, prior to sending the NLU results data 1185 to the post-NLU ranker 1165, associate intents in the NLU hypotheses with skills 1195. For example, if a NLU hypothesis includes a <PlayMusic> intent, the orchestrator component may associate the NLU hypothesis with one or more skills 1195 that can execute the <PlayMusic> intent. Thus, the orchestrator component may send the NLU results data 1185, including NLU hypotheses paired with skills 1195, to the post-NLU ranker 1165. In response to ASR data 610 corresponding to “what should I do for dinner today,” the orchestrator component may generates pairs of skills 1195 with associated NLU hypotheses corresponding to:
Skill 1/NLU hypothesis including <Help> intent
Skill 2/NLU hypothesis including <Order> intent
Skill 3/NLU hypothesis including <DishType> intent

The post-NLU ranker 1165 queries each skill 1195, paired with a NLU hypothesis in the NLU output data 1185, to provide result data 1130 based on the NLU hypothesis with which it is associated. That is, with respect to each skill, the post-NLU ranker 1165 colloquially asks the each skill “if given this NLU hypothesis, what would you do with it.” According to the above example, the post-NLU ranker 1165 may send skills 1195 the following data:
Skill 1: First NLU hypothesis including <Help> intent indicator
Skill 2: Second NLU hypothesis including <Order> intent indicator
Skill 3: Third NLU hypothesis including <DishType> intent indicator
   The post-NLU ranker 1165 may query each of the skills 1195 in parallel or substantially in parallel.

A skill 1195 may provide the post-NLU ranker 1165 with various data and indications in response to the post-NLU ranker 1165 soliciting the skill 1195 for result data 1130. A skill 1195 may simply provide the post-NLU ranker 1165 with an indication of whether or not the skill can execute with respect to the NLU hypothesis it received. A skill 1195 may also or alternatively provide the post-NLU ranker 1165 with output data generated based on the NLU hypothesis it received. In some situations, a skill 1195 may need further information in addition to what is represented in the received NLU hypothesis to provide output data responsive to the user input. In these situations, the skill 1195 may provide the post-NLU ranker 1165 with result data 1130 indicating slots of a framework that the skill 1195 further needs filled or entities that the skill 1195 further needs resolved prior to the skill 1195 being able to provided result data 1130 responsive to the user input. The skill 1195 may also provide the post-NLU ranker 1165 with an instruction and/or computer-generated speech indicating how the skill 1195 recommends the system solicit further information needed by the skill 1195. The skill 1195 may further provide the post-NLU ranker 1165 with an indication of whether the skill 1195 will have all needed information after the user provides additional information a single time, or whether the skill 1195 will need the user to provide various kinds of additional information prior to the skill 1195 having all needed information. According to the above example, skills 1195 may provide the post-NLU ranker 1165 with the following:
Skill 1: indication representing the skill can execute with respect to a NLU hypothesis including the <Help> intent indicator
Skill 2: indication representing the skill needs to the system to obtain further information
Skill 3: indication representing the skill can provide numerous results in response to the third NLU hypothesis including the <DishType> intent indicator

Result data 1130 includes an indication provided by a skill 1195 indicating whether or not the skill 1195 can execute with respect to a NLU hypothesis; data generated by a skill 1195 based on a NLU hypothesis; as well as an indication provided by a skill 1195 indicating the skill 1195 needs further information in addition to what is represented in the received NLU hypothesis.

The post-NLU ranker 1165 uses the result data 1130 provided by the skills 1195 to alter the NLU processing confidence scores generated by the reranker 1190. That is, the post-NLU ranker 1165 uses the result data 1130 provided by the queried skills 1195 to create larger differences between the NLU processing confidence scores generated by the reranker 1190. Without the post-NLU ranker 1165, the system may not be confident enough to determine an output in response to a user input, for example when the NLU hypotheses associated with multiple skills are too close for the system to confidently determine a single skill 1195 to invoke to respond to the user input. For example, if the system does not implement the post-NLU ranker 1165, the system may not be able to determine whether to obtain output data from a general reference information skill or a medical information skill in response to a user input corresponding to “what is acne.”

The post-NLU ranker 1165 may prefer skills 1195 that provide result data 1130 responsive to NLU hypotheses over skills 1195 that provide result data 1130 corresponding to an indication that further information is needed, as well as skills 1195 that provide result data 1130 indicating they can provide multiple responses to received NLU hypotheses. For example, the post-NLU ranker 1165 may generate a first score for a first skill 1195a that is greater than the first skill's NLU confidence score based on the first skill 1195a providing result data 1130a including a response to a NLU hypothesis. For further example, the post-NLU ranker 1165 may generate a second score for a second skill 1195b that is less than the second skill's NLU confidence score based on the second skill 1195b providing result data 1130b indicating further information is needed for the second skill 1195b to provide a response to a NLU hypothesis. Yet further, for example, the post-NLU ranker 1165 may generate a third score for a third skill 1195c that is less than the third skill's NLU confidence score based on the third skill 1195c providing result data 1130c indicating the third skill 1195c can provide multiple responses to a NLU hypothesis.

The post-NLU ranker 1165 may consider other data 1120 in determining scores. The other data 1120 may include rankings associated with the queried skills 1195. A ranking may be a system ranking or a user-specific ranking. A ranking may indicate a veracity of a skill from the perspective of one or more users of the system. For example, the post-NLU ranker 1165 may generate a first score for a first skill 1195a that is greater than the first skill's NLU processing confidence score based on the first skill 1195a being associated with a high ranking. For further example, the post-NLU ranker 1165 may generate a second score for a second skill 1195b that is less than the second skill's NLU processing confidence score based on the second skill 1195b being associated with a low ranking.

The other data 1120 may include information indicating whether or not the user that originated the user input has enabled one or more of the queried skills 1195. For example, the post-NLU ranker 1165 may generate a first score for a first skill 1195a that is greater than the first skill's NLU processing confidence score based on the first skill 1195a being enabled by the user that originated the user input. For further example, the post-NLU ranker 1165 may generate a second score for a second skill 1195b that is less than the second skill's NLU processing confidence score based on the second skill 1195b not being enabled by the user that originated the user input. When the post-NLU ranker 1165 receives the NLU results data 1185, the post-NLU ranker 1165 may determine whether profile data, associated with the user and/or device that originated the user input, includes indications of enabled skills.

The other data 1120 may include information indicating output capabilities of a device that will be used to output content, responsive to the user input, to the user. The system may include devices that include speakers but not displays, devices that include displays but not speakers, and devices that include speakers and displays. If the device that will output content responsive to the user input includes one or more speakers but not a display, the post-NLU ranker 1165 may increase the NLU processing confidence score associated with a first skill configured to output audio data and/or decrease the NLU processing confidence score associated with a second skill configured to output visual data (e.g., image data and/or video data). If the device that will output content responsive to the user input includes a display but not one or more speakers, the post-NLU ranker 1165 may increase the NLU processing confidence score associated with a first skill configured to output visual data and/or decrease the NLU processing confidence score associated with a second skill configured to output audio data.

The other data 1120 may include information indicating the veracity of the result data 1130 provided by a skill 1195. For example, if a user says “tell me a recipe for pasta sauce,” a first skill 1195a may provide the post-NLU ranker 1165 with first result data 1130a corresponding to a first recipe associated with a five star rating and a second skill 1195b may provide the post-NLU ranker 1165 with second result data 1130b corresponding to a second recipe associated with a one star rating. In this situation, the post-NLU ranker 1165 may increase the NLU processing confidence score associated with the first skill 1195a based on the first skill 1195a providing the first result data 1130a associated with the five star rating and/or decrease the NLU processing confidence score associated with the second skill 1195b based on the second skill 1195b providing the second result data 1130b associated with the one star rating.

The other data 1120 may include information indicating the type of device that originated the user input. For example, the device may correspond to a “hotel room” type if the device is located in a hotel room. If a user inputs a command corresponding to “order me food” to the device located in the hotel room, the post-NLU ranker 1165 may increase the NLU processing confidence score associated with a first skill 1195a corresponding to a room service skill associated with the hotel and/or decrease the NLU processing confidence score associated with a second skill 1195b corresponding to a food skill not associated with the hotel.

The other data 1120 may include information indicating a location of the device and/or user that originated the user input. The system may be configured with skills 1195 that may only operate with respect to certain geographic locations. For example, a user may provide a user input corresponding to “when is the next train to Portland.” A first skill 1195a may operate with respect to trains that arrive at, depart from, and pass through Portland, Oregon. A second skill 1195b may operate with respect to trains that arrive at, depart from, and pass through Portland, Maine. If the device and/or user that originated the user input is located in Seattle, Washington, the post-NLU ranker 1165 may increase the NLU processing confidence score associated with the first skill 1195a and/or decrease the NLU processing confidence score associated with the second skill 1195b. Likewise, if the device and/or user that originated the user input is located in Boston, Massachusetts, the post-NLU ranker 1165 may increase the NLU processing confidence score associated with the second skill 1195b and/or decrease the NLU processing confidence score associated with the first skill 1195a.

The other data 1120 may include information indicating a time of day. The system may be configured with skills 1195 that operate with respect to certain times of day. For example, a user may provide a user input corresponding to “order me food.” A first skill 1195a may generate first result data 1130a corresponding to breakfast. A second skill 1195b may generate second result data 1130b corresponding to dinner. If the system(s) 120 receives the user input in the morning, the post-NLU ranker 1165 may increase the NLU processing confidence score associated with the first skill 1195a and/or decrease the NLU processing score associated with the second skill 1195b. If the system(s) 120 receives the user input in the afternoon or evening, the post-NLU ranker 1165 may increase the NLU processing confidence score associated with the second skill 1195b and/or decrease the NLU processing confidence score associated with the first skill 1195a.

The other data 1120 may include information indicating user preferences. The system may include multiple skills 1195 configured to execute in substantially the same manner. For example, a first skill 1195a and a second skill 1195b may both be configured to order food from respective restaurants. The system may store a user preference (e.g., in a profile storage) that is associated with the user that provided the user input to the system(s) 120 as well as indicates the user prefers the first skill 1195a over the second skill 1195b. Thus, when the user provides a user input that may be executed by both the first skill 1195a and the second skill 1195b, the post-NLU ranker 1165 may increase the NLU processing confidence score associated with the first skill 1195a and/or decrease the NLU processing confidence score associated with the second skill 1195b.

The other data 1120 may include information indicating system usage history associated with the user that originated the user input. For example, the system usage history may indicate the user originates user inputs that invoke a first skill 1195a more often than the user originates user inputs that invoke a second skill 1195b. Based on this, if the present user input may be executed by both the first skill 1195a and the second skill 1195b, the post-NLU ranker 1165 may increase the NLU processing confidence score associated with the first skill 1195a and/or decrease the NLU processing confidence score associated with the second skill 1195b.

The other data 1120 may include information indicating a speed at which the device 110 that originated the user input is traveling. For example, the device 110 may be located in a moving vehicle, or may be a moving vehicle. When a device 110 is in motion, the system may prefer audio outputs rather than visual outputs to decrease the likelihood of distracting the user (e.g., a driver of a vehicle). Thus, for example, if the device 110 that originated the user input is moving at or above a threshold speed (e.g., a speed above an average user's walking speed), the post-NLU ranker 1165 may increase the NLU processing confidence score associated with a first skill 1195a that generates audio data. The post-NLU ranker 1165 may also or alternatively decrease the NLU processing confidence score associated with a second skill 1195b that generates image data or video data.

The other data 1120 may include information indicating how long it took a skill 1195 to provide result data 1130 to the post-NLU ranker 1165. When the post-NLU ranker 1165 multiple skills 1195 for result data 1130, the skills 1195 may respond to the queries at different speeds. The post-NLU ranker 1165 may implement a latency budget. For example, if the post-NLU ranker 1165 determines a skill 1195 responds to the post-NLU ranker 1165 within a threshold amount of time from receiving a query from the post-NLU ranker 1165, the post-NLU ranker 1165 may increase the NLU processing confidence score associated with the skill 1195. Conversely, if the post-NLU ranker 1165 determines a skill 1195 does not respond to the post-NLU ranker 1165 within a threshold amount of time from receiving a query from the post-NLU ranker 1165, the post-NLU ranker 1165 may decrease the NLU processing confidence score associated with the skill 1195.

It has been described that the post-NLU ranker 1165 uses the other data 1120 to increase and decrease NLU processing confidence scores associated with various skills 1195 that the post-NLU ranker 1165 has already requested result data from. Alternatively, the post-NLU ranker 1165 may use the other data 1120 to determine which skills 1195 to request result data from. For example, the post-NLU ranker 1165 may use the other data 1120 to increase and/or decrease NLU processing confidence scores associated with skills 1195 associated with the NLU results data 1185 output by the NLU component 160. The post-NLU ranker 1165 may select n-number of top scoring altered NLU processing confidence scores. The post-NLU ranker 1165 may then request result data 1130 from only the skills 1195 associated with the selected n-number of NLU processing confidence scores.

As described, the post-NLU ranker 1165 may request result data 1130 from all skills 1195 associated with the NLU results data 1185 output by the NLU component 160. Alternatively, the system(s) 120 may prefer result data 1130 from skills implemented entirely by the system(s) 120 rather than skills at least partially implemented by the skill system(s) 125. Therefore, in the first instance, the post-NLU ranker 1165 may request result data 1130 from only skills associated with the NLU results data 1185 and entirely implemented by the system(s) 120. The post-NLU ranker 1165 may only request result data 1130 from skills associated with the NLU results data 1185, and at least partially implemented by the skill system(s) 125, if none of the skills, wholly implemented by the system(s) 120, provide the post-NLU ranker 1165 with result data 1130 indicating either data response to the NLU results data 1185, an indication that the skill can execute the user input, or an indication that further information is needed.

As indicated above, the post-NLU ranker 1165 may request result data 1130 from multiple skills 1195. If one of the skills 1195 provides result data 1130 indicating a response to a NLU hypothesis and the other skills provide result data 1130 indicating either they cannot execute or they need further information, the post-NLU ranker 1165 may select the result data 1130 including the response to the NLU hypothesis as the data to be output to the user. If more than one of the skills 1195 provides result data 1130 indicating responses to NLU hypotheses, the post-NLU ranker 1165 may consider the other data 1120 to generate altered NLU processing confidence scores, and select the result data 1130 of the skill associated with the greatest score as the data to be output to the user.

A system that does not implement the post-NLU ranker 1165 may select the highest scored NLU hypothesis in the NLU results data 1185. The system may send the NLU hypothesis to a skill 1195 associated therewith along with a request for output data. In some situations, the skill 1195 may not be able to provide the system with output data. This results in the system indicating to the user that the user input could not be processed even though another skill associated with lower ranked NLU hypothesis could have provided output data responsive to the user input.

The post-NLU ranker 1165 reduces instances of the aforementioned situation. As described, the post-NLU ranker 1165 queries multiple skills associated with the NLU results data 1185 to provide result data 1130 to the post-NLU ranker 1165 prior to the post-NLU ranker 1165 ultimately determining the skill 1195 to be invoked to respond to the user input. Some of the skills 1195 may provide result data 1130 indicating responses to NLU hypotheses while other skills 1195 may providing result data 1130 indicating the skills cannot provide responsive data. Whereas a system not implementing the post-NLU ranker 1165 may select one of the skills 1195 that could not provide a response, the post-NLU ranker 1165 only selects a skill 1195 that provides the post-NLU ranker 1165 with result data corresponding to a response, indicating further information is needed, or indicating multiple responses can be generated.

The post-NLU ranker 1165 may select result data 1130, associated with the skill 1195 associated with the highest score, for output to the user. Alternatively, the post-NLU ranker 1165 may output ranked output data 1125 indicating skills 1195 and their respective post-NLU ranker rankings. Since the post-NLU ranker 1165 receives result data 1130, potentially corresponding to a response to the user input, from the skills 1195 prior to post-NLU ranker 1165 selecting one of the skills or outputting the ranked output data 1125, little to no latency occurs from the time skills provide result data 1130 and the time the system outputs responds to the user.

If the post-NLU ranker 1165 selects result audio data to be output to a user and the system determines content should be output audibly, the post-NLU ranker 1165 (or another component of the system(s) 120) may cause the device 110a and/or the device 110b to output audio corresponding to the result audio data. If the post-NLU ranker 1165 selects result text data to output to a user and the system determines content should be output visually, the post-NLU ranker 1165 (or another component of the system(s) 120) may cause the device 110b to display text corresponding to the result text data. If the post-NLU ranker 1165 selects result audio data to output to a user and the system determines content should be output visually, the post-NLU ranker 1165 (or another component of the system(s) 120) may send the result audio data to the ASR component 150. The ASR component 150 may generate output text data corresponding to the result audio data. The system(s) 120 may then cause the device 110b to display text corresponding to the output text data. If the post-NLU ranker 1165 selects result text data to output to a user and the system determines content should be output audibly, the post-NLU ranker 1165 (or another component of the system(s) 120) may send the result text data to the TTS component 180. The TTS component 180 may generate output audio data (corresponding to computer-generated speech) based on the result text data. The system(s) 120 may then cause the device 110a and/or the device 110b to output audio corresponding to the output audio data.

As described, a skill 1195 may provide result data 1130 either indicating a response to the user input, indicating more information is needed for the skill 1195 to provide a response to the user input, or indicating the skill 1195 cannot provide a response to the user input. If the skill 1195 associated with the highest post-NLU ranker score provides the post-NLU ranker 1165 with result data 1130 indicating a response to the user input, the post-NLU ranker 1165 (or another component of the system(s) 120, such as the orchestrator component) may simply cause content corresponding to the result data 1130 to be output to the user. For example, the post-NLU ranker 1165 may send the result data 1130 to the orchestrator component. The orchestrator component may cause the result data 1130 to be sent to the device (110a/110b), which may output audio and/or display text corresponding to the result data 1130. The orchestrator component may send the result data 1130 to the ASR component 150 to generate output text data and/or may send the result data 1130 to the TTS component 180 to generate output audio data, depending on the situation.

The skill 1195 associated with the highest post-NLU ranker score may provide the post-NLU ranker 1165 with result data 1130 indicating more information is needed as well as instruction data. The instruction data may indicate how the skill 1195 recommends the system obtain the needed information. For example, the instruction data may correspond to text data or audio data (i.e., computer-generated speech) corresponding to “please indicate ______.” The instruction data may be in a format (e.g., text data or audio data) capable of being output by the device (110a/110b). When this occurs, the post-NLU ranker 1165 may simply cause the received instruction data be output by the device (110a/110b). Alternatively, the instruction data may be in a format that is not capable of being output by the device (110a/110b). When this occurs, the post-NLU ranker 1165 may cause the ASR component 150 or the TTS component 180 to process the instruction data, depending on the situation, to generate instruction data that may be output by the device (110a/110b). Once the user provides the system with all further information needed by the skill 1195, the skill 1195 may provide the system with result data 1130 indicating a response to the user input, which may be output by the system as detailed above.

The system may include “informational” skills 1195 that simply provide the system with information, which the system outputs to the user. The system may also include “transactional” skills 1195 that require a system instruction to execute the user input. Transactional skills 1195 include ride sharing skills, flight booking skills, etc. A transactional skill 1195 may simply provide the post-NLU ranker 1165 with result data 1130 indicating the transactional skill 1195 can execute the user input. The post-NLU ranker 1165 may then cause the system to solicit the user for an indication that the system is permitted to cause the transactional skill 1195 to execute the user input. The user-provided indication may be an audible indication or a tactile indication (e.g., activation of a virtual button or input of text via a virtual keyboard). In response to receiving the user-provided indication, the system may provide the transactional skill 1195 with data corresponding to the indication. In response, the transactional skill 1195 may execute the command (e.g., book a flight, book a train ticket, etc.). Thus, while the system may not further engage an informational skill 1195 after the informational skill 1195 provides the post-NLU ranker 1165 with result data 1130, the system may further engage a transactional skill 1195 after the transactional skill 1195 provides the post-NLU ranker 1165 with result data 1130 indicating the transactional skill 1195 may execute the user input.

In some instances, the post-NLU ranker 1165 may generate respective scores for first and second skills that are too close (e.g., are not different by at least a threshold difference) for the post-NLU ranker 1165 to make a confident determination regarding which skill should execute the user input. When this occurs, the system may request the user indicate which skill the user prefers to execute the user input. The system may output TTS-generated speech to the user to solicit which skill the user wants to execute the user input.

One or more models implemented by components of the orchestrator component, post-NLU ranker 1165, shortlister 1050, or other component may be trained and operated according to various machine learning techniques.

FIG. 12 is a conceptual diagram of components of an image processing component, according to embodiments of the present disclosure.

The system(s) 120 may include image processing component 142. The image processing component 142 may located across different physical and/or virtual machines. The image processing component 142 may receive and analyze image data (which may include single images or a plurality of images such as in a video feed). The image processing component 142 may work with other components of the system 120 to perform various operations. For example the image processing component 142 may work with user recognition component 195 to assist with user recognition using image data. The image processing component 142 may also include or otherwise be associated with image data storage 1270 which may store aspects of image data used by image processing component 142. The image data may be of different formats such as JPEG, GIF, BMP, MPEG, video formats, and the like.

Image matching algorithms, such as those used by image processing component 142, may take advantage of the fact that an image of an object or scene contains a number of feature points. Feature points are specific points in an image which are robust to changes in image rotation, scale, viewpoint or lighting conditions. This means that these feature points will often be present in both the images to be compared, even if the two images differ. These feature points may also be known as “points of interest.” Therefore, a first stage of the image matching algorithm may include finding these feature points in the image. An image pyramid may be constructed to determine the feature points of an image. An image pyramid is a scale-space representation of the image, e.g., it contains various pyramid images, each of which is a representation of the image at a particular scale. The scale-space representation enables the image matching algorithm to match images that differ in overall scale (such as images taken at different distances from an object). Pyramid images may be smoothed and downsampled versions of an original image.

To build a database of object images, with multiple objects per image, a number of different images of an object may be taken from different viewpoints. From those images, feature points may be extracted and pyramid images constructed. Multiple images from different points of view of each particular object may be taken and linked within the database (for example within a tree structure described below). The multiple images may correspond to different viewpoints of the object sufficient to identify the object from any later angle that may be included in a user's query image. For example, a shoe may look very different from a bottom view than from a top view than from a side view. For certain objects, this number of different image angles may be 6 (top, bottom, left side, right side, front, back), for other objects this may be more or less depending on various factors, including how many images should be taken to ensure the object may be recognized in an incoming query image. With different images of the object available, it is more likely that an incoming image from a user may be recognized by the system and the object identified, even if the user's incoming image is taken at a slightly different angle.

This process may be repeated for multiple objects. For large databases, such as an online shopping database where a user may submit an image of an object to be identified, this process may be repeated thousands, if not millions of times to construct a database of images and data for image matching. The database also may continually be updated and/or refined to account for a changing catalog of objects to be recognized.

When configuring the database, pyramid images, feature point data, and/or other information from the images or objects may be used to cluster features and build a tree of objects and images, where each node of the tree will keep lists of objects and corresponding features. The tree may be configured to group visually significant subsets of images/features to ease matching of submitted images for object detection. Data about objects to be recognized may be stored by the system in image data 1270, a profile storage, or other storage component.

Image selection component 1220 may select desired images from input image data to use for image processing at runtime. For example, input image data may come from a series of sequential images, such as a video stream where each image is a frame of the video stream. These incoming images need to be sorted to determine which images will be selected for further object recognition processing as performing image processing on low quality images may result in an undesired user experience. To avoid such an undesirable user experience, the time to perform the complete recognition process, from first starting the video feed to delivering results to the user, should be as short as possible. As images in a video feed may come in rapid succession, the image processing component 142 may be configured to select or discard an image quickly so that the system can, in turn, quickly process the selected image and deliver results to a user. The image selection component 1220 may select an image for object recognition by computing a metric/feature for each frame in the video feed and selecting an image for processing if the metric exceeds a certain threshold. While FIG. 12 illustrates image selection component 1220 as part of system 120, it may also be located on device 110 so that the device may select only desired image(s) to send to system 120, thus avoiding sending too much image data to system 120 (thus expending unnecessary computing/communication resources). Thus the device may select only the best quality images for purposes of image analysis.

The metrics used to select an image may be general image quality metrics (focus, sharpness, motion, etc.) or may be customized image quality metrics. The metrics may be computed by software components or hardware components. For example, the metrics may be derived from output of device sensors such as a gyroscope, accelerometer, field sensors, inertial sensors, camera metadata, or other components. The metrics may thus be image based (such as a statistic derived from an image or taken from camera metadata like focal length or the like) or may be non-image based (for example, motion data derived from a gyroscope, accelerometer, GPS sensor, etc.). As images from the video feed are obtained by the system, the system, such as a device, may determine metric values for the image. One or more metrics may be determined for each image. To account for temporal fluctuation, the individual metrics for each respective image may be compared to the metric values for previous images in the image feed and thus a historical metric value for the image and the metric may be calculated. This historical metric may also be referred to as a historical metric value. The historical metric values may include representations of certain metric values for the image compared to the values for that metric for a group of different images in the same video feed. The historical metric(s) may be processed using a trained classifier model to select which images are suitable for later processing.

For example, if a particular image is to be measured using a focus metric, which is a numerical representation of the focus of the image, the focus metric may also be computed for the previous N frames to the particular image. N is a configurable number and may vary depending on system constraints such as latency, accuracy, etc. For example, N may be 30 image frames, representing, for example, one second of video at a video feed of 30 frames-per-second. A mean of the focus metrics for the previous N images may be computed, along with a standard deviation for the focus metric. For example, for an image number X+1 in a video feed sequence, the previous N images, may have various metric values associated with each of them. Various metrics such as focus, motion, and contrast are discussed, but others are possible. A value for each metric for each of the N images may be calculated, and then from those individual values, a mean value and standard deviation value may be calculated. The mean and standard deviation (STD) may then be used to calculate a normalized historical metric value, for example STD(metric)/MEAN(metric). Thus, the value of a historical focus metric at a particular image may be the STD divided by the mean for the focus metric for the previous N frames. For example, historical metrics (HIST) for focus, motion, and contrast may be expressed as:

$${HIST}_{Focus} = \frac{{STD}_{Focus}}{{MEAN}_{Focus}}$$

$${HIST}_{Motion} = \frac{{STD}_{Motion}}{{MEAN}_{Motion}}$$

$${HIST}_{Contrast} = \frac{{STD}_{Contrast}}{{MEAN}_{Contrast}}$$

In one embodiment the historical metric may be further normalized by dividing the above historical metrics by the number of frames N, particularly in situations where there are small number of frames under consideration for the particular time window. The historical metrics may be recalculated with each new image frame that is received as part of the video feed. Thus each frame of an incoming video feed may have a different historical metric from the frame before. The metrics for a particular image of a video feed may be compared historical metrics to select a desirable image on which to perform image processing.

Image selection component 1220 may perform various operations to identify potential locations in an image that may contain recognizable text. This process may be referred to as glyph region detection. A glyph is a text character that has yet to be recognized. If a glyph region is detected, various metrics may be calculated to assist the eventual optical character recognition (OCR) process. For example, the same metrics used for overall image selection may be re-used or recalculated for the specific glyph region. Thus, while the entire image may be of sufficiently high quality, the quality of the specific glyph region (i.e. focus, contrast, intensity, etc.) may be measured. If the glyph region is of poor quality, the image may be rejected for purposes of text recognition.

Image selection component 1220 may generate a bounding box that bounds a line of text. The bounding box may bound the glyph region. Value(s) for image/region suitability metric(s) may be calculated for the portion of the image in the bounding box. Value(s) for the same metric(s) may also be calculated for the portion of the image outside the bounding box. The value(s) for inside the bounding box may then be compared to the value(s) outside the bounding box to make another determination on the suitability of the image. This determination may also use a classifier.

Additional features may be calculated for determining whether an image includes a text region of sufficient quality for further processing. The values of these features may also be processed using a classifier to determine whether the image contains true text character/glyphs or is otherwise suitable for recognition processing. To locally classify each candidate character location as a true text character/glyph location, a set of features that capture salient characteristics of the candidate location is extracted from the local pixel pattern. Such features may include aspect ratio (bounding box width/bounding box height), compactness (4*π*candidate glyph area/(perimeter)²), solidity (candidate glyph area/bounding box area), stroke-width to width ratio (maximum stroke width/bounding box width), stroke-width to height ratio (maximum stroke width/bounding box height), convexity (convex hull perimeter/perimeter), raw compactness (4*π*(candidate glyph number of pixels)/(perimeter)²), number of holes in candidate glyph, or other features. Other candidate region identification techniques may be used. For example, the system may use techniques involving maximally stable extremal regions (MSERs). Instead of MSERs (or in conjunction with MSERs), the candidate locations may be identified using histogram of oriented gradients (HoG) and Gabor features.

If an image is sufficiently high quality it may be selected by image selection 1220 for sending to another component (e.g., from device to system 120) and/or for further processing, such as text recognition, object detection/resolution, etc.

The feature data calculated by image selection component 1220 may be sent to other components such as text recognition component 1240, object detection component 1230, object resolution component 1250, etc. so that those components may use the feature data in their operations. Other preprocessing operations such as masking, binarization, etc. may be performed on image data prior to recognition/resolution operations. Those preprocessing operations may be performed by the device prior to sending image data or by system 120.

Object detection component 1230 may be configured to analyze image data to identify one or more objects represented in the image data. Various approaches can be used to attempt to recognize and identify objects, as well as to determine the types of those objects and applications or actions that correspond to those types of objects, as is known or used in the art. For example, various computer vision algorithms can be used to attempt to locate, recognize, and/or identify various types of objects in an image or video sequence. Computer vision algorithms can utilize various different approaches, as may include edge matching, edge detection, recognition by parts, gradient matching, histogram comparisons, interpretation trees, and the like.

The object detection component 1230 may process at least a portion of the image data to determine feature data. The feature data is indicative of one or more features that are depicted in the image data. For example, the features may be face data, or other objects, for example as represented by stored data in a profile storage. Other examples of features may include shapes of body parts or other such features that identify the presence of a human. Other examples of features may include edges of doors, shadows on the wall, texture on the walls, portions of artwork in the environment, and so forth to identify a space. The object detection component 1230 may compare detected features to stored data (e.g., in a profile storage, image data 1270, or other storage) indicating how detected features may relate to known objects for purposes of object detection.

Various techniques may be used to determine the presence of features in image data. For example, one or more of a Canny detector, Sobel detector, difference of Gaussians, features from accelerated segment test (FAST) detector, scale-invariant feature transform (SIFT), speeded up robust features (SURF), color SIFT, local binary patterns (LBP), trained convolutional neural network, or other detection methodologies may be used to determine features in the image data. A feature that has been detected may have an associated descriptor that characterizes that feature. The descriptor may comprise a vector value in some implementations. For example, the descriptor may comprise data indicative of the feature with respect to many (e.g., 256) different dimensions.

One statistical algorithm that may be used for geometric matching of images is the Random Sample Consensus (RANSAC) algorithm, although other variants of RANSAC-like algorithms or other statistical algorithms may also be used. In RANSAC, a small set of putative correspondences is randomly sampled. Thereafter, a geometric transformation is generated using these sampled feature points. After generating the transformation, the putative correspondences that fit the model are determined. The putative correspondences that fit the model and are geometrically consistent and called “inliers.” The inliers are pairs of feature points, one from each image, that may correspond to each other, where the pair fits the model within a certain comparison threshold for the visual (and other) contents of the feature points, and are geometrically consistent (as explained below relative to motion estimation). A total number of inliers may be determined. The above mentioned steps may be repeated until the number of repetitions/trials is greater than a predefined threshold or the number of inliers for the image is sufficiently high to determine an image as a match (for example the number of inliers exceeds a threshold). The RANSAC algorithm returns the model with the highest number of inliers corresponding to the model.

To further test pairs of putative corresponding feature points between images, after the putative correspondences are determined, a topological equivalence test may be performed on a subset of putative correspondences to avoid forming a physically invalid transformation. After the transformation is determined, an orientation consistency test may be performed. An offset point may be determined for the feature points in the subset of putative correspondences in one of the images. Each offset point is displaced from its corresponding feature point in the direction of the orientation of that feature point. The transformation is discarded based on orientation of the feature points obtained from the feature points in the subset of putative correspondences if any one of the images being matched and its offset point differs from an estimated orientation by a predefined limit. Subsequently, motion estimation may be performed using the subset of putative correspondences which satisfy the topological equivalence test.

Motion estimation (also called geometric verification) may determine the relative differences in position between corresponding pairs of putative corresponding feature points. A geometric relationship between putative corresponding feature points may determine where in one image (e.g., the image input to be matched) a particular point is found relative to that potentially same point in the putatively matching image (i.e., a database image). The geometric relationship between many putatively corresponding feature point pairs may also be determined, thus creating a potential map between putatively corresponding feature points across images. Then the geometric relationship of these points may be compared to determine if a sufficient number of points correspond (that is, if the geometric relationship between point pairs is within a certain threshold score for the geometric relationship), thus indicating that one image may represent the same real-world physical object, albeit from a different point of view. Thus, the motion estimation may determine that the object in one image is the same as the object in another image, only rotated by a certain angle or viewed from a different distance, etc.

The above processes of image comparing feature points and performing motion estimation across putative matching images may be performed multiple times for a particular query image to compare the query image to multiple potential matches among the stored database images. Dozens of comparisons may be performed before one (or more) satisfactory matches that exceed the relevant thresholds (for both matching feature points and motion estimation) may be found. The thresholds may also include a confidence threshold, which compares each potential matching image with a confidence score that may be based on the above processing. If the confidence score exceeds a certain high threshold, the system may stop processing additional candidate matches and simply select the high confidence match as the final match. Or if, the confidence score of an image is within a certain range, the system may keep the candidate image as a potential match while continuing to search other database images for potential matches. In certain situations, multiple database images may exceed the various matching/confidence thresholds and may be determined to be candidate matches. In this situation, a comparison of a weight or confidence score may be used to select the final match, or some combination of candidate matches may be used to return results. The system may continue attempting to match an image until a certain number of potential matches are identified, a certain confidence score is reached (either individually with a single potential match or among multiple matches), or some other search stop indicator is triggered. For example, a weight may be given to each object of a potential matching database image. That weight may incrementally increase if multiple query images (for example, multiple frames from the same image stream) are found to be matches with database images of a same object. If that weight exceeds a threshold, a search stop indicator may be triggered and the corresponding object selected as the match.

Once an object is detected by object detection component 1230 the system may determine which object is actually seen using object resolution component 1250. Thus one component, such as object detection component 1230, may detect if an object is represented in an image while another component, object resolution component 1250 may determine which object is actually represented. Although illustrated as separate components, the system may also be configured so that a single component may perform both object detection and object resolution.

For example, when a database image is selected as a match to the query image, the object in the query image may be determined to be the object in the matching database image. An object identifier associated with the database image (such as a product ID or other identifier) may be used to return results to a user, along the lines of “I see you holding object X” along with other information, such giving the user information about the object. If multiple potential matches are returned (such as when the system can't determine exactly what object is found or if multiple objects appear in the query image) the system may indicate to the user that multiple potential matching objects are found and may return information/options related to the multiple objects.

In another example, object detection component 1230 may determine that a type of object is represented in image data and object resolution component 1250 may then determine which specific object is represented. The object resolution component 1250 may also make available specific data about a recognized object to further components so that further operations may be performed with regard to the resolved object.

Object detection component 1230 may be configured to process image data to detect a representation of an approximately two-dimensional (2D) object (such as a piece of paper) or a three-dimensional (3D) object (such as a face). Such recognition may be based on available stored data (e.g., a user profile, image data, etc.) which in turn may have been provided through an image data ingestion process managed by image data ingestion component 1210. Various techniques may be used to determine the presence of features in image data. For example, one or more of a Canny detector, Sobel detector, difference of Gaussians, features from accelerated segment test (FAST) detector, scale-invariant feature transform (SIFT), speeded up robust features (SURF), color SIFT, local binary patterns (LBP), trained convolutional neural network, or other detection methodologies may be used to determine features in the image data. A feature that has been detected may have an associated descriptor that characterizes that feature. The descriptor may comprise a vector value in some implementations. For example, the descriptor may comprise data indicative of the feature with respect to many (e.g., 256) different dimensions.

FIG. 13 is a schematic diagram of an illustrative architecture in which sensor data is combined to recognize one or more users according to embodiments of the present disclosure.

The device 110 and/or the system(s) 120 may include a user recognition component 195 that recognizes one or more users using a variety of data. As illustrated in FIG. 13, the user recognition component 195 may include one or more subcomponents including a vision component 1308, an audio component 1310, a biometric component 1312, a radio frequency (RF) component 1314, a machine learning (ML) component 1316, and a recognition confidence component 1318. In some instances, the user recognition component 195 may monitor data and determinations from one or more subcomponents to determine an identity of one or more users associated with data input to the device 110 and/or the system(s) 120. The user recognition component 195 may output user recognition data 1395, which may include a user identifier associated with a user the user recognition component 195 determines originated data input to the device 110 and/or the system(s) 120. The user recognition data 1395 may be used to inform processes performed by various components of the device 110 and/or the system(s) 120.

The vision component 1308 may receive data from one or more sensors capable of providing images (e.g., cameras) or sensors indicating motion (e.g., motion sensors). The vision component 1308 can perform facial recognition or image analysis to determine an identity of a user and to associate that identity with a user profile associated with the user. In some instances, when a user is facing a camera, the vision component 1308 may perform facial recognition and identify the user with a high degree of confidence. In other instances, the vision component 1308 may have a low degree of confidence of an identity of a user, and the user recognition component 195 may utilize determinations from additional components to determine an identity of a user. The vision component 1308 can be used in conjunction with other components to determine an identity of a user. For example, the user recognition component 195 may use data from the vision component 1308 with data from the audio component 1310 to identify what user's face appears to be speaking at the same time audio is captured by a device 110 the user is facing for purposes of identifying a user who spoke an input to the device 110 and/or the system(s) 120.

The overall system of the present disclosure may include biometric sensors that transmit data to the biometric component 1312. For example, the biometric component 1312 may receive data corresponding to fingerprints, iris or retina scans, thermal scans, weights of users, a size of a user, pressure (e.g., within floor sensors), etc., and may determine a biometric profile corresponding to a user. The biometric component 1312 may distinguish between a user and sound from a television, for example. Thus, the biometric component 1312 may incorporate biometric information into a confidence level for determining an identity of a user. Biometric information output by the biometric component 1312 can be associated with specific user profile data such that the biometric information uniquely identifies a user profile of a user.

The radio frequency (RF) component 1314 may use RF localization to track devices that a user may carry or wear. For example, a user (and a user profile associated with the user) may be associated with a device. The device may emit RF signals (e.g., Wi-Fi, Bluetooth®, etc.). A device may detect the signal and indicate to the RF component 1314 the strength of the signal (e.g., as a received signal strength indication (RSSI)). The RF component 1314 may use the RSSI to determine an identity of a user (with an associated confidence level). In some instances, the RF component 1314 may determine that a received RF signal is associated with a mobile device that is associated with a particular user identifier.

In some instances, a personal device (such as a phone, tablet, wearable or other device) may include some RF or other detection processing capabilities so that a user who speaks an input may scan, tap, or otherwise acknowledge his/her personal device to the device 110. In this manner, the user may “register” with the system 100 for purposes of the system 100 determining who spoke a particular input. Such a registration may occur prior to, during, or after speaking of an input.

The ML component 1316 may track the behavior of various users as a factor in determining a confidence level of the identity of the user. By way of example, a user may adhere to a regular schedule such that the user is at a first location during the day (e.g., at work or at school). In this example, the ML component 1316 would factor in past behavior and/or trends in determining the identity of the user that provided input to the device 110 and/or the system(s) 120. Thus, the ML component 1316 may use historical data and/or usage patterns over time to increase or decrease a confidence level of an identity of a user.

In at least some instances, the recognition confidence component 1318 receives determinations from the various components 1308, 1310, 1312, 1314, and 1316, and may determine a final confidence level associated with the identity of a user. In some instances, the confidence level may determine whether an action is performed in response to a user input. For example, if a user input includes a request to unlock a door, a confidence level may need to be above a threshold that may be higher than a threshold confidence level needed to perform a user request associated with playing a playlist or sending a message. The confidence level or other score data may be included in the user recognition data 1395.

The audio component 1310 may receive data from one or more sensors capable of providing an audio signal (e.g., one or more microphones) to facilitate recognition of a user. The audio component 1310 may perform audio recognition on an audio signal to determine an identity of the user and associated user identifier. In some instances, aspects of device 110 and/or the system(s) 120 may be configured at a computing device (e.g., a local server). Thus, in some instances, the audio component 1310 operating on a computing device may analyze all sound to facilitate recognition of a user. In some instances, the audio component 1310 may perform voice recognition to determine an identity of a user.

The audio component 1310 may also perform user identification based on audio data 611 input into the device 110 and/or the system(s) 120 for speech processing. The audio component 1310 may determine scores indicating whether speech in the audio data 611 originated from particular users. For example, a first score may indicate a likelihood that speech in the audio data 611 originated from a first user associated with a first user identifier, a second score may indicate a likelihood that speech in the audio data 611 originated from a second user associated with a second user identifier, etc. The audio component 1310 may perform user recognition by comparing speech characteristics represented in the audio data 611 to stored speech characteristics of users (e.g., stored voice profiles associated with the device 110 that captured the spoken user input).

FIG. 14 illustrates user recognition processing as may be performed by the user recognition component 195. The ASR component 150 performs ASR processing on ASR feature vector data 1450. ASR confidence data 1407 may be passed to the user recognition component 195. The user recognition component 195 may perform user recognition using various data including the user recognition feature vector data 1440, feature vectors 1405 representing voice profiles of users of the system 100, the ASR confidence data 1407, and other data 1409. The user recognition component 195 may output the user recognition data 1395, which reflects a certain confidence that the user input was spoken by one or more particular users. The user recognition data 1395 may include one or more user identifiers (e.g., corresponding to one or more voice profiles). Each user identifier in the user recognition data 1395 may be associated with a respective confidence value, representing a likelihood that the user input corresponds to the user identifier. A confidence value may be a numeric or binned value.

The feature vector(s) 1405 input to the user recognition component 195 may correspond to one or more voice profiles. The user recognition component 195 may use the feature vector(s) 1405 to compare against the user recognition feature vector 1440, representing the present user input, to determine whether the user recognition feature vector 1440 corresponds to one or more of the feature vectors 1405 of the voice profiles. Each feature vector 1405 may be the same size as the user recognition feature vector 1440.

To perform user recognition, the user recognition component 195 may determine the device 110 from which the audio data 611 originated. For example, the audio data 611 may be associated with metadata including a device identifier representing the device 110. Either the device 110 or the system(s) 120 may generate the metadata. The system 100 may determine a group profile identifier associated with the device identifier, may determine user identifiers associated with the group profile identifier, and may include the group profile identifier and/or the user identifiers in the metadata. The system 100 may associate the metadata with the user recognition feature vector 1440 produced from the audio data 611. The user recognition component 195 may send a signal to voice profile storage 1485, with the signal requesting only audio data and/or feature vectors 1405 (depending on whether audio data and/or corresponding feature vectors are stored) associated with the device identifier, the group profile identifier, and/or the user identifiers represented in the metadata. This limits the universe of possible feature vectors 1405 the user recognition component 195 considers at runtime and thus decreases the amount of time to perform user recognition processing by decreasing the amount of feature vectors 1405 needed to be processed. Alternatively, the user recognition component 195 may access all (or some other subset of) the audio data and/or feature vectors 1405 available to the user recognition component 195. However, accessing all audio data and/or feature vectors 1405 will likely increase the amount of time needed to perform user recognition processing based on the magnitude of audio data and/or feature vectors 1405 to be processed.

If the user recognition component 195 receives audio data from the voice profile storage 1485, the user recognition component 195 may generate one or more feature vectors 1405 corresponding to the received audio data.

The user recognition component 195 may attempt to identify the user that spoke the speech represented in the audio data 611 by comparing the user recognition feature vector 1440 to the feature vector(s) 1405. The user recognition component 195 may include a scoring component 1422 that determines respective scores indicating whether the user input (represented by the user recognition feature vector 1440) was spoken by one or more particular users (represented by the feature vector(s) 1405). The user recognition component 195 may also include a confidence component 1424 that determines an overall accuracy of user recognition processing (such as those of the scoring component 1422) and/or an individual confidence value with respect to each user potentially identified by the scoring component 1422. The output from the scoring component 1422 may include a different confidence value for each received feature vector 1405. For example, the output may include a first confidence value for a first feature vector 1405a (representing a first voice profile), a second confidence value for a second feature vector 1405b (representing a second voice profile), etc. Although illustrated as two separate components, the scoring component 1422 and the confidence component 1424 may be combined into a single component or may be separated into more than two components.

The scoring component 1422 and the confidence component 1424 may implement one or more trained machine learning models (such as neural networks, classifiers, etc.) as known in the art. For example, the scoring component 1422 may use probabilistic linear discriminant analysis (PLDA) techniques. PLDA scoring determines how likely it is that the user recognition feature vector 1440 corresponds to a particular feature vector 1405. The PLDA scoring may generate a confidence value for each feature vector 1405 considered and may output a list of confidence values associated with respective user identifiers. The scoring component 1422 may also use other techniques, such as GMMs, generative Bayesian models, or the like, to determine confidence values.

The confidence component 1424 may input various data including information about the ASR confidence 1407, speech length (e.g., number of frames or other measured length of the user input), audio condition/quality data (such as signal-to-interference data or other metric data), fingerprint data, image data, or other factors to consider how confident the user recognition component 195 is with regard to the confidence values linking users to the user input. The confidence component 1424 may also consider the confidence values and associated identifiers output by the scoring component 1422. For example, the confidence component 1424 may determine that a lower ASR confidence 1407, or poor audio quality, or other factors, may result in a lower confidence of the user recognition component 195. Whereas a higher ASR confidence 1407, or better audio quality, or other factors, may result in a higher confidence of the user recognition component 195. Precise determination of the confidence may depend on configuration and training of the confidence component 1424 and the model(s) implemented thereby. The confidence component 1424 may operate using a number of different machine learning models/techniques such as GMM, neural networks, etc. For example, the confidence component 1424 may be a classifier configured to map a score output by the scoring component 1422 to a confidence value.

The user recognition component 195 may output user recognition data 1395 specific to a one or more user identifiers. For example, the user recognition component 195 may output user recognition data 1395 with respect to each received feature vector 1405. The user recognition data 1395 may include numeric confidence values (e.g., 0.0-1.0, 0-1000, or whatever scale the system is configured to operate). Thus, the user recognition data 1395 may output an n-best list of potential users with numeric confidence values (e.g., user identifier 123—0.2, user identifier 234—0.8). Alternatively or in addition, the user recognition data 1395 may include binned confidence values. For example, a computed recognition score of a first range (e.g., 0.0-0.33) may be output as “low,” a computed recognition score of a second range (e.g., 0.34-0.66) may be output as “medium,” and a computed recognition score of a third range (e.g., 0.67-1.0) may be output as “high.” The user recognition component 195 may output an n-best list of user identifiers with binned confidence values (e.g., user identifier 123—low, user identifier 234—high). Combined binned and numeric confidence value outputs are also possible. Rather than a list of identifiers and their respective confidence values, the user recognition data 1395 may only include information related to the top scoring identifier as determined by the user recognition component 195. The user recognition component 195 may also output an overall confidence value that the individual confidence values are correct, where the overall confidence value indicates how confident the user recognition component 195 is in the output results. The confidence component 1424 may determine the overall confidence value.

The confidence component 1424 may determine differences between individual confidence values when determining the user recognition data 1395. For example, if a difference between a first confidence value and a second confidence value is large, and the first confidence value is above a threshold confidence value, then the user recognition component 195 is able to recognize a first user (associated with the feature vector 1405 associated with the first confidence value) as the user that spoke the user input with a higher confidence than if the difference between the confidence values were smaller.

The user recognition component 195 may perform thresholding to avoid incorrect user recognition data 1395 being output. For example, the user recognition component 195 may compare a confidence value output by the confidence component 1424 to a threshold confidence value. If the confidence value does not satisfy (e.g., does not meet or exceed) the threshold confidence value, the user recognition component 195 may not output user recognition data 1395, or may only include in that data 1395 an indicator that a user that spoke the user input could not be recognized. Further, the user recognition component 195 may not output user recognition data 1395 until enough user recognition feature vector data 1440 is accumulated and processed to verify a user above a threshold confidence value. Thus, the user recognition component 195 may wait until a sufficient threshold quantity of audio data of the user input has been processed before outputting user recognition data 1395. The quantity of received audio data may also be considered by the confidence component 1424.

The user recognition component 195 may be defaulted to output binned (e.g., low, medium, high) user recognition confidence values. However, such may be problematic in certain situations. For example, if the user recognition component 195 computes a single binned confidence value for multiple feature vectors 1405, the system may not be able to determine which particular user originated the user input. In this situation, the user recognition component 195 may override its default setting and output numeric confidence values. This enables the system to determine a user, associated with the highest numeric confidence value, originated the user input.

The user recognition component 195 may use other data 1409 to inform user recognition processing. A trained model(s) or other component of the user recognition component 195 may be trained to take other data 1409 as an input feature when performing user recognition processing. Other data 1409 may include a variety of data types depending on system configuration and may be made available from other sensors, devices, or storage. The other data 1409 may include a time of day at which the audio data 611 was generated by the device 110 or received from the device 110, a day of a week in which the audio data audio data 611 was generated by the device 110 or received from the device 110, etc.

The other data 1409 may include image data or video data. For example, facial recognition may be performed on image data or video data received from the device 110 from which the audio data 611 was received (or another device). Facial recognition may be performed by the user recognition component 195. The output of facial recognition processing may be used by the user recognition component 195. That is, facial recognition output data may be used in conjunction with the comparison of the user recognition feature vector 1440 and one or more feature vectors 1405 to perform more accurate user recognition processing.

The other data 1409 may include location data of the device 110. The location data may be specific to a building within which the device 110 is located. For example, if the device 110 is located in user A's bedroom, such location may increase a user recognition confidence value associated with user A and/or decrease a user recognition confidence value associated with user B.

The other data 1409 may include data indicating a type of the device 110. Different types of devices may include, for example, a smart watch, a smart phone, a tablet, and a vehicle. The type of the device 110 may be indicated in a profile associated with the device 110. For example, if the device 110 from which the audio data 611 was received is a smart watch or vehicle belonging to a user A, the fact that the device 110 belongs to user A may increase a user recognition confidence value associated with user A and/or decrease a user recognition confidence value associated with user B.

The other data 1409 may include geographic coordinate data associated with the device 110. For example, a group profile associated with a vehicle may indicate multiple users (e.g., user A and user B). The vehicle may include a global positioning system (GPS) indicating latitude and longitude coordinates of the vehicle when the vehicle generated the audio data 611. As such, if the vehicle is located at a coordinate corresponding to a work location/building of user A, such may increase a user recognition confidence value associated with user A and/or decrease user recognition confidence values of all other users indicated in a group profile associated with the vehicle. A profile associated with the device 110 may indicate global coordinates and associated locations (e.g., work, home, etc.). One or more user profiles may also or alternatively indicate the global coordinates.

The other data 1409 may include data representing activity of a particular user that may be useful in performing user recognition processing. For example, a user may have recently entered a code to disable a home security alarm. A device 110, represented in a group profile associated with the home, may have generated the audio data 611. The other data 1409 may reflect signals from the home security alarm about the disabling user, time of disabling, etc. If a mobile device (such as a smart phone, Tile, dongle, or other device) known to be associated with a particular user is detected proximate to (for example physically close to, connected to the same Wi-Fi network as, or otherwise nearby) the device 110, this may be reflected in the other data 1409 and considered by the user recognition component 195.

Depending on system configuration, the other data 1409 may be configured to be included in the user recognition feature vector data 1440 so that all the data relating to the user input to be processed by the scoring component 1422 may be included in a single feature vector. Alternatively, the other data 1409 may be reflected in one or more different data structures to be processed by the scoring component 1422.

FIG. 15 is a conceptual diagram illustrating sentiment detection component 172 according to embodiments of the present disclosure. The sentiment detection component 172 may determine a user sentiment based on audio data 611, image data, and other data. Although certain configurations/operations of the sentiment detection component 172 are illustrated in FIG. 15 and described herein, other techniques/configurations of sentiment detection may be used depending on system configuration.

The sentiment detection component 172 may include a voice activity detection (VAD) component 1505, a user identification component 1510, an encoder component 1520, a modality attention layer 1535, a trained model component 1540, an utterance attention layer 1545, and a trained model component 1565. The audio data 611 captured by a device 110 may be inputted into the VAD component 1505. The VAD component 1505 may determine if the audio data 611 includes speech spoken by a human or voice activity by a human, and may determine a portion of the audio data 611 that includes speech or voice activity. The VAD component 1505 may send the portion of the audio data 611 including speech or voice activity to the user identification component 1510. The VAD component 1505 may employ voice activity detection techniques. Such techniques may determine whether speech is present in audio data based on various quantitative aspects of the audio data, such as the spectral slope between one or more frames of the audio data; the energy levels of the audio data in one or more spectral bands; the signal-to-noise ratios of the audio data in one or more spectral bands; or other quantitative aspects. In other examples, the VAD component 1505 may implement a limited classifier configured to distinguish speech from background noise. The classifier may be implemented by techniques such as linear classifiers, support vector machines, and decision trees. In still other examples, the device 110 may apply Hidden Markov Model (HMM) or Gaussian Mixture Model (GMM) techniques to compare the audio data to one or more acoustic models in storage, which acoustic models may include models corresponding to speech, noise (e.g., environmental noise or background noise), or silence. Still other techniques may be used to determine whether speech is present in audio data.

The user identification component 1510 may communicate with the user recognition component 195 to determine user audio data 1515 that corresponds to a particular user profile. The user recognition component 195 may recognize one or more users as described in connection with FIGS. 13 and 14. The user audio data 1515 may be a portion of the audio data 611 that includes speech or one or more utterances from a particular user associated with the user profile. In other words, audio data representing a particular user's speech may be isolated and stored as the user audio data 1515 for further analysis. In an example embodiment, the user may be associated with or using the device 110, and may have provided permission to the system 100 to record and analyze his or her voice/conversations to determine a sentiment category corresponding to the conversation.

The user audio data 1515 may be input into the encoder component 1520 to determine frame feature vector(s) 1525. The encoder component 1520 may be a bidirectional LSTM. The frame feature vector(s) 1525 may represent audio frame level features extracted from the user audio data 1515. One frame feature vector 1525 may represent audio frame level features for an audio frame of 20 ms of the user audio data 1515. The frame feature vector(s) 1525 may be derived by spectral analysis of the user audio data 1515. The sentiment detection component 172 may determine the portions of user audio data 1515 that correspond to individual words and may extract acoustic features from the respective portions of audio using the encoder component 1520.

In some embodiments, the frame feature vector(s) 1525 may be used to determine utterance feature vector(s) 1560 representing utterance-level features of one or more utterances represented in the user audio data 1515. The utterance feature vector(s) 1560 may be determined by performing statistics calculations, delta calculation and other processing on the frame feature vector(s) 1525 for the audio frames corresponding to an utterance of interest. As such, the utterance feature vector(s) 1560 may be a feature matrix whose dimensions are based on the number of audio frames corresponding to the utterance of interest and the dimension of the corresponding frame feature vector 1525. The utterance feature vector(s) 1560 may be a high-level function or other mathematical functions representing the utterance-level features.

The ASR component 150, as described above, may generate ASR output data, for example including text data representative of one or more utterances represented in the audio data 611. In some examples, the system sends audio data 611 to the ASR component 150 for processing. In other examples, the system sends user audio data 1515 to the ASR component 150 for processing. The ASR output may be represented as word feature vector(s) 1530, where each word feature vector 1530 may correspond to a word in the text data determined by the ASR component 150 and may represent lexical information of the utterance. The word feature vector 1530 may be a word embedding.

In an example embodiment, the sentiment detection component 172 determines that the user audio data 1515 includes an entire utterance. That is, the sentiment detection component 172 may determine that a startpoint of the user audio data 1515 corresponds to a startpoint of an utterance, and an endpoint of the user audio data 1515 corresponds to an endpoint of the utterance. In this case, the frame feature vector(s) 1525 and the word feature vector(s) 1530 may represent all the words in one utterance.

The sentiment detection component 172 may also input image data 611 which may come from still images, an image feed of video data, or the like for example from one or more cameras of device 110 or otherwise. The image data 611 may include a representation of a user which the system may analyze to determine the user's sentiment. Image data 611 may be processed by an encoder (not illustrated) to determine image feature vector(s) 1527. Such an encoder may be included as part of sentiment detection component 172 or may be located separately, in which case image feature vector(s) 1527 may be input into sentiment detection component 172 in addition to or instead of image data 611. The image data/feature vectors may be analyzed separately by sentiment detection component 172 if audio data/ASR data is unavailable. The image data/feature vectors may also be analyzed in conjunction with the audio data/ASR output data.

The sentiment detection component 172 may align a frame feature vector 1525 with a corresponding word feature vector 1530 such that the pair represents acoustic information and lexical information, respectively, for an individual word in the utterance represented in user audio data 1515. The sentiment detection component 172 may similarly align one or more image feature vector(s) 1527 with one or more frame feature vector(s) 1525 and/or corresponding word feature vector(s) 1530 so the appropriate image(s) are matched with the frames/ASR output data thus allowing the system to consider the audio, content and image of the user talking when performing sentiment analysis. The frame feature vectors 1525, image feature vector(s) 1527, and the word feature vectors 1530 may be processed by the trained model 1540 simultaneously.

The trained model 1540 may process the frame feature vector(s) 1525 and corresponding word feature vector(s) 1530 using a machine learning model. In some embodiments, the sentiment detection component 172 includes a modality attention component 1535 configured to determine how much acoustic information versus how much lexical information versus how much image information from the respective feature vectors 1525/1527/1530 should be used by the trained model 1540. In some cases the acoustic information corresponding to certain words may indicate a certain sentiment based on how the words were spoken by the user. In other cases the lexical information corresponding to certain words may indicate a certain sentiment based on the meaning or semantic of the word. For example, words “hey you” spoken with a certain level of anger, as indicated by the corresponding acoustic information, may indicate a sentiment category of anger, while the same words “hey you” spoken with no level of anger or excitement, as indicated by the corresponding acoustic information, may indicate a sentiment category of neutral. As a lexical example, the words “I am angry” may indicate a sentiment category of anger based on the corresponding lexical information. The modality attention component 1535 may assign a weight or percentage to the data represented by the acoustic feature vectors, the data represented by the image feature vectors, and the data represented by the lexical feature vectors to indicate the importance of each to the trained model 1540.

The trained model 1540 may be a neural network, for example a bi-directional LSTM. The output of the trained model 1540 may be fed into an utterance attention component 1545. The utterance attention component 1545 may employ a neural network, for example a recurrent neural network, although the disclosure is not limited thereto. The utterance attention component 1545 may be configured to emphasize relevant portions of an input utterance. The utterance attention component 1545 may be configured to take in output data from the trained model 1540 and produce an output for every time step (e.g., a 10 ms audio frame). The utterance attention component 1545 may be configured to aggregate information from different time intervals/audio frames of the input audio data to determine how certain parts of the utterance affects determining of the sentiment. For example, an acoustic representation of a first word in the utterance may indicate a high arousal implying anger, in which case the utterance attention component 1545 is configured to realize that the first word corresponds to an anger sentiment and that that should affect the processing of the other words in the utterance to ultimately determine a sentiment category corresponding to the utterance.

The utterance attention component 1545 may output score(s) 1550 indicating a sentiment category 1555 for the user audio data 1515. The sentiment detection component 172 may predict from multiple sentiment categories, including but not limited to, happiness, sadness, anger and neutral. In an example embodiment, the sentiment category 1555 may be determined after score(s) 1550 have been determined for a particular period of time of input audio data. In an example embodiment, the sentiment categories may be broad such as positive, neutral, and negative or may be more precise such as angry, happy, distressed, surprised, disgust, or the like.

In some embodiments, the sentiment detection component 172 is configured to determine a sentiment category 1575 at an utterance-level. The sentiment detection component 172 may use contextual information from the entire utterance to determine an overall sentiment of the speaker when speaking the utterance. The sentiment detection component 172 may also use information conveyed by individual words in the utterance to determine the sentiment of the speaker when speaking the utterance. For example, particular words may represent a particular sentiment or emotion because of its meaning (lexical information), while some words may represent a particular sentiment or emotion because of the way it is spoken by the user (acoustic information). In other embodiments, the sentiment detection component 172 may be configured to determine a sentiment category on a word level (that is for each word within an utterance).

As illustrated in FIG. 15, the trained model component 1565 may process the utterance feature vector(s) 1560 using a fully-connected neural network trained using techniques known to one of skill in the art. The trained model component 1565 may output score(s) 1570 indicating a sentiment category 1575 for the user audio data 1515.

The sentiment detection component 172 may predict one of three sentiment categories 1555/1575. In some examples, the sentiment categories 1555/1575 may be positive, neutral, and negative. However, the disclosure is not limited thereto, and in other examples the sentiment categories 1555/1575 may be angry, neutral (e.g., neutral/sad), and happy without departing from the disclosure. Additionally or alternatively, the sentiment detection component 172 may predict any number of sentiment categories 1555/1575 without departing from the disclosure. For example, the sentiment detection component 172 may predict one of four sentiment categories 1555/1575, such as angry, sad, neutral, and happy, although the disclosure is not limited thereto.

The machine learning model for the trained model component 1540/1565 may take many forms, including a neural network. The trained model component 1540/1565 may employ a convolutional neural network and/or may employ a fully-connected neural network. In some examples, a neural network may include a number of layers, from input layer 1 through output layer N. Each layer is configured to output a particular type of data and output another type of data. Thus, a neural network may be configured to input data of type data A (which is the input to layer 1) and output data of type data Z (which is the output from the last layer N). The output from one layer is then taken as the input to the next layer. For example, the output data (data B) from layer 1 is the input data for layer 2 and so forth such that the input to layer N is data Y output from a penultimate layer.

While values for the input data/output data of a particular layer are not known until a neural network is actually operating during runtime, the data describing the neural network describes the structure and operations of the layers of the neural network.

In some examples, a neural network may be structured with an input layer, middle layer(s), and an output layer. The middle layer(s) may also be known as the hidden layer(s). Each node of the hidden layer is connected to each node in the input layer and each node in the output layer. In some examples, a neural network may include a single hidden layer, although the disclosure is not limited thereto and the neural network may include multiple middle layers without departing from the disclosure. In this case, each node in a hidden layer will connect to each node in the next higher layer and next lower layer. Each node of the input layer represents a potential input to the neural network and each node of the output layer represents a potential output of the neural network. Each connection from one node to another node in the next layer may be associated with a weight or score. A neural network may output a single output or a weighted set of possible outputs.

In one aspect, the neural network may be constructed with recurrent connections such that the output of the hidden layer of the network feeds back into the hidden layer again for the next set of inputs. For example, each node of the input layer may connect to each node of the hidden layer, and each node of the hidden layer may connect to each node of the output layer. In addition, the output of the hidden layer may be fed back into the hidden layer for processing of the next set of inputs. A neural network incorporating recurrent connections may be referred to as a recurrent neural network (RNN).

Neural networks may also be used to perform ASR processing including acoustic model processing and language model processing. In the case where an acoustic model uses a neural network, each node of the neural network input layer may represent an acoustic feature of a feature vector of acoustic features, such as those that may be output after the first pass of performing speech recognition, and each node of the output layer represents a score corresponding to a subword unit (such as a phone, triphone, etc.) and/or associated states that may correspond to the sound represented by the feature vector. For a given input to the neural network, it outputs a number of potential outputs each with an assigned score representing a probability that the particular output is the correct output given the particular input. The top scoring output of an acoustic model neural network may then be fed into an HMM which may determine transitions between sounds prior to passing the results to a language model.

In the case where a language model uses a neural network, each node of the neural network input layer may represent a previous word and each node of the output layer may represent a potential next word as determined by the trained neural network language model. As a language model may be configured as a recurrent neural network which incorporates some history of words processed by the neural network, the prediction of the potential next word may be based on previous words in an utterance and not just on the most recent word. The language model neural network may also output weighted predictions for the next word.

Processing by a neural network is determined by the learned weights on each node input and the structure of the network. Given a particular input, the neural network determines the output one layer at a time until the output layer of the entire network is calculated.

Connection weights may be initially learned by the neural network during training, where given inputs are associated with known outputs. In a set of training data, a variety of training examples are fed into the network. Each example typically sets the weights of the correct connections from input to output to 1 and gives all connections a weight of 0. As examples in the training data are processed by the neural network, an input may be sent to the network and compared with the associated output to determine how the network performance compares to the target performance. Using a training technique, such as back propagation, the weights of the neural network may be updated to reduce errors made by the neural network when processing the training data. In some circumstances, the neural network may be trained with an entire lattice to improve speech recognition when the entire lattice is processed.

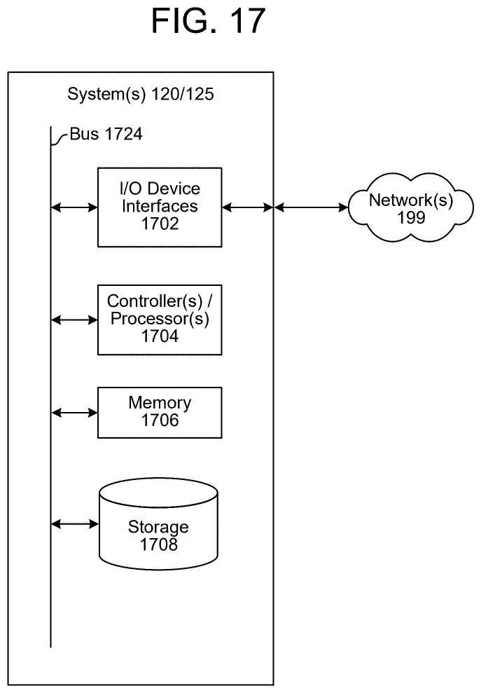

FIG. 16 is a block diagram conceptually illustrating a device 110, for example, a wearable device such as the smart glasses 110a, that may be used with the system. FIG. 17 is a block diagram conceptually illustrating example components of a remote device, such as the natural language command processing system 120, which may assist with ASR processing, NLU processing, etc., and a skill system 125. A system (120/125) may include one or more servers. A “server” as used herein may refer to a traditional server as understood in a server/client computing structure but may also refer to a number of different computing components that may assist with the operations discussed herein. For example, a server may include one or more physical computing components (such as a rack server) that are connected to other devices/components either physically and/or over a network and is capable of performing computing operations. A server may also include one or more virtual machines that emulates a computer system and is run on one or across multiple devices. A server may also include other combinations of hardware, software, firmware, or the like to perform operations discussed herein. The server(s) may be configured to operate using one or more of a client-server model, a computer bureau model, grid computing techniques, fog computing techniques, mainframe techniques, utility computing techniques, a peer-to-peer model, sandbox techniques, or other computing techniques.

While the device 110 may operate locally to a user (e.g., within a same environment so the device may receive inputs and playback outputs for the user) he server/system 120 may be located remotely from the device 110 as its operations may not require proximity to the user. The server/system 120 may be located in an entirely different location from the device 110 (for example, as part of a cloud computing system or the like) or may be located in a same environment as the device 110 but physically separated therefrom (for example a home server or similar device that resides in a user's home or business but perhaps in a closet, basement, attic, or the like). One benefit to the server/system 120 being in a user's home/business is that data used to process a command/return a response may be kept within the user's home, thus reducing potential privacy concerns.

Multiple systems (120/125) may be included in the overall system 100 of the present disclosure, such as one or more natural language processing systems 120 for performing ASR processing, one or more natural language processing systems 120 for performing NLU processing, one or more skill systems 125, etc. In operation, each of these systems may include computer-readable and computer-executable instructions that reside on the respective device (120/125), as will be discussed further below.

Each of these devices (110/120/125) may include one or more controllers/processors (204/1704), which may each include a central processing unit (CPU) for processing data and computer-readable instructions, and a memory (206/1706) for storing data and instructions of the respective device. The memories (206/1706) may individually include volatile random access memory (RAM), non-volatile read only memory (ROM), non-volatile magnetoresistive memory (MRAM), and/or other types of memory. Each device (110/120/125) may also include a data storage component (208/1708) for storing data and controller/processor-executable instructions. Each data storage component (208/1708) may individually include one or more non-volatile storage types such as magnetic storage, optical storage, solid-state storage, etc. Each device (110/120/125) may also be connected to removable or external non-volatile memory and/or storage (such as a removable memory card, memory key drive, networked storage, etc.) through respective input/output device interfaces (202/1702).

Computer instructions for operating each device (110/120/125) and its various components may be executed by the respective device's controller(s)/processor(s) (204/1704), using the memory (206/1706) as temporary “working” storage at runtime. A device's computer instructions may be stored in a non-transitory manner in non-volatile memory (206/1706), storage (208/1708), or an external device(s). Alternatively, some or all of the executable instructions may be embedded in hardware or firmware on the respective device in addition to or instead of software.

Each device (110/120/125) includes input/output device interfaces (202/1702). A variety of components may be connected through the input/output device interfaces (202/1702), as will be discussed further below. Additionally, each device (110/120/125) may include an address/data bus (224/1724) for conveying data among components of the respective device. Each component within a device (110/120/125) may also be directly connected to other components in addition to (or instead of) being connected to other components across the bus (224/1724).

Referring to FIG. 16, the device 110 may include input/output device interfaces 202 that connect to a variety of components such as an audio output component such as a loudspeaker 114, a wired headset or a wireless headset (not illustrated), or other component capable of outputting audio. The device 110 may also include an audio capture component. The audio capture component may be, for example, a microphone 112 or array of microphones, a wired headset or a wireless headset (not illustrated), etc. If an array of microphones is included, approximate distance to a sound's point of origin may be determined by acoustic localization based on time and amplitude differences between sounds captured by different microphones of the array. The device 110 may additionally include a display 1616 for displaying content. The device 110 may further include a camera 118. Components of the device 110 may draw power from a power source, such as one or more batteries 210.

Via antenna(s) 222, the input/output device interfaces 202 may connect to one or more networks 199 via a wireless local area network (WLAN) (such as Wi-Fi) radio, Bluetooth, and/or wireless network radio, such as a radio capable of communication with a wireless communication network such as a Long Term Evolution (LTE) network, WiMAX network, 3G network, 4G network, 5G network, etc. A wired connection such as Ethernet may also be supported. Through the network(s) 199, the system may be distributed across a networked environment. The I/O device interface (202/1702) may also include communication components that allow data to be exchanged between devices such as different physical servers in a collection of servers or other components.

The components of the device(s) 110, the natural language command processing system 120, or a skill system 125 may include their own dedicated processors, memory, and/or storage. Alternatively, one or more of the components of the device(s) 110, the natural language command processing system 120, or a skill system 125 may utilize the I/O interfaces (202/1702), processor(s) (204/1704), memory (206/1706), and/or storage (208/1708) of the device(s) 110, natural language command processing system 120, or the skill system 125, respectively. Thus, the ASR component 150 may have its own I/O interface(s), processor(s), memory, and/or storage; the NLU component 160 may have its own I/O interface(s), processor(s), memory, and/or storage; and so forth for the various components discussed herein.

As noted above, multiple devices may be employed in a single system. In such a multi-device system, each of the devices may include different components for performing different aspects of the system's processing. The multiple devices may include overlapping components. The components of the device 110, the natural language command processing system 120, and a skill system 125, as described herein, are illustrative, and may be located as a stand-alone device or may be included, in whole or in part, as a component of a larger device or system. As can be appreciated, a number of components may exist either on a system 120 and/or on device 110. For example, language processing (which may include ASR 150 and/or NLU 160), language output (which may include natural language generation (NLG) and/or TTS 180), etc., for example as illustrated in FIGS. 1 and 4. Unless expressly noted otherwise, the system version of such components may operate similarly to the device version of such components and thus the description of one version (e.g., the system version or the local version) applies to the description of the other version (e.g., the local version or system version) and vice-versa.

As illustrated in FIG. 18, multiple devices (110a-110n, 120, 125) may contain components of the system and the devices may be connected over a network(s) 199. The network(s) 199 may include a local or private network or may include a wide network such as the Internet. Devices may be connected to the network(s) 199 through either wired or wireless connections. For example, a wearable device such as smart glasses 110a, a smart phone 110b, a smart watch 110c, speech-detection devices with display 110d, speech-detection devices 110e, a tablet computer 110f, a display/smart television 110g, a vehicle 110h, a smart appliance such as a washer/dryer or a refrigerator 110i, a microwave 110j, headphones/earbuds 110m/110n, etc. (e.g., a device such as a FireTV stick, Echo Auto or the like) may be connected to the network(s) 199 through a wireless service provider, over a Wi-Fi or cellular network connection, or the like. Other devices are included as network-connected support devices, such as the natural language command processing system 120, the skill system(s) 125, and/or others. The support devices may connect to the network(s) 199 through a wired connection or wireless connection. Networked devices may capture audio using one-or-more built-in or connected microphones or other audio capture devices, with processing performed by ASR components, NLU components, or other components of the same device or another device connected via the network(s) 199, such as the ASR component 150, the NLU component 160, etc. of the natural language command processing system 120.

The concepts disclosed herein may be applied within a number of different devices and computer systems, including, for example, general-purpose computing systems, speech processing systems, and distributed computing environments.

The above aspects of the present disclosure are meant to be illustrative. They were chosen to explain the principles and application of the disclosure and are not intended to be exhaustive or to limit the disclosure. Many modifications and variations of the disclosed aspects may be apparent to those of skill in the art. Persons having ordinary skill in the field of computers and speech processing should recognize that components and process steps described herein may be interchangeable with other components or steps, or combinations of components or steps, and still achieve the benefits and advantages of the present disclosure. Moreover, it should be apparent to one skilled in the art, that the disclosure may be practiced without some or all of the specific details and steps disclosed herein. Further, unless expressly stated to the contrary, features/operations/components, etc. from one embodiment discussed herein may be combined with features/operations/components, etc. from another embodiment discussed herein.

Aspects of the disclosed system may be implemented as a computer method or as an article of manufacture such as a memory device or non-transitory computer readable storage medium. The computer readable storage medium may be readable by a computer and may comprise instructions for causing a computer or other device to perform processes described in the present disclosure. The computer readable storage medium may be implemented by a volatile computer memory, non-volatile computer memory, hard drive, solid-state memory, flash drive, removable disk, and/or other media. In addition, components of system may be implemented as in firmware or hardware.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements, and/or steps are in any way required for one or more embodiments or that one or more embodiments necessarily include logic for deciding, with or without other input or prompting, whether these features, elements, and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Disjunctive language such as the phrase “at least one of X, Y, Z,” unless specifically stated otherwise, is understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

As used in this disclosure, the term “a” or “one” may include one or more items unless specifically stated otherwise. Further, the phrase “based on” is intended to mean “based at least in part on” unless specifically stated otherwise.

What is claimed is:

1. A method comprising:
receiving audio data representing speech in a first language;
performing automatic speech recognition (ASR) processing on the audio data to generate ASR results data representing a transcription of the speech in the first language;
determining context data corresponding to the audio data, the context data comprising a user setting;
processing, using at least one trained model, the ASR results data and the context data to:
based on the context data, determine a verbosity for a translation of the speech in a second language, and
based on the verbosity, determine text data corresponding to the translation;
generating output data based on the text data; and
causing the output data to be presented.

2. The method of claim 1, further comprising determining the context data to further comprise an indication of a fluency of a user in the second language.

3. The method of claim 1, further comprising determining the user setting represents a desired verbosity for a social situation.

4. The method of claim 1, further comprising determining the user setting represents a desired verbosity for a professional situation.

5. The method of claim 1, further comprising:
processing the ASR results data to determine an indication of deference; and
determining the context data to further comprise the indication of deference.

6. The method of claim 5, further comprising determining the indication of deference based on articles of speech in the ASR results data.

7. The method of claim 1, further comprising determining the user setting of an intended recipient of the speech.

8. The method of claim 1, further comprising:
determining voice characteristics of the speech;
determining, using the voice characteristics, that the speech corresponds to audio output by a media device; and
in response to determining that the speech corresponds to the audio output by a media device, determining to translate the speech.

9. The method of claim 1, further comprising receiving the audio data by smart glasses.

10. The method of claim 1, further comprising receiving the audio data by ear-bud style headphones.

11. A system comprising:
at least one processor; and
at least one memory comprising instructions that, when executed by the at least one processor, cause the system to:
receive audio data representing speech in a first language;
perform automatic speech recognition (ASR) processing on the audio data to generate ASR results data representing a transcription of the speech in the first language;
determine context data corresponding to the audio data, the context data comprising a user setting;
process, using at least one trained model, the ASR results data and the context data to:
based on the context data, determine a verbosity for a translation of the speech in a second language, and
based on the verbosity, determine text data corresponding to the translation;
generate output data based on the text data; and
cause the output data to be presented.

12. The system of claim 11, wherein the at least one memory comprises instructions that, when executed by the at least one processor, further cause the system to determine the context data to further comprise an indication of a fluency of a user in the second language.

13. The system of claim 11, wherein the user setting represents a desired verbosity for a social situation.

14. The system of claim 11, wherein the user setting represents a desired verbosity for a professional situation.

15. The system of claim 11, wherein the at least one memory comprises instructions that, when executed by the at least one processor, further cause the system to:
process the ASR results data to determine an indication of deference; and
determine the context data to further comprise the indication of deference.

16. The system of claim 15, wherein the at least one memory comprises instructions that, when executed by the at least one processor, further cause the system to determine the indication of deference based on articles of speech in the ASR results data.

17. The system of claim 11, wherein the at least one memory comprises instructions that, when executed by the at least one processor, further cause the system to determine the user setting of an intended recipient of the speech.

18. The system of claim 11, wherein the at least one memory comprises instructions that, when executed by the at least one processor, further cause the system to:
determine voice characteristics of the speech;
determine, using the voice characteristics, that the speech corresponds to audio output by a media device; and
in response to determining that the speech corresponds to the audio output by a media device, determine to translate the speech.

19. The system of claim 11, wherein the at least one memory comprises instructions that, when executed by the at least one processor, further cause the system to receive the audio data by smart glasses.

20. The system of claim 11, wherein the at least one memory comprises instructions that, when executed by the at least one processor, further cause the system to receive the audio data by ear-bud style headphones.
